(19) United States
(12) Patent Application Publication
(10) Pub. No.: US 2020/0375388 A1
(43) Pub. Date: Dec. 3, 2020

(54) Robotic Beverage Preparation System and Control Systems and Methods Therefor

(71) Applicant: Aabak Thoughts Pty Ltd, Port Melbourne (AU)

(72) Inventors: Flynn MacFarlane, Southbank (AU); Daniel Bolitho, Preston (AU); Liam Wilkie, Preston (AU); Ali Syed Mohammad, Maidstone (AU); Michael Elliot-Jones, Brunswick (AU); Ryan Ralph, Yarraville (AU); Bhavish Sookram, Southbank (AU); Clayton Gregory Arnold Lund, St Kilda (AU); Patrick Watts, Footscray (AU); Jaden Jigme Rubinstein, Melbourne (AU); Yun Xiao, Blackburn (AU); Hafiz Abdul Moid, St Kilda (AU)

(21) Appl. No.: 16/769,722

(22) PCT Filed: Dec. 4, 2018
(86) PCT No.: PCT/AU2018/051295

§ 371 Date: Jun. 4, 2020

(30) Foreign Application Priority Data
Dec. 4, 2017 (AU) 2017904875
Apr. 17, 2018 (AU) 2018901284
Apr. 19, 2018 (AU) 2018901306

(51) Int. Cl. A47J 31/00; A47J 31/42; A47J 31/40; A47J 31/36; A47J 31/52; A47J 31/60; A23F 5/26; B25J 11/00; B25J 9/00; G07F 11/16; G07F 13/06; G06Q 20/18

(52) U.S. Cl. CPC A47J 31/007; H05B 1/0269; A47J 31/404; A47J 31/405; A47J 31/402; A47J 31/3614; A47J 31/521; A47J 31/60; A23F 5/26; B25J 11/008; B25J 9/0003; G07F 11/165; G07F 13/065; G06Q 20/18; A47J 31/42

(57) ABSTRACT

Embodiments generally relate to systems, apparatus and methods concerned with autonomous preparation of brewed beverages, such as coffee beverages. Some embodiments make use of at least one robotic arm in the brewed beverage preparation. Various embodiments use two robotic arms. Various embodiments have multiple separately controlled components with which the at least one robotic arm can interact as part of the coffee preparation process.

### CROSS-REFERENCE TO RELATED APPLICATIONS

The present application is a § 371 National Phase Entry of and claims priority of International patent application Serial No. PCT/AU2018/051295, filed Dec. 4, 2018, and published in English the content of which is hereby incorporated by reference in its entirety. The present application further claims priority to Australian Patent Application Nos. 2017904875, filed Dec. 4, 2017, 2018901284 filed Apr. 17, 2018, and 2018901306 filed Apr. 19, 2018 the content of each of which is hereby incorporated by reference in its entirety.

### TECHNICAL FIELD

Embodiments generally relate to preparation of brewed beverages, such as coffee beverages. Some embodiments are autonomous and/or make use of at least one robotic arm in the brewed beverage preparation.

### BACKGROUND

Coffee preparation machines include small counter-top machines and larger stand-alone vending machines. Counter-top machines tend to brew one coffee at a time and reply heavily on human interaction operate the machine and to frequently re-supply the machine with water, coffee beans or grounds and optionally also milk. Such machines also frequently require human interaction to empty used grounds and drip trays. Such re-supply and maintenance can typically be required at least once for every ten or so coffee beverages. Such machines typically exercise relatively unsophisticated control over the grinding process and/or brewing process, so the quality of the coffee dispensed is less preferable than having a barista prepare a coffee. For stand-alone coffee vending machines, the coffee beverage is often prepared using instant coffee powder and the quality of the coffee beverage is often quite low.

The quality of coffee prepared by some baristas using espresso machines can be high. However, there can be inconsistent dispensing and compaction of grounds into the filter basket of a group handle typically used for such espresso machines, leading the variability in quality from one beverage to another. Additionally, even high quality and efficient baristas have limitations on their efficiency. For good baristas, wages can be relatively high.

It is desired to address or ameliorate one or more shortcomings or disadvantages associated with prior methods or systems of coffee preparation, or to at least provide a useful alternative thereto.

### SUMMARY

Some embodiments relate to an automated coffee preparation system, comprising:

a controller;

a coffee grinder to grind coffee beans into grounds;

a doser to dispense grounds into a filter basket;

a compactor to compact the grounds in the filter basket;

a brewing machine comprising at least one brew head and configured to force water through the grounds in the filter basket to create a coffee beverage; and

at least one robotic arm configured to:
transport an empty portable filter that holds the filter basket to the doser, then transport the portable filter and filled filter basket to the compactor, then transport the portable filter with compacted grounds to the brewing machine and then engage the portable filter with the at least one brew head of the brewing machine:
wherein the controller controls independent operation of each of the at least one robotic arm, the coffee grinder, the compactor and the brewing machine.

The system may further comprise a weigh station to measure a mass of the grounds in the filter basket. The controller may be configured to control the at least one robotic arm to transport the portable filter with compacted grounds to the weigh station before transporting it to the brewing machine.

The system may further comprise a weight reduction station to remove some of the compacted grounds from the filter basket. The controller may be configured to control the at least one robotic arm to transport the portable filter with compacted grounds to the weight reduction (dose adjustment) station after transporting it to the weigh station.

The system may further comprise a grounds disposal station to remove used grounds from the filter basket. The controller may be configured to control the at least one robotic arm to transport the portable filter with used grounds to the disposal station after the coffee beverage is created at the brewing machine.

The system may further comprise a storage station for storing the portable filter. The controller may be configured to control the at least one robotic arm to transport the portable filter to the storage station at times when the portable filter is not needed.

The at least one robotic arm may comprise an engagement component to engage a handle of the portable filter for transport. The engagement component may comprise a gripper.

The at least one robotic arm may comprise a first robotic arm having multiple separately actuatable engagement components at a distal end of the first robotic arm. The multiple engagement components may comprise a first component to engage the portable filter and a second component to engage a cup.

The at least one robotic arm may comprise a first robotic arm and a second robotic arm. The first and second robotic arms may each comprise multiple separately actuatable engagement components at respective distal ends of the first and second robotic arms.

The system may further comprise a delivery portal to deliver finished coffee beverages, the delivery portal being accessible to the at least one robotic arm. The delivery portal may have at least one cup sensor to sense a presence of at least one cup in the delivery portal.

The system may further comprise an ordering interface to process coffee orders and cause generation of instructions for execution by the controller.

The system may further comprise a user interface to receive user input in relation to coffee orders and to provide order instructions to the ordering interface in response to received user input.

The user interface may comprise a local user interface accessible at a same geographic location as the at least one robotic arm. The user interface may also comprise a remotely accessible user interface that is accessible via a data network.

Preparation and delivery of the coffee beverage to the delivery portal may be autonomous.

The system may further comprise a milk supply and a sweetener supply, wherein the controller controls dispensing of milk from the milk supply and dispensing of sweetener from the sweetener supply.

Some embodiments relate to an autonomous robotic brewed beverage preparation system, comprising:

a housing comprising an upper cabinet and a lower cabinet;

an order interface;

a control system in the housing and responsive to the order interface to process brewed beverage orders received via the order interface;

brewed beverage preparation apparatus in the housing responsive to the control system to prepare a brewed beverage in a removable vessel based on a brewed beverage order;

wherein the brewed beverage preparation apparatus comprises a first robotic arm for performing a first set of preparation tasks and a second robotic arm for performing a second set of different preparation tasks.

The system may further comprise a transfer station disposed between the first robotic arm and the second robotic arm. The first and second robotic arms may be configured to transfer beverage cups via the transfer station.

Some embodiments relate to an autonomous robotic coffee preparation system, comprising:

coffee preparation apparatus;

at least one robotic arm configured to cooperate with the coffee preparation apparatus to prepare and deliver coffee orders;

a controller configured to control operation of the at least one robotic arm and the coffee preparation apparatus;

a user interface disposed at a same geographic location as the at least one robotic arm to generate local coffee orders in response to user input;

an order interface configured to receive and process local coffee orders generated by the user interface and to provide coffee preparation instructions to the controller;

wherein the order interface is further configured to receive and process remote coffee orders from a remote server via a communication network.

The order interface may be configured to queue local coffee orders and remote coffee orders for order fulfillment according to a time of receipt of the respective coffee orders.

The controller, the coffee preparation apparatus and the at least one robotic arm may be configured to prepare multiple coffee beverages in a single local or remote coffee order. The controller, the coffee preparation apparatus and the at least one robotic arm may be configured to fulfil multiple local and/or remote coffee orders simultaneously.

Some embodiments relate to an autonomous robotic coffee preparation system, comprising:

coffee preparation apparatus comprising a compactor to compact coffee grounds in a filter basket;

at least one robotic arm configured to cooperate with the coffee preparation apparatus to prepare and deliver coffee orders;

a controller configured to control operation of the at least one robotic arm and the coffee preparation apparatus;

wherein the compactor is configured to apply at least about 200 N of force when compacting the coffee grounds in the filter basket.

The compactor may be configured to apply at least about 300 N of force when compacting the coffee grounds in the filter basket.

Some embodiments relate to an autonomous robotic coffee preparation system, comprising:

coffee preparation apparatus;

at least one robotic arm configured to cooperate with the coffee preparation apparatus to prepare and deliver coffee orders;

a controller configured to control operation of the at least one robotic arm and the coffee preparation apparatus;

a delivery portal for delivery of prepared coffee beverages;

a monitoring subsystem to monitor removal of the prepared coffee beverages from the delivery portal and to determine an overdue pick-up event when one or more prepared coffee beverages have remained in the delivery portal for longer than a predetermined time;

wherein the controller is configured to cause the at least one robotic arm to retrieve the one or more remaining coffee beverages from the delivery portal in response to determination of an overdue pick-up event by the monitoring subsystem.

The controller may be configured to cause the at least one robotic arm to dispose of the retrieved one or more remaining coffee beverages.

The controller may be configured to cause the at least one robotic arm to store the one or more remaining coffee beverages in a storage area that is separate from the delivery portal.

Some embodiments relate to an autonomous robotic coffee preparation system, comprising:

coffee preparation apparatus;

at least one robotic arm configured to cooperate with the coffee preparation apparatus to prepare and deliver coffee orders;

a controller configured to control operation of the at least one robotic arm and the coffee preparation apparatus;

a delivery portal for delivery of prepared coffee beverages;

wherein the delivery portal comprises a plurality of position sensors to sense the presence of a cup at a respective plurality of delivery positions with in the delivery portal.

The system may further comprise at least one camera disposed to capture images over time of an interior of the delivery portal including the delivery positions, and further comprising an image analysis subsystem to determine whether one or more cups in the delivery portal have moved over time but have remained in the delivery portal.

Some embodiments relate to an autonomous robotic coffee preparation system, comprising:

a housing closed to unauthorised access;

coffee preparation apparatus in the housing;

coffee preparation supply storage in the housing and accessible to the coffee preparation apparatus;

at least one robotic arm in the housing and configured to cooperate with the coffee preparation apparatus to prepare and deliver coffee orders using coffee preparation supplies stored in the coffee preparation supply storage;

a controller in the housing configured to control operation of the at least one robotic arm and the coffee preparation apparatus;

a delivery portal for delivery of prepared coffee beverages;

wherein the coffee preparation apparatus and the coffee preparation supply storage are configured to allow preparation of at least 100 coffee beverages without resupply of coffee preparation supplies.

The system may further comprise:
a processor and a memory as part of the controller;
a coffee beverage weigh station to measure a mass of the created coffee beverage; and
grind coarseness control as part of the coffee grinder.

In some embodiments, the controller is further configured to record the measured mass of the created coffee beverage in the memory as a sequence of mass of created coffee beverages.

In some embodiments, the controller is further configured to:
calculate a grinding gradient flag based on the sequence of mass of created coffee beverages; and
based on the calculated grinding flag, increase or decrease the grind coarseness control.

In some embodiments, the grinding gradient flag is calculated to be a positive or negative grinding gradient flag based on a moving average of the sequence of mass of created coffee beverages and a stored range of optimum moving average of the sequence of mass of created coffee beverages.

In some embodiments, the grinding gradient flag is calculated to be a positive or negative grinding gradient flag based on a regression value of the sequence of mass of created coffee beverages and a stored range of optimum regression value of the sequence of mass of created coffee beverages.

In some embodiments:
if the grinding gradient flag is calculated to be a positive grinding gradient flag, then the controller changes the grind coarseness control to grind finer coffee; and
if the grinding gradient flag is calculated to be a negative grinding gradient flag, then the controller changes the grind coarseness control to grind courser coffee.

The coffee preparation apparatus and the coffee preparation supply storage may be configured to allow preparation of at least 200, at least 400 or at least 600 coffee beverages without resupply of coffee preparation supplies.

Some embodiments relate to an automated coffee preparation system, comprising:

a controller;

a coffee grinder to grind coffee beans into grounds;

a doser to dispense grounds into a filter basket;

a compactor to compact the grounds in the filter basket, the compactor being co-located with the doser;

a brewing machine comprising at least one brew head and configured to force water through the grounds in the filter basket to create a coffee beverage; and

at least one robotic arm configured to:
transport an empty portable filter that holds the filter basket to the doser and the compactor, then transport the portable filter to the brewing machine and then engage the portable filter with the at least one brew head of the brewing machine:

wherein the controller controls independent operation of each of the at least one robotic arm, the coffee grinder, the doser, the compactor and the brewing machine.

The doser and the compactor may be integrated into a single unit. The compactor may be adapted to deliver between 100 N and 700 N or between 300 N to 600 N of force to compact grounds in the filter basket.

The doser may be configured to hold multiple separate doses of coffee grounds for sequential delivery to successive filter baskets. The doser may comprise a plurality of dose chambers for receiving respective doses of coffee grounds. The doser may comprise a manifold that is movable to sequentially dispense the separate doses of coffee grounds. The doser may be configured to adopt one of a plurality of dispense positions in which the compactor is aligned with one dose chamber. The compactor may comprise a plunger configured to pass through the aligned one dose chamber to compact a dispensed dose of grounds into the filter basket.

At least one of the doser and the compactor may comprise an alignment adjustment mechanism arranged to cause fine alignment of the one dose chamber with the compactor.

Some embodiments relate to an autonomous robotic coffee preparation system, comprising:

a closed housing;

a first robotic arm arranged in the housing to transport a filter basket between a plurality of different automatically controlled coffee preparation stations;

a second robotic arm arranged in the housing to select and transport a disposable coffee vessel between automatically controlled coffee preparation and delivery stations;

a control system configured to control operation of the first and second robotic arms, and the coffee preparation and delivery stations.

One of the coffee preparation stations may comprise a brewing machine, wherein both the first robotic arm and the second robotic arm have access to the brewing machine. The brewing machine may comprise a water heater to deliver hot water to filter baskets coupled to the brewing machine and to deliver hot water to a puck removal apparatus.

The system further comprise the puck removal apparatus, wherein the puck removal apparatus is configured to remove a puck of spent coffee grounds from a filter basket using the hot water. The puck removal apparatus may be configured: to remove the puck from the filter basket by application of pressurised air and hot water directed at an inverted filter basket; and to receive the spent coffee grounds into a disposal conduit positioned below the inverted filter basket. The puck removal apparatus may comprise a basket holder to securely hold a filter basket in an inverted position during puck removal. The puck removal apparatus may be disposed in or adjacent the brewing machine.

The system may comprise multiple filter baskets that are separately transportable and engageable with ones of the plurality of coffee preparation stations using the first robotic arm to enable parallel operation of the plurality of coffee preparation stations.

The control system may be configured to control the first robotic arm to separately manipulate at least three different filter baskets as part of parallel operation of the plurality of coffee preparation stations.

Some embodiments relate to an automatic coffee preparation system comprising:

an autonomous robotic coffee preparation apparatus;

a server in communication with the coffee preparation apparatus;

a mobile electronic device in communication with the server and having a geolocation function, the electronic device comprising an application to facilitate remote coffee ordering for coffee preparation by the coffee preparation apparatus;

wherein at least one of the server and the electronic device determines occurrence of a trigger event in response to the electronic device passing into a predetermined geofence boundary; and

wherein the server is configured to, in response to the trigger event, automatically transmit instructions to cause the coffee preparation apparatus to prepare a coffee beverage.

The coffee preparation system may comprise at least one robotic arm to facilitate coffee preparation functions. The server may be configured to, in response to the trigger event, look up a stored set of user preferences and transmit the user preferences with the instructions to the coffee preparation apparatus; or the mobile electronic device may be configured to, in response to the trigger event, look up a stored set of user preferences and transmit the user preferences with the instructions to the coffee preparation apparatus. Determination of occurrence of the trigger event may be based at least in part on at least one user-defined timing parameter, such that if a time of passing into the predetermined geofence boundary does not satisfy the at least one timing parameter, then the trigger event is not determined to occur. The coffee preparation apparatus may comprise the system described above.

Some embodiments relate to an autonomous robotic coffee preparation system, comprising:

coffee preparation apparatus comprising a grinding and dosing subsystem and a separate brewing machine;

at least one robotic arm configured to cooperate with the coffee preparation apparatus to prepare and deliver coffee orders and is configured to transport at least one filter basket between the grinding and dosing subsystem and the brewing machine;

a controller configured to control operation of the at least one robotic arm and the coffee preparation apparatus;

a delivery interface for delivery of prepared coffee orders in separate transportable cups, wherein the delivery interface comprises multiple separate delivery portals arranged in a portal array disposed on or toward an opposite end of the apparatus from an order interface.

The controller may be further configured to control operation of the at least one robotic arm and the coffee preparation apparatus to prepare multiple coffee beverages based on a single order for multiple coffee beverages and to cause the at least one robotic arm to deliver the multiple coffee beverages to respective multiple delivery portals.

The delivery interface may further comprise a display screen adjacent to the portal array to assist in notification of delivery of prepared coffee orders. The delivery interface may comprise at least one sensor to detect proximity of an object immediately in front of each delivery portal. Each of the delivery interfaces may comprise a portal housing defining a portal chamber and a portal aperture, wherein the portal aperture is sized to allow passage of a robot end effector therethrough for placement of a prepared coffee beverage in the portal chamber. The housing may be movable between an insertion position, in which the portal chamber is accessible to the at least one robotic arm but not accessible from outside the coffee preparation apparatus, and a retrieval position, in which the portal chamber is accessible from outside the coffee preparation apparatus but not accessible to the at least one robotic arm. The portal housing may comprises a cylindrical housing portion that defines the portal aperture and is rotatable between the insertion position and the retrieval position.

Each delivery portal may have an externally visible lighting component disposed in close proximity to an external side of the delivery portal. The controller may be configured to cause the lighting component for a particular one of the delivery portals to illuminate once a prepared beverage is placed into the particular delivery portal.

Some embodiments relate to apparatus for use in coffee preparation, comprising:

a coffee grinding machine;

a coffee doser disposed adjacent the coffee grinding machine to receive coffee grounds from the coffee grinding machine; and

a compactor arranged to compact coffee grounds received from the doser into a filter basket, wherein the compactor is configured to apply a compacting force between about 100 N and about 700 N to compact coffee grounds in the filter basket.

The coffee grinding machine may be configured to adjust a coarseness of the grinding in response to a control signal from a controller. A piston of the compactor may pass through a body of the doser when the compactor applies force to compact the grounds. The doser may comprise a rotating cylinder defining dose chambers to each receive and subsequently dispense a dose of coffee grounds. When the rotating cylinder is in a dispense position, one of the dose chambers may be aligned with a piston of the computer.

The apparatus may further comprise an air jet nozzle configured to blow grounds from a compacting face of a piston of the compactor after or during a return stroke of the piston in response to a control signal. The apparatus may further comprise an agitator to settle coffee grounds received in the dose chambers. A drive motor that causes rotation of the rotating cylinder may act as the agitator.

The compactor may be adapted to apply a compacting force between about 300 N and about 600 N to compact coffee grounds in the filter basket. The doser may be configured to provide a coarse alignment of one of the dose chambers with the piston, and may further comprise a fine alignment unit to provide fine alignment of the one dose chamber and the piston to ensure unimpeded passage of the piston through the dose chamber in a forward compacting stroke and in a return stroke of the piston. The fine alignment unit may comprise a tapered alignment piston receivable in and cooperating with a fine alignment bore that is fixed in relation to the rotating cylinder, wherein receipt of a forward stroke of the tapered alignment piston in the fine alignment bore causes fine alignment of the one dose chamber with the compactor piston. The coffee grinding machine, the coffee doser and the compactor may all be automatically controlled by control signals received from a controller.

The apparatus may further comprise a dose adjustment unit to reduce a mass of compacted grounds in the filter basket. The apparatus may further comprise a weighing station to weigh the mass of coffee grounds received and compacted in the filter basket.

Some embodiments relate to apparatus for cleaning a coffee filter basket, comprising:

a body defining a vertically oriented tubular chamber with a top opening;

a water jet nozzle positioned to project water from a pressurised water source, optionally through the chamber toward the top opening;

an air jet outlet positioned to project air from a pressurised air source through the chamber toward the top opening;

wherein when a filter basket is engaged with the engagement structure in an inverted orientation over the top opening, water from the water jet nozzle and air from the air jet outlet can impinge on an inside of the filter basket to clean the inside of the filter basket.

The water jet nozzle may be positioned in the chamber. The water jet nozzle may be positioned in a central part of the chamber. The water jet nozzle may be configured to project a conical water jet toward the top opening. The apparatus may further comprise the pressurised water source. The pressurised water source may comprise water heated to at least 95° C. The water may be heated to at least 100° C., optionally up to 125° C.

The apparatus may further comprise the pressurised air source. The apparatus may further comprise a controller to control projection of water from the water jet nozzle and to control projection of air from the air jet outlet so that water is projected toward the top opening for a first predetermined time period and air is projected toward the top opening for a second predetermined period. The first predetermined time period and the second predetermined time period may be sequential or may partially overlap;

and/or the first predetermined time period may begin prior to the second predetermined time period. The water may be projected to clean coffee grounds from the filter basket and the air may be projected to clean water from the filter basket. The body may define a drainage outlet at a bottom of the chamber so that coffee grounds and water falling from the filter basket can be disposed of via the drainage outlet.

Some embodiments relate to a coffee preparation system, comprising:

a brewing machine for brewing a coffee beverage from coffee grounds held in a filter basket; and

the apparatus described above to clean the filter basket before or after use in the brewing machine.

Some embodiments relate to a coffee preparation system, comprising:

a coffee brewing machine for brewing a coffee beverage from coffee grounds held in a removable filter basket; and

a cleaning station disposed adjacent the coffee brewing machine to automatically clean spent coffee grounds from the filter basket using pressurised water.

The system may further comprise a transport mechanism to transport the filter basket from the coffee brewing machine to the cleaning station. The system may further comprise a controller configured to automatically control operation of the coffee brewing machine, the cleaning station and the transport mechanism. The transport mechanism may comprise a robotic arm.

The system may further comprise a hot water source comprising a heater and configured to supply hot water to the coffee brewing machine and the cleaning station. A water tank of the hot water source may be pressurised to between about 1.5 bar and about 2.0 bar. Water in the water tank may be heated to a temperature between 100° C. and 125° C. The system may further comprise a pressure sensor to sense a pressure in the hot water source. A water tank of the hot water source may be filled with water to less than the volumetric capacity of the water tank to allow air to fill the remainder of the volumetric capacity.

The coffee brewing machine may comprise a drip tray disposed beneath brewing heads of the coffee brewing machine, wherein the cleaning station is disposed adjacent the drip tray. The drip tray and the cleaning station may drain into a shared drainage reservoir. The cleaning station may be integrated with a part of the coffee brewing machine. The cleaning station may be integrated with a drip tray of the coffee brewing machine. The cleaning station may be arranged to hold the filter basket in an inverted orientation for cleaning. The cleaning station may comprise a water jet and an air jet to clean particulate and liquid from the filter basket. The cleaning station may be configured to heat the filter basket during cleaning.

Some embodiments relate to a method of autonomous management of robotic coffee preparation apparatus, comprising:

monitoring utilisation of robotic coffee preparation apparatus, wherein the monitoring is by a controller of the robotic coffee preparation apparatus;

determining, by the controller, from the monitoring that the robotic coffee preparation apparatus is idle for a first predetermined period in response to the determining by the controller, setting a first reduced price for a next coffee beverage to be prepared by the robotic coffee preparation, wherein the first reduced price is less than a normal set price for the coffee beverage;

causing the robotic coffee preparation apparatus to prepare and deliver a selected coffee beverage in response to receiving a coffee beverage order at the first reduced price.

The method may further comprise resetting, by the controller, a price for a next coffee beverage to the normal set price in response to the coffee order at the first reduced price. The method may further comprise: secondly determining, by the controller, from the monitoring that the robotic coffee preparation apparatus is idle for a second predetermined period that is longer than the first predetermined period; in response to the secondly determining, setting by the controller a second reduced price for the next coffee beverage, wherein the second reduced price is less than the first reduced price; and causing the robotic coffee preparation apparatus to prepare and deliver a selected coffee beverage in response to receiving a coffee beverage order at the second reduced price.

The coffee beverage order may be received by the controller via either: a local order interface at a location of the robotic coffee preparation; or a server in communication with a mobile client device that executes mobile order interface.

Some embodiments relate to a method for brewed beverage preparation, comprising:

receiving at an autonomous robotic brewed beverage preparation system a brewed beverage order for a specified brewed beverage, the brewed beverage order comprising a specified order delivery time;

initiating preparation of the specified brewed beverage by the brewed beverage preparation system for delivery by manual pick-up at a location of the brewed beverage preparation system at the specified order delivery time.

The method may further comprise monitoring a delivery window of the brewed beverage preparation system to determine whether manual pick-up has occurred within a predetermined time period after the specified order delivery time. If manual pick-up is determined to have occurred within the predetermined time period, the method may include automatically debiting a user account for a cost of the brewed beverage. If manual pick-up is determined to have occurred within the predetermined time period, the brewed beverage may be automatically removed from the delivery window by a delivery component of the brewed beverage preparation system.

Some embodiments relate to methods, apparatus and systems for autonomous brewed beverage preparation, where the brewed beverage may be coffee or the brewed beverage may be a non-coffee beverage, such as tea or a coffee substitute or other brewed beverage. The systems, apparatus and methods described herein may be used to autonomously prepare and deliver hot brewed beverages or cold brewed beverages.

In some embodiments, the systems, apparatus and methods may be used to prepare and deliver beverages without a brewed beverage component but which can be readily prepared using the equipment and supplies already available to the beverage preparation apparatus. For example, the prepared beverage may comprise hot or warm water and/or a non-water liquid, such as frothed or steamed milk, which are available as part of the brewed beverage preparation process. The steamed or frothed milk may be an animal milk, such as cow's milk, or may be a legume or nut milk, such as soy, coconut or almond milk. In some embodiments, apparatus, equipment and methods described herein may be used for non-brewed, non-coffee beverage preparation. The local ordering interface on a machine and/or the remote ordering interface may allow for selection and ordering of such non-coffee and/or non-brewed beverages.

Some embodiments disclosed herein involve the use of one or two robotic arms, while other embodiments have utility as separate devices, apparatus or processes independent of the one or two robotic arms. While such other embodiments are described herein in the context of being used in combination with one or two robotic arms, they may have novelty and inventiveness in their own right regardless of whether they are used in combination with one or two robotic arms.

Some embodiments relate to an autonomous beverage preparation system, comprising:

an enclosed housing;

a controller in the housing

an order interface in communication with the controller for receiving beverage orders;

a water delivery station in the housing and responsive to the controller and comprising a water tank and a water heater, the water delivery station defining a first cup location at which heated water can be dispensed into a cup;

a non-water delivery station in the housing and spaced from the water delivery system and separately controlled by the controller, the non-water delivery station being configured to dispense a non-water liquid and defining a second cup location at which the non-water liquid can be dispensed into a cup; and

robotic transport apparatus in the housing and configured to transport the cup to the water delivery station and to the non-water delivery station and to deliver the cup to a delivery port for collection;

wherein the delivery port is controlled by the controller to be selectively opened to allow collection of the cup from outside the housing.

The water delivery station may comprise a dispensing outlet configured for brewed beverage preparation by forcing water through a packed porous beverage ingredient. The water delivery station comprises at least one cup support defining the first cup location and at least a third cup location, wherein each cup support has a load cell coupled thereto to measure a weight of the cup when positioned at the first cup location or the at least third cup location.

The non-water delivery station may be configured to dispense at least one milk type liquid. The non-water delivery station may be configured to steam and/or froth the non-water liquid for dispensing into the cup. The non-water delivery station may comprise a plurality of spaced dispensing outlets and may be configured to dispense a different type of non-water liquid from each dispensing outlet.

The robotic transport apparatus may comprise a robotic arm controlled by the controller and having a cup gripper at an end of the robotic arm.

Embodiments also relate to the steps, features, integers, systems, subsystems, apparatus, assemblies, subassemblies, arrangements, configurations, processes, sub-processes, components, circuits, sub-circuits, circuit boards, controllers, machines, control systems, networks, structures, substructures and/or elements disclosed herein or indicated in the specification of this application individually or collectively, and any and all combinations of two or more of said steps, features, integers, systems, subsystems, apparatus, assemblies, subassemblies, arrangements, configurations, processes, sub-processes, components, circuits, sub-circuits, circuit boards, controllers, machines, control systems, networks, structures, substructures and/or elements. Some embodiments relate to methods for coffee preparation, comprising operating a robotic coffee preparation system in a manner to give effect to the control functions of any of the systems, apparatus, stations or machines described above.

The present summary is provided only by way of example, and not limitation. Other aspects of the present invention will be appreciated in view of the entirety of the present disclosure, including the entire text, claims and accompanying figures.

### BRIEF DESCRIPTION OF DRAWINGS

Embodiments are described in further detail below, by way of example and with reference to the accompanying drawings, in which:

FIG. 1 is a block diagram of a coffee preparation management system;

FIG. 2 is a block diagram of an autonomous coffee preparation system;

FIG. 3 is a plan view of a layout of components of the coffee preparation system of FIG. 2;

FIG. 3a is a perspective view of the autonomous coffee preparation system of FIG. 2;

FIG. 4 is a perspective view of an example brewing machine forming part of the autonomous coffee preparation system;

FIG. 5 is a further perspective view of an example brewing machine forming part of the autonomous coffee preparation system, showing an example drip tray arrangement;

FIG. 6 is a perspective view of an example gripper mechanism forming part of the autonomous coffee preparation system;

FIG. 7 is a perspective view of an example tool storage rack forming part of the autonomous coffee preparation system;

FIG. 8 is a perspective view of an example tool storage rack, shown with tools (group handles) positioned therein;

FIG. 9 is a perspective view of an example coffee grinder and doser forming part of the autonomous coffee preparation system;

FIG. 10 is a close-up perspective view of part of the coffee grinder,

FIG. 11 is a close-up perspective view of part of the doser,

FIG. 12 is a cross-sectional view of an interior of the doser;

FIG. 13 is a perspective view of an example sweetener supply forming part of the autonomous coffee preparation system;

FIG. 14 is an exploded view of the internal components of the sweetener supply;

FIG. 15 is a perspective view of an example milk supply forming part of the autonomous coffee preparation system;

FIG. 16 is a perspective view of an example compactor forming part of the autonomous coffee preparation system;

FIG. 17 is an exploded view of a lid dispenser forming part of the autonomous coffee preparation system;

FIG. 18 is an exploded view of a cup dispenser forming part of the autonomous coffee preparation system;

FIG. 19 is a perspective view of an example of cup and lid dispenser placement on a cabinet separator

FIG. 20 is a perspective view of an example weight reduction station forming part of the autonomous coffee preparation system;

FIG. 21 is a perspective view of an example weigh station forming part of the autonomous coffee preparation system;

FIG. 22 is a perspective view of an example grounds disposal station forming part of the autonomous coffee preparation system;

FIG. 23 is a perspective view of an example drip tray forming part of the autonomous coffee preparation system;

FIG. 24 is a side view of an example robotic staging arm forming part of the autonomous coffee preparation system;

FIG. 25 is a close-up perspective view of an example robotic staging arm end effector assembly forming part of the autonomous coffee preparation system;

FIG. 26 is perspective view of an example robotic brewing arm forming part of the autonomous coffee preparation system;

FIG. 27 is a close-up perspective view of an example robotic brewing arm end effector assembly forming part of the autonomous coffee preparation system;

FIG. 28 is a perspective view of an example lower cabinet frame forming part of the autonomous coffee preparation system;

FIG. 29 is a perspective view of an example air supply forming part of the autonomous coffee preparation system;

FIG. 30 is a close-up perspective view of a part of the lower cabinet frame;

FIG. 31 is a perspective view of an example ingredient supply and waste separator forming part of the autonomous coffee preparation system;

FIG. 31 is a perspective view of an example ingredient supply and waste separator forming part of the autonomous coffee preparation system;

FIG. 32 is a close-up perspective view of a sealing aperture forming part of the autonomous coffee preparation system;

FIG. 33 is a front perspective view of an example first brewing waste container forming part of the autonomous coffee preparation system;

FIG. 34 is a front view of an example second brewing waste container forming part of the autonomous coffee preparation system;

FIG. 35 is a front view of an example hydraulic control interface forming part of the autonomous coffee preparation system;

FIG. 36 is a first circuit diagram of an example hydraulic system forming part of the autonomous coffee preparation system;

FIG. 37 is a second circuit diagram of an example hydraulic system forming part of the autonomous coffee preparation system;

FIG. 38 is a perspective view of a water supply forming part of the autonomous coffee preparation system;

FIG. 39 is a perspective view of an upper cabinet frame forming part of the autonomous coffee preparation system;

FIG. 40 is a close-up perspective view of delivery portal safety sensor forming part of the autonomous coffee preparation system;

FIG. 41 is a perspective view of delivery portal forming part of the autonomous coffee preparation system;

FIG. 42 is a front view of delivery portal forming part of the autonomous coffee preparation system;

FIG. 43 is a perspective view of an interface device housing forming part of the autonomous coffee preparation system;

FIG. 44 is a back view of a Robotic Control Unit 4400;

FIG. 45 is a back view of a Robotic Driver Unit 4500;

FIG. 46 is a front and back view of a Coffee Preparation System Controller 240;

FIG. 47 is a picture of an example Actuator Microcontroller 4700;

FIG. 48 is a picture of an example 10 Expander Board 4800;

FIG. 49 is a schematic diagram of a Waste Separation Pump Control Circuit 4900;

FIG. 50 is a picture of an example sensor microcontroller 5000;

FIG. 51 is a schematic illustration of a pressure transducer 5100;

FIG. 52 is a perspective view of the collection shelf 4100 of FIG. 41 with cup detection sensors 5210;

FIG. 53 is a schematic illustration of a light curtain 5300;

FIG. 54 is a picture of an example Load Cell Signal Processor 5400;

FIG. 55 is a diagram of an example front plate of an electronics enclosure 5500;

FIG. 56 is a picture of an example Robot IO board 5600;

FIG. 57 is a picture of an example safety board 5700;

FIG. 58 is a perspective view of a wire loom 5800;

FIG. 59 is a view of the wire loom of FIG. 58 arranged in a lower cabinet;

FIG. 60 is a schematic diagram of a router driven communications network 6000;

FIG. 61 is a schematic diagram of a USB port driven communications network 6100;

FIG. 62 is a picture of an example foaming station microcontroller 6200 of the foaming station 204 of FIG. 2;

FIG. 63 is a picture of an example modified internal touch screen controller board 6300 of the foaming station 204 of FIG. 2;

FIG. 64 is a picture of an example Brewing Station Microcontroller 6400 of the Brewing Station 202 of FIG. 2;

FIG. 65 is a schematic diagram of a grinding station power box relay 6500 for the grinding station 203 of FIG. 2;

FIG. 66 is a perspective view of an example grinding station power box 6600 for the grinding station 203 of FIG. 2;

FIG. 67 is an example process flow diagram for a robotic staging arm;

FIG. 68 is an example process flow diagram for a robotic brewing arm;

FIG. 69 is a block diagram of parts of the coffee preparation system 110 showing its software components and modules;

FIG. 70 is an online order cycle flowchart 7000;

FIG. 71 is block diagram of logical dashboard components 7100 of the Coffee Preparation Array Configuration Server 120 of FIG. 1;

FIG. 72 is a support procedure flowchart 7200;

FIG. 73 is a dose calibration flowchart 7300;

FIG. 74 is another dose calibration flowchart 7400;

FIG. 75 is another dose calibration flowchart 7500;

FIG. 76 is power up sequence flow diagram 7600 for Coffee Preparation System Controller 240 of FIG. 2;

FIG. 77 is a data flow diagram 7700 show part of the data flow controlled by the Coffee Preparation System Controller 240 of FIG. 2;

FIG. 78 is an order processing flowchart 7800;

FIG. 79 is a coffee allocation flowchart 7900;

FIGS. 80, 80A and 80B in combination show an automated brewing flowchart 8000;

FIGS. 81, 81A and 81B in combination show a coffee delivery process flowchart 8100;

FIG. 82 is a block diagram of a coffee preparation management system implementing a geofence;

FIG. 83 is a flowchart illustrating the steps of geofence-based ordering.

FIG. 84 is top perspective view of an example brewing machine forming part of the autonomous coffee preparation system;

FIG. 85A is a top view of an example brewing machine forming part of the autonomous coffee preparation system, showing a drip tray arrangement;

FIG. 85B is a top view with transparent features of an example brewing machine forming part of the autonomous coffee preparation system, showing a drip tray arrangement;

FIG. 86 is a bottom perspective view of an example brewing machine forming part of the autonomous coffee preparation system showing a drip tray arrangement;

FIG. 87A is a top perspective view of an example drip tray arrangement forming part of the autonomous coffee preparation system;

FIG. 87B is a front sectional view of an example drip tray arrangement forming part of the autonomous coffee preparation system;

FIG. 88A is a front sectional view of an example cleaning station within a drip tray arrangement forming part of the autonomous coffee preparation system;

FIG. 88B is a second front sectional view of an example cleaning station within a drip tray arrangement forming part of the autonomous coffee preparation system;

FIG. 88C is a top view of an example cleaning station within a drip tray arrangement forming part of the autonomous coffee preparation system;

FIG. 88D is a top perspective of an example cleaning station within a drip tray arrangement forming part of the autonomous coffee preparation system;

FIG. 89 is a front perspective view of an example tool storage rack forming part of the autonomous coffee preparation system;

FIG. 90A is a bottom perspective view of an example group handle used by the autonomous coffee preparation system;

FIG. 90B is a side sectional view of an example group handle forming part of the autonomous coffee preparation system;

FIG. 91 is a perspective view of an example robotic arm forming part of the autonomous coffee preparation system;

FIG. 92 is a side sectional view of an example cup gripper forming part of the autonomous coffee preparation system;

FIG. 93A is a top perspective view of an example coffee grinder and integrated dosing and compacting station forming part of the autonomous coffee preparation system;

FIG. 93B is a top perspective view of an example coffee grinder and integrated dosing and compacting station forming part of the autonomous coffee preparation system, pictured without housing;

FIG. 94 is a side view of an example coffee grinder and integrated dosing and compacting station forming part of the autonomous coffee preparation system, pictured without housing;

FIG. 95A is a perspective view of an example integrated dosing and compacting station forming part of the autonomous coffee preparation system;

FIG. 95B is a perspective exploded view of an example integrated dosing and compacting station forming part of the autonomous coffee preparation system;

FIG. 96A is side sectional view of an example integrated dosing and compacting station forming part of the autonomous coffee preparation system;

FIG. 96B is double sectional view of an example integrated dosing and compacting station forming part of the autonomous coffee preparation system;

FIG. 97A is side sectional view of an example integrated dosing and compacting station forming part of the autonomous coffee preparation system, pictured with a compacting piston in a disengaged position.

FIG. 97B is side sectional view of an example integrated dosing and compacting station forming part of the autonomous coffee preparation system, pictured with a compacting piston in an engaged position.

FIG. 98A is a top view of an example integrated dosing and compacting station forming part of the autonomous coffee preparation system;

FIG. 98B is a top view with transparent features of an example integrated dosing and compacting station forming part of the autonomous coffee preparation system;

FIG. 99 is a side sectional view of an example integrated dosing and compacting station forming part of the autonomous coffee preparation system;

FIG. 100A is a side sectional view of an example integrated dosing and compacting station forming part of the autonomous coffee preparation system, pictured with fine alignment piston disengaged;

FIG. 100B is a side sectional view of an example integrated dosing and compacting station forming part of the autonomous coffee preparation system, pictured with fine alignment piston engaged;

FIG. 101 is a perspective view of an example milk dispenser with cup holders;

FIG. 102 is a perspective view of an example delivery portal forming part of the autonomous coffee preparation system;

FIG. 103A is a perspective view of an example delivery chamber forming part of the autonomous coffee preparation system;

FIG. 103B is an exploded perspective view of an example delivery chamber forming part of the autonomous coffee preparation system;

FIG. 104 is a side view of an example delivery chamber forming part of the autonomous coffee preparation system;

FIG. 105 is a plan view of a layout of components of an example coffee preparation system;

FIG. 106A is a perspective view of an example weigh station forming part of the autonomous coffee preparation system;

FIG. 106B is a first side view of an example weigh station forming part of the autonomous coffee preparation system;

FIG. 107A is a second side sectional view of an example weigh station forming part of the autonomous coffee preparation system;

FIG. 107B is a first sectional view of an example weigh station forming part of the autonomous coffee preparation system;

FIG. 108 is a perspective view of an example cup gripper assembly and robotic arm forming part of the autonomous coffee preparation system;

FIG. 109 is a first perspective view of an example integrated dosing and compacting station forming part of the autonomous coffee preparation system;

FIG. 110A is a second perspective view of an example integrated dosing and compacting station forming part of the autonomous coffee preparation system;

FIG. 110B is a third perspective view of an example integrated dosing and compacting station forming part of the autonomous coffee preparation system, with the dosing and compacting portions pictured separately;

FIG. 111 is an exploded view of a rotatable compacting piston forming part of the autonomous coffee preparation system;

FIG. 112 is a perspective view of an example dosing portion of an integrated dosing and compacting station forming part of the autonomous coffee preparation system;

FIG. 113 is a side sectional view of an example integrated dosing and compacting station forming part of the autonomous coffee preparation system;

FIG. 114A is a perspective view of an example cleaning station within a drip tray arrangement forming part of the autonomous coffee preparation system;

FIG. 114B is a side sectional view of an example cleaning station within a drip tray arrangement forming part of the autonomous coffee preparation system; and

FIG. 115 is a plan view of a layout of components of an example autonomous coffee preparation system according to some embodiments;

FIG. 116A is a first example of a coffee ordering user interface display;

FIG. 116B is a second example of a coffee ordering user interface display; and

FIG. 116C is a third example of a coffee ordering user interface display.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

Embodiments generally relate to systems, apparatus and methods concerned with autonomous preparation of brewed beverages, such as coffee beverages. Some embodiments make use of at least one robotic arm in the brewed beverage preparation. Various embodiments use two robotic arms. Various embodiments have multiple separately controlled components with which the at least one robotic arm can interact as part of the coffee preparation process. Some embodiments are coffee vending machines and include a user interface for placing an order and a payment interface to make a payment. Embodiments may also autonomously prepare and serve hot or warm beverages other than coffee. Such beverages may be prepared using hot or warm water from a water supply station and/or a non-water liquid from a non-water supply station. Such non-water liquids may include one or multiple types of milk, for example. Beverages prepared using water and/or non-water liquids may not require brewing, for example. For simplicity of description, this disclosure focuses on embodiments concerning autonomous preparation of brewed coffee beverages, but various aspects and embodiments can also be used for beverage preparation of a different kind.

Various embodiments herein are concerned with preparation and delivery of brewed beverages, such as coffee that is prepared by passing water through coffee grounds. Other types of beverages can be brewed using embodiments described herein in a similar manner by passing water through a (usually) dry granulated beverage ingredient material. Brewed beverages can be distinguished from non-brewed beverages (e.g. prepared by admixture of ingredients) by the fact that brewed beverages are prepared by passing a liquid such as water through a beverage ingredient that leaches some of its material into the liquid but which is generally not dissolved into the liquid. As a result, brewed beverages leave a spent beverage ingredient (e.g. coffee grounds or tea leaves) as a waste product, while non-brewed beverages such as instant coffee generally have the dry ingredient become part of the beverage, generally leaving no waste residue or barely any residue.

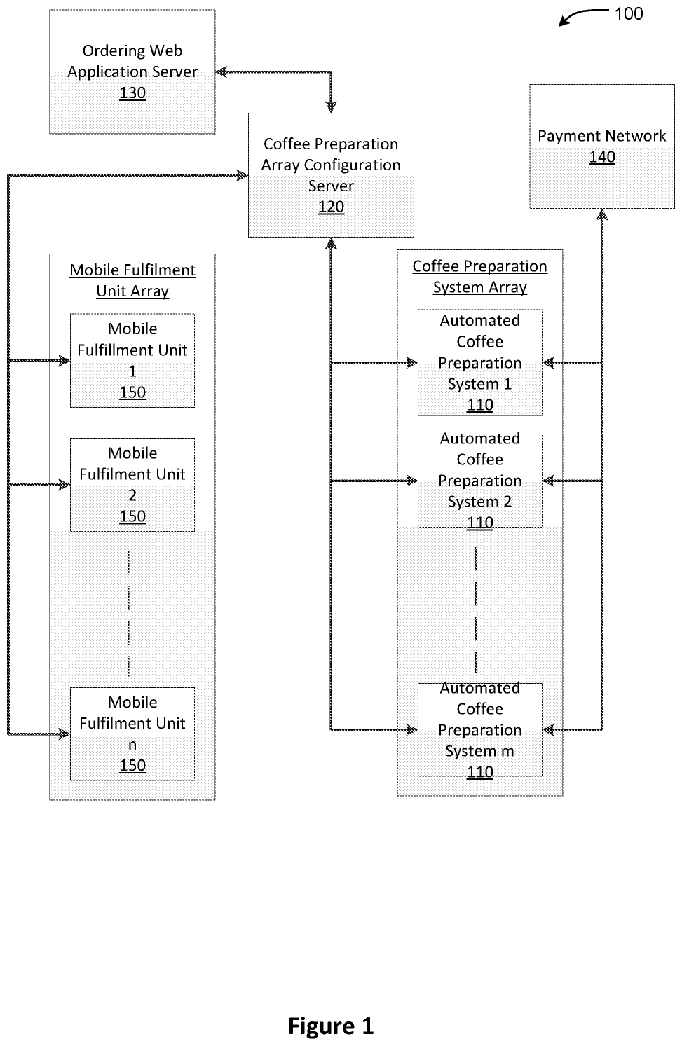

Some embodiments relate generally to a coffee preparation management system 100, as shown in FIG. 1. Such systems also act as coffee vending systems. Coffee preparation management system 100 comprises a plurality or array of automated coffee preparation systems 110 located at various spaced geographic locations, such as around urban centres like cities. Coffee preparation management system 100 further comprises a coffee preparation array configuration server 120 in communication with the automated coffee preparation systems 110 over one or more networks, including public and/or private data or telephony networks.

Coffee preparation management system 100 further comprises at least one and possibly a plurality (array) of mobile fulfillment units 150 that can travel between automated coffee preparation systems 110 for servicing and replenishing of coffee-making supplies. Coffee preparation management system 100 further comprises an ordering web application server 130 in communication with the coffee preparation array configuration server 120, and a payment network 140 in communication with each of the automated coffee preparation systems 110. All of such communication is via one or more networks, including public and/or private data or telephony networks. The payment network 140 operates to effect payment processing for coffee orders received by the automated coffee preparation systems 110 and received via the ordering web application server 130 (e.g. through interaction with a client device executing a suitable coffee ordering application).

These automated coffee preparation systems 110 are configured to automatically log a request for servicing or supply replenishment with the coffee preparation array configuration server, which then allocates the service or replenishment request to one of the mobile fulfillment units 150. The allocation may be based on a comparative location proximity of the mobile fulfillment units 150 and/or coffee making supply levels of specific mobile fulfillment units 150 and/or the number of requests already queued for the mobile fulfillment units 150.

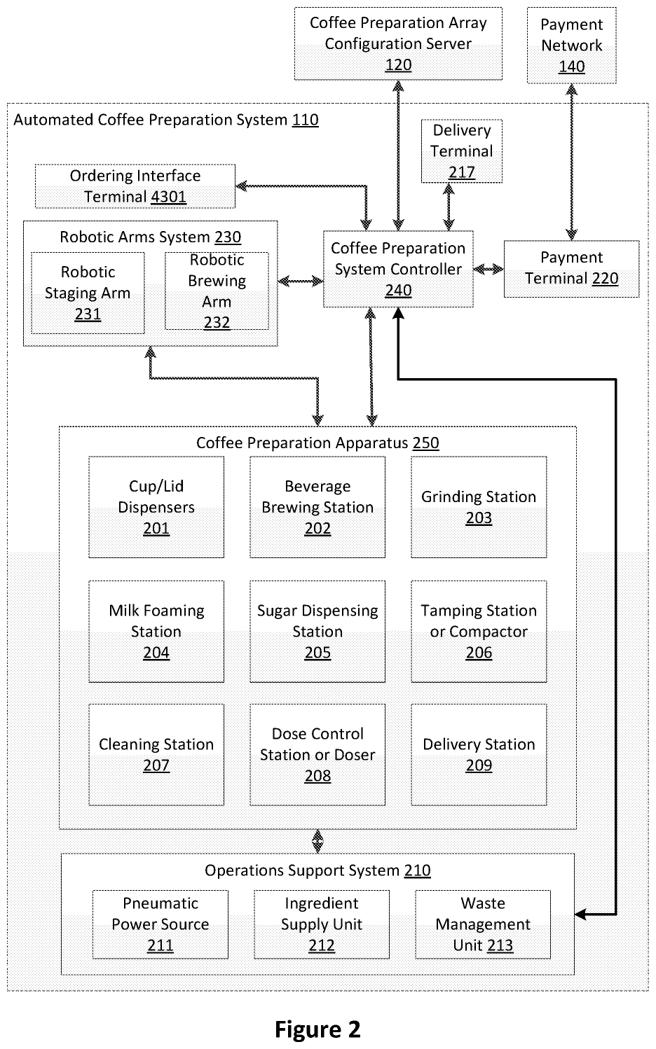

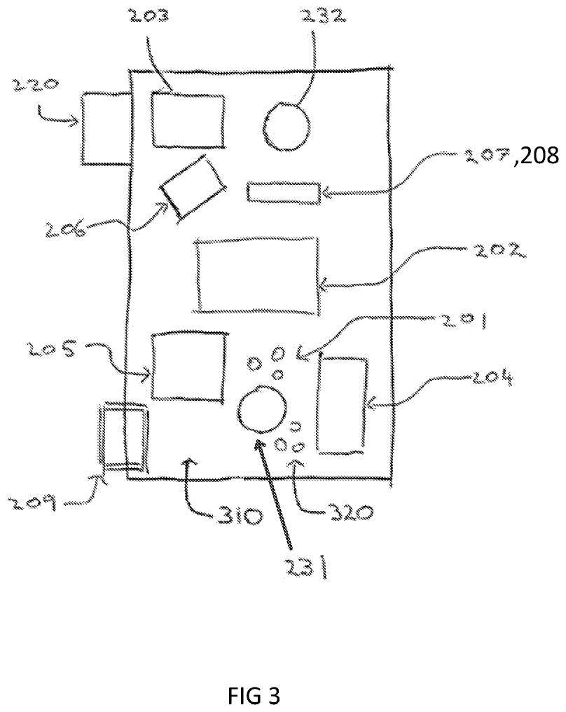

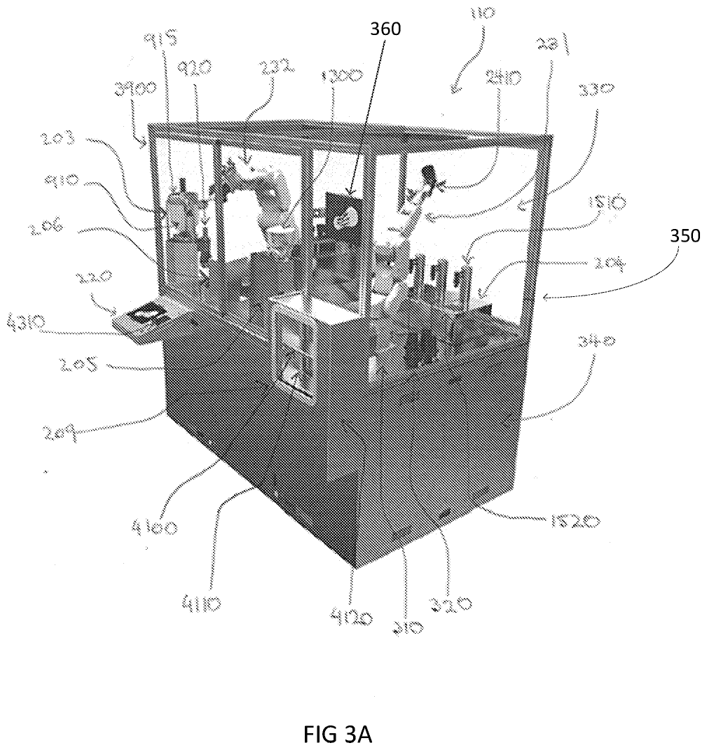

FIG. 2 is a block diagram of parts of the system of FIG. 1, but showing the automated coffee preparation system 110 in further detail. The automated coffee preparation system 110 comprises a coffee preparation system controller 240 that interfaces with and controls operation of a robotic arms system and a coffee preparation system or apparatus, as well as operations supports system 210. The automated coffee preparation system 110 functions as an autonomous coffee preparation system run by the controller 240 and comprises a system housing 350 comprising upper and lower cabinets 340, 330 (best seen in FIG. 3A). The system housing 350 is self-contained, in that it does not need to be connected to a local water supply, except that system 110 does rely on supply of electrical power from a local power source, such as a mains power supply. The robotic arms system 230 is disposed inside the system housing 350. System housing 350 is designed to prevent unauthorised access into the internal spaces of the system housing, so that inadvertent human injuries can be avoided and tampering with the system is avoided or mitigated. The coffee preparation apparatus 250 and the operation support system 210 are also disposed inside the system housing 350. This arrangement allows a system 110 to be located within a publicly accessible area, such as a lobby of an office building or in an airport lounge, for example, where the only requirement at that location is that mains power is available.

The coffee preparation system 110 further comprises an ordering interface terminal 4301 located on or in proximity to the system housing 350, in order to allow a user to input a coffee order. Such an ordering interface may be computerised and provided by a computing device such as an iPad™, for example. Physically located with or nearby the ordering interface may be a payment terminal 220, such as a credit or debit card or other card payment terminal, for example. The automated coffee preparation system 110 may in some embodiments be configured to receive physical currency for payment of a coffee order generated through ordering interface terminal 4301. The payment terminal 220 may interact with a payment network 140 over a wired or wireless network to effect payment transactions according to known techniques.

The automated coffee preparation system 110 further comprises a delivery portal or station 209 and a delivery interface or display, such as a delivery terminal 217 computing device to display information associated with fulfilled (i.e. prepared) coffee orders. Such displayed information may include a name input by the user along with the coffee order that has been prepared. The delivery terminal 217 may be physically located nearby the delivery station or portal 209 on or in the system housing 350.

Embodiments of coffee or other beverage preparation systems described herein are generally autonomous in the sense they are controlled without human input after initial placement of the beverage order and during the preparation process. In other words, the only human interaction needed is to place an order by the order interface (at the physical machine or online via a client device) and to manually remove a completed beverage from the delivery portal of the machine.

The robotic arms system 230 comprises multiple robotic arms. The robotic arms system 230 comprises a robotic staging arm 231 and a robotic brewing arm 232. The robotic arms 231, 232 are each configured to perform certain separate sets of coffee preparation tasks, under the control of the coffee preparation system controller 240. Those different tasks are described in further detail below.

Coffee preparation apparatus 250 comprises a number of separate functional components to assist in the preparation of coffee beverages, each of which is accessible to the robotic arms system 230. Some of the components of coffee preparation apparatus 250 are accessible only to the robotic brewing arm 232 and some are accessible only to the robotic staging arm 231. The coffee preparation apparatus 250 comprises one or more groups of cup and lid dispensers 201, a beverage brewing station 202, a grinding station 203, a milk dispensing (and foaming) station 204, a sugar dispensing station 205, a tamping or compaction station 206, a puck cleaning station 207, a dose control station 208 and the delivery portal or station 209.

The coffee preparation apparatus 250 further comprises weigh stations to weigh the amount of grounds dispensed into a group handle filter basket and/or to weigh the amount of liquid coffee dispensed into a cup by the beverage brewing station 202. Further, the coffee preparation apparatus 250 comprises a tool storage station to store group handles while they are not being used in the beverage brewing process.

The robotic brewing arm 232 is responsible for performing tasks associated with receiving coffee grounds, dose control of received coffee grounds and brewing. The robotic brewing arm 232 therefore has access (and reaches) to the beverage brewing station 202, the grinding station 203, the tamping or compacting station 206, the cleaning station 207 and the dose control station 208. Further, the robotic brewing arm 232 has access to a transfer station for cup transfer between the robotic staging arm 231 and the robotic brewing arm 232.

Each of the robotic brewing arm 232 and the robotic staging arm 231 have a pneumatically actuated cup gripper at a distal end of the arm for handling coffee cups in an upright position. As described herein, the robotic arms 231, 232 also have other actuatable engagement elements, such as a handle gripper on robotic arm 232 and a lid suction element on robotic arm 231, for example.

The cup and lid dispensers 201, the milk dispensing (foaming) station 204, the sugar dispensing station 205 and the delivery station or portal 209 are accessible to the robotic staging arm 231. Therefore, as part of the coffee preparation process, while the robotic brewing arm 232 is preparing grounds in a group handle for coupling to the beverage brewing station 202, the robotic staging arm 231 retrieves a suitable number of cups from the cup and lid dispensers 201 and places them at the transfer station. The transfer station may be on top of or located nearby the beverage brewing station 202. The transfer station is thus located at a position that is readily accessible by both of the robotic staging arm and robotic brewing arm 232.

The operations support system 210 comprises a pneumatic power source 211, an ingredients supply unit 212 and a waste management unit 213. Although not shown, the automated coffee preparation system 110 has an electrical power supply system that runs on mains power received from a nearby mains power source. The operation support system 210 is under control of the coffee preparation system 240 and interacts with the coffee preparation apparatus 250 to provide coffee supplies as appropriate and dispose of waste as appropriate.

The pneumatic power source 211 may be used to supply pressurised air to the cleaning station 207 and/or the pneumatically actuated parts of the robotic arms system 230, for example. Ingredients supply unit 212 may supply milk to the milk foaming station 204, sugar to the sugar dispensing station 205 and/or coffee beans to the grinding station 203. Where the ingredients supply unit 212 supplies milk to the milk foaming station 204, it does so under the control of coffee preparation system controller 240 in order to supply a selected one of multiple available milk products. Although the sugar dispensing station 205 may dispense only a single kind of sugar, in some embodiments, multiple sugar or sweetener dispensing options may be provided and supplied through ingredients supplied at 212.

Waste management unit 213 is arranged to dispose of spent coffee grounds received through cleaning station 207 and also to receive and dispose of liquid waste received from drip trays at the beverage brewing station 202 and/or milk dispensing station 204. Further, some unused coffee grounds may be removed from the tamped (compressed) puck of coffee grounds (in the filter basket at the dose control station 208) and such removed coffee grounds are received into the waste management unit 213 via the dose control station 208.

FIGS. 3 and 3A show the parts of the automated coffee preparation system 110 that are visible to an observer including the upper cabinet 330 and the lower cabinet 340. The robotic system 230 and the coffee appropriation apparatus 250 are visible to an observer through transparent panes of the system housing 350 in the upper cabinet 330, while the operations support system 210 is contained within the lower cabinet 340 of the system housing 350. This arrangement allows an observer to observe, monitor and potentially derive entertainment from the operation of the robotic arm system 230 and the coffee preparation apparatus 250 visible in the upper cabinet 330 while the coffee beverages are being prepared.

While the automated coffee preparation system 110 has adequate coffee making supplies within the system housing 350 and is operating without malfunction, it can autonomously prepare a large number of coffee beverages according to received coffee orders, without the need for human intervention or interaction in the preparation process. Further, because of the robotic arm system 230 allowing multiple tasks to be performed simultaneously by separate robotic arms that can co-operate (e.g, transfer cups to each other), significant efficiency gains can be achieved in comparison to a system comprising a single robot arm. Additionally, because the various separate coffee preparation components of coffee preparation apparatus 250 are separately controlled and operated, each of those components can be configured to have relatively optimised performance and/or functionality, thereby allowing optimisation and efficiency across the whole system, while preparing a consistently high quality coffee beverage (with precision control) to meet the needs of discerning consumers.

Further, because of the described configuration of the automated coffee preparation system 110 as described herein, multiple coffee orders can be in the course of preparations simultaneously (i.e., in parallel) and each coffee order can have multiple coffee beverages specified within it for delivery at or about the same time through the delivery station or portal 209. The coffee preparation system controller 240 manages queuing of successive coffee orders for improved efficiency purposes, while making sure to deliver an earlier ordered coffee beverage sooner than a later ordered coffee beverage, even where both of those beverages may have been in preparation simultaneously (i.e. through simultaneous use of different brewing heads at the beverage brewing station 202).

The described configuration allows for more than 100 distinct coffee beverages to be prepared within an operational day (which may be less than 24 hours) without needing servicing or supply replenishment. More than 200, 300, 400 or 500 distinct coffee beverages may be prepared in this way within a single operating day. In fact, the automated coffee system 110 as described herein is designed and configured to enable up to 600 separate coffee beverages to be prepared within an operational day before servicing and/or supply replenishment is required. The operational day may generally correspond with likely consumer hours for coffee beverages, such as 5:00 am to midnight, for example.

Beverage Brewing Station:

The beverage brewing station 202 may include at least one brewing apparatus, such as a modified group machine 400, with at least one group head 430, a number of group handles 600 and a tool holder 700 configured to receive and store the group handles 600.

The beverage brewing station 202 may comprise a modified group machine. In one embodiment this machine may be a commercially available cafe grade machine consisting of at least two group heads 430, a steam boiler, a brew boiler, a mixer tap 420 and on board control unit. This may be modified both electrically and mechanically to adapt this to suit the interactions of both robotic arms 231, 232 and fixing onto the cabinet separator surface 310.

The beverage brewing station 202 may be selected based on factors such as reliability, quality of coffee produced, availability of replacement parts, cost of acquisition, and/or the familiarity of technicians with the model and potential modifications. In one embodiment, the beverage brewing station 202 may be a modified La Marzocca™ Linea Classic Two Group Machine for example, which is understood as a machine that has demonstrated strong performance in the above areas.

In some embodiments, internal and external modifications are required to adapt an existing group machine to fit the requirements of the overall system 110. These may include the following:

| | Internal Modifications | External Modifications |
|---|---|---|
| 1 | Addition of mixer tap 420 | Front upper switch panel |
| | to adjust temperature of | removed and replaced |
| | dispensed hot water | with blanked top plate |
| | | integrated panel |
| 2 | Repurposing of steam boiler to | Stock drip-tray removed |
| | deliver hot water to cleaning | and replaced with custom |
| | station 207. This may be achieved | CNC-machined unit with |
| | by removing the original hot water | load-cells 2320. |
| | tap line from the boiler, addition of | |
| | a T-junction and valve for control | |
| | purposes and reattaching the line | |
| | out to the hot water mixer tap 420. | |
| 3 | Steam wand removal | Upper cup warmer panels |
| | | replaced with handover |
| | | staging rack 410. |
| 4 | Addition of temperature probe or | Mixer tap 420 relocated |
| | pressure sensors added to boilers | to bent panel mount. |
| | for feedback. | |
| 5 | Relocation of water feed line-in | Mount feet removed and |
| | and distribution block away from | replaced with rigid |
| | front panel. In some embodiments | mount 440, achieving |
| | this may be a necessity to | more accurate and |
| | accommodate the replacement of | repeatable placement |
| | the standard drip tray with a | on table surface. |
| | custom load-celled drip tray 500. | |
| 6 | Rigid copper group exhaust lines | Addition of a staging |
| | replaced with flexible silicone lines | rack 410 as a handover |
| | with barb tee pieces. This may | point between robotic |
| | allow flexible placement of the | arms 231, 232 |
| | beverage brewing station 202 and | |
| | may mitigate potential | |
| | misalignment of the drip tray 500. | |

A staging rack 410 may be mounted on top of the group machine 400. The staging rack 410 comprises a platform designed to receive and hold individual cups during the order and brewing process. The staging rack 410 also comprises at least one cup position. These positions define a location where a cup may be placed or retrieved by a robotic arm system 230. These positions provide stabilisation and alignment to the cups placed in them, holding them in an easily retrievable manner.

In some embodiments the cup positions comprise recessed portions machined into the staging rack 410. The staging interior wall of this recess providing stabilisation. The interior edges of the recessed portion may be further chamfered to allow for correction of misalignment by a robotic arm system 230.

In some embodiments the cup positions comprise raised discs, affixed to the staging rack platform. These discs with a machined edge suitable for containing cups. The interior of the machined edge of the disc may be further chamfered to allow for correction of misalignment by a robotic arm system 230.

In some embodiments, the beverage brewing station 202 may be a custom built unit obviating the need for modification of an existing group machine.

Group Handles and Tool Holder:

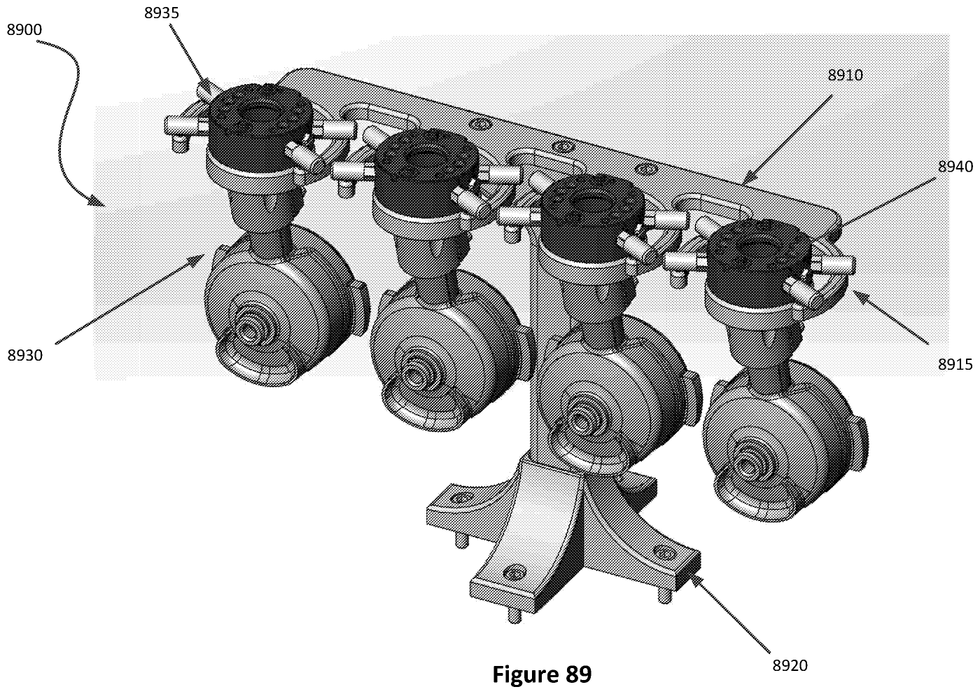

As part of the coffee preparation system, group handles 600 are provided to function as portable filters. In some embodiments, the group handles 600 may be a combination of purchased, cast group handles formed with a compatible and industry standard group handle size, such as 58 mm. In some embodiments, the group handle shank 620 is modified or machined to interface with a robotic end tool such as a jaw gripper 630 or a pneumatic coupler, such as is shown and described in relation to FIGS. 89 to 92.

The group handles 600 may be stored and accessed by a robotic brewing arm 232 in a tool holder 700. The holder may be composed of a tool holder body 710 bolted to the cabinet separator 310. Additionally, the holder incorporates tool holder channels 720 that interface with the group handle shank 620 with a tight tolerance, allowing for accurate pickup and placement of tools by a robotic brewing arm 232. In some embodiments the tool holder channels 720 and group handle shank 620 may comprise a hexagonal interface. The hexagonal interface allows for stable, consistent storage, and minimises risk of misalignment of the tool handle shank 620 within the tool holder 700.

Drip Tray:

The drip tray 500 may comprise a solid cast aluminium unit positioned in front of the group machine 400, below the group heads 430. The primary purpose is to catch liquid waste from the brewing process and group head cleaning process, as well as support and weigh the cups during the brewing process.

The drip tray 500 is also being used to catch drips from the group handles 600 after the puck cleaning process performed by the cleaning station 207.

The drip tray 500 may have mounting brackets, rails, or hollow portions for at least one drip tray load cell 2320. In some embodiments, the drip tray load cells 2320 may be a pair of 600 g Model 1004 Tedea-Huntleigh™ load cells for example. The load cells 2320 measure the mass of brewed coffee in the cup and allow for a consistent delivered product. The drip tray 500 may also be mounted with at least one cup platform 2310 designed to hold and receive cups from a robotic brewing arm 232. In some embodiments the cup platform 2310 is 3D printed with cup locating segments of 3 mm diameter wire bar across the bottom to receive the cups from a robotic brewing arm 232 and locate the cups correctly under the group. In some embodiments, a cup platform 2310 may be positioned under a mixer tap 420 to provide a support for a cup receiving a water dose.

The inner surface of the drip tray 500 may be sloped to guide liquid waste towards the drip tray outlet port 2330, which routes through the table surface to lower waste vat 3300. The drip tray 500 may also have a pressure relief valve, which allows steam/water from the group machine brewing process to be vented through to the upper waste vats 3400 and the group exhaust nozzle.

Grinding Station:

The grinding station 203 may include at least one grinder 900, an ingredient supply assembly, and grinder dose tube 920 to act as a doser or dispenser. The dose tube (doser) provides ground coffee into a required dose, received in a group handle basket 610 for filtering during espresso preparation. The group handle basket 610 may also be described as a filter basket.

In some embodiments, the grinder 900 is a modified Mazzer Robur™ grinder for example. Modifications to the grinder may include removal of exterior casings to the cast motor casing, and removal of externally mounted systems such as the ground coffee delivery system. In other embodiments, a suitable alternative conical burr grinder may be used.

The grinder 900 may comprise a grinder hopper 910 with a customised grinder hopper lid 915. The grinder hopper lid 915 may be designed and machine to allow coupling to a feeder tube 930. The grinder hopper lid 915 may be secured with thumbscrews so that the lid assembly can be opened for maintenance and cleaning.

The grinding station 203 may incorporate ingredient level sensors 950, which may be mounted to the side of the grinder hopper 910, for example. These sensors 950 provide output signals to the controller 240 and are configured to detect when the level of beans in the grinder hopper 910 falls below a predetermined level, at which point a bean refill vacuum 940 may be triggered (through a control signal transmitted by the controller 240 or local circuitry at the grinding station 203) to refill the grinder hopper 910. In some embodiments, the ingredient level sensors 950 may comprise light sensors. This allows for steady and consistent bean volumes during coffee preparation without need for manual oversight.

To adjust the ingredient grind size, a stepper motor 1010 may be mounted and coupled to the grind adjustment gear 1000 on the machine allowing grind coarseness to be adjusted electronically. In some embodiments a NEMA™ 24 stepper motor may be configured for this purpose for example.

In some embodiments, the existing ground coffee delivery system is replaced with a custom machined grinder dose tube 920. In such embodiments, the grinder dose tube 920 is coupled to the existing grind outlet and directs coffee grounds through the hollow delivery shaft, directly into a group handle basket 610 held by a robotic brewing arm 232. This allows for a precise dose to be delivered directly into a group handle basket 610 with minimal waste.

The grinder 900 may be spaced above the table via a stack of laser cut plates, and the base of the unit, including spacer plates and the cast grinder housing, may be concealed by an aluminium sheet casing. The spacer plates provide clear access by a robotic brewing arm 232

In the lower cabinet 340, the grinder input power may be directed through a grinder power box relay circuit mounted directly below the unit. A hole in the cabinet separator 310 below the grinder dose tube 920 may catch excess grinds and direct them to the grind separation unit 3100.

In some embodiments, the grinding station 203 may be a custom built unit having the described functionality, obviating the need for modification of an existing grinder.

Sugar Dispensing Station:

A sugar dispending station 205 may comprise a modified stock sugar dispenser, such as an AromaCup™ AC2000 Dispenser for example. The dispensing station mechanism dispenses a repeatable volume of sugar with the oscillating rotation of the input shaft of approximately 60 degrees. The unit may be housed in custom sugar dispenser housing 1320, and actuated by a sugar dispenser stepper motor 1400.

In some embodiments a custom designed and manufactured dispensing station 205 may be used, with a rotary dispensing wheel 1410. In such embodiments, on each rotation of 45 degrees, sugar fills a dose container 1420 on one side of the dispensing wheel 1410 and dispenses from the sugar spout 1310. Sugar is gravity fed from the sugar hopper 1300 into a number of sugar dose containers 1420 in the rotary dispensing wheel 1410 as it rotates.

The sugar supply may sit above the housing 1320 in the hopper 1300 and dispense sugar out of the sugar spout 1310 below the sugar hopper 1300. In some embodiments the sugar hopper 1300 holds a minimum of 3.6 L of sugar to account for estimated sugar use with a safety factor of 1.2.

In some embodiments the sugar dispenser stepper motor 1400 may comprise a NEMA™ 23 stepper motor for example. Power and control inputs are supplied through the bottom of the unit from below the cabinet separator 310. Additionally, the sugar dispenser stepper motor 1400 may be positioned within the sugar dispenser housing 1320.

In some embodiments, rotary action of a rotary dispensing wheel 1410 is controlled by a with a spring return microswitch that may engage with notches on the dispensing wheel 1410 to control the rotation angle. This stepper motor may be a NEMA™ 23 stepper motor, for example. The rotary dispensing wheel 1410 may be made of acetal, allowing smooth spinning in the tightly toleranced housing segments.

Milk Foaming Station:

Milk foaming within the coffee preparation system 110 may be completed by at least one milk foaming station 204 which may be comprise at least one milk foaming device 1500. Each milk foaming device 1500 may be supplied with full, skim, or soy milk.

The milk foaming device 1500 may dispense milk based upon manual data entry provided by a coffee technician through testing and calibration with in house replica equipment to accurately produce quality milk coffee types and variations. This may be actuated through electronic control systems interfacing with OEM touch screen protocols. In some embodiments the at least one milk foaming device 1500 may be a rehoused and modified Barissima™ UNO system for example.

In some embodiments, Barissima™ UNO systems may be rehoused to remove touch screen interfaces in order to better suit the form factor required. In some embodiments modifications include reducing overall length and width by inclusion of a font tube as the main outlet position for the milk tap 1510.

In order to accommodate access by a robotic staging arm 231 the milk foaming station 204 may be recessed into the lower cabinet 340 to ensure full access capability.

In some embodiments, milk drip trays 1520 are be installed below the milk taps 1510 to route milk and cleaning waste through the milk foaming station 204 and down into the lower waste vat 3300.

Power, milk, and flashing USB inputs may be accessible from the bottom of the milk foaming station 204.

Tamping Station:

A tamping station 206 may comprise a tamping unit 1600 which compacts coffee grounds into a puck in a group handle basket 610, at least one tamping station spacer plate 1620, and a tamping unit housing.

In some embodiments the tamping unit 1600 may comprise a modified Puq Press™ Automatic Coffee Tamper for example. Modifications to this tamping unit 1600 include removal of the stock housing of the purchased unit, elevation of at least 50 mm within the housing with at least one spacer plate 1620, allowing a robotic brewing arm 232 to approach the tamping station with the group handle basket 610 with adequate clearance between the end effector assemblies 2401, 2601 and the cabinet separator 310.

In some embodiments, the tamping unit 1600 may exert or apply a consistent compacting force digitally adjustable from approximately 100-300 Newtons, a low rate of channeling (7-10%) and automatic tamping action when a group handle basket 610 is placed upon the group handle basket seat 1610. In some embodiments, at least about 200 N (roughly equivalent to about 20 kg weight, if gravity is rounded up from 9.8 m/s² to 10 m/s²), and optionally at least about 300 N (roughly equivalent to about 30 kg weight) of force may be applied in the compaction of the coffee grounds.

Power inputs for the tamping station 206 may come from below the cabinet separator 310, through the spacer plates 1620 and into the bottom of the tamping unit 1600. A tamping station housing may house a push button wired to the tamping unit 1600 which extends the tamp head for cleaning and maintenance purposes.

In some embodiments, the tamping station 206 may be a custom built unit obviating the need for modification of an existing tamper.

Cup/Lid Dispenser:

Cups and lids may be housed within a cup/lid dispenser 201. The cup/lid dispenser 201 may dispense cups through at least one dispenser with at least one spring loaded dispenser tube 1700, providing an upward force upon the cups, to direct the cups to preformed cabinet separator apertures 320 on the cabinet separator 310, within reach of a robotic staging arm 231. The containers may be held in place against an interior flexible membrane 1712 of a dispenser plate assembly 1710 with apertures allowing dispensary access by a robotic staging arm 231.

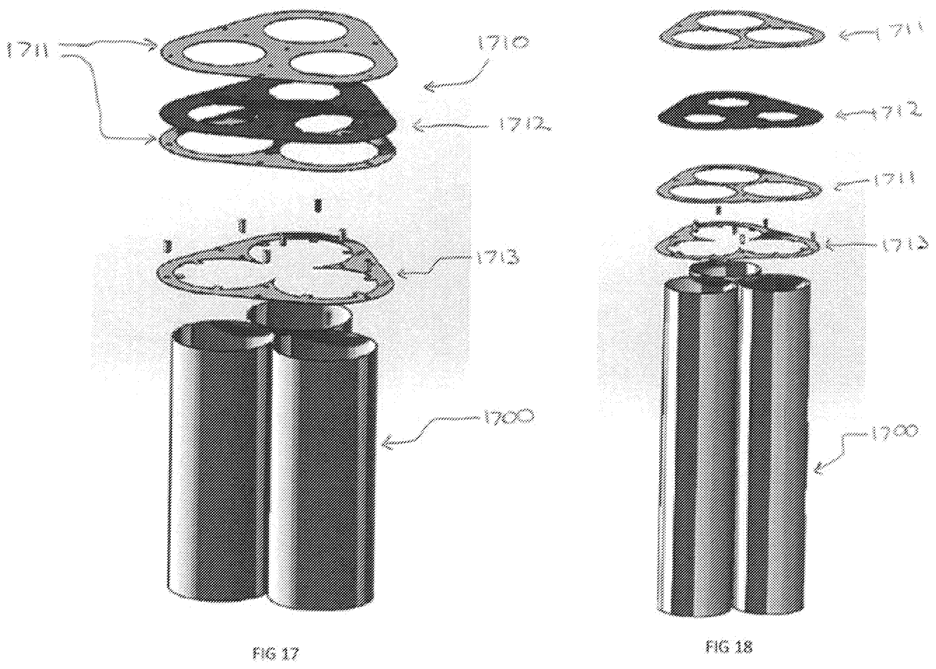

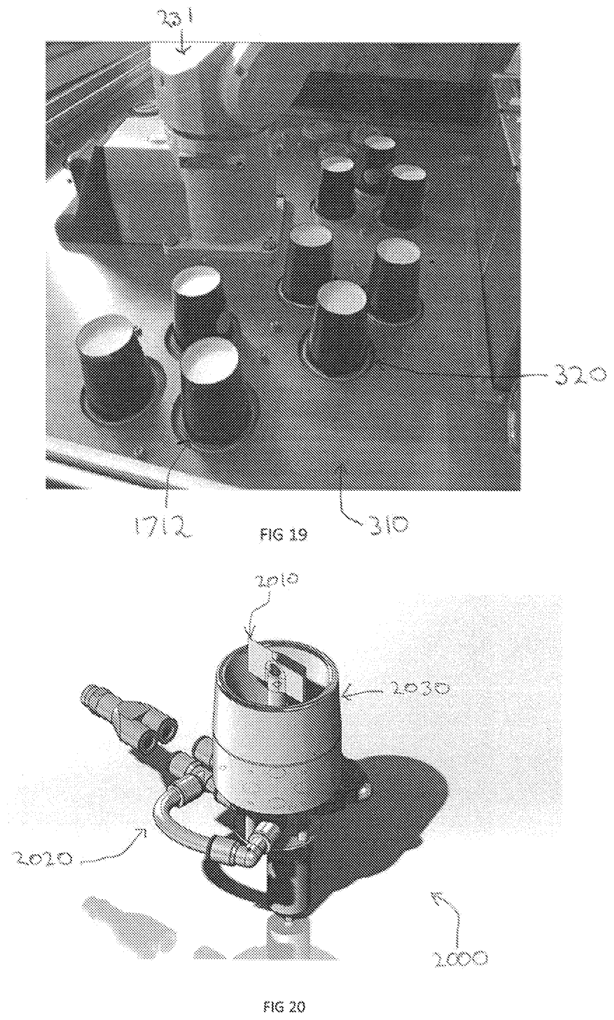

In some embodiments, the dispenser tubes 1700 are arranged in a triangular formation. Each dispenser tube 1700 being loaded with a spring and endplate, upon which the cups rest. FIG. 17 shows storage and dispenser tubes 1700 configured for lids, while FIG. 18 shows storage and dispenser tubes 1700 configured for cups.

In some embodiments, the dispenser plate assembly 1710 may comprise a flexible membrane 1712 mounted between at least one fixing plate 1711. The flexible membrane 1712 is perforated with apertures of a slightly smaller diameter than the cups. The at least one fixing plate 1711 allows a flush fitting below apertures on the cabinet separator 310. In some embodiments the dispenser plate assembly may include a mounting plate 1713 affixing the cup/lid dispenser system 201 to the cabinet separator 310 using countersunk fasteners, flush rivet nuts, or alternative fixing means to allow a flush fitting below the cabinet separator apertures 320.

In some embodiments, the flexible membrane 1712 may be replaced or supplemented by upwardly directed grasping fingers (not shown), which may be arranged around the cup dispensing apertures and formed of silicone, for example. The grasping fingers and/or the flexible membrane 1712 may be arranged with a stiffness, hardness and/or surface condition to apply a frictional resistance that is enough to retain the sup stack in place and resist the spring force that pushes the stack of cups upward, while providing little enough resistance that the staging arm 231 can readily pull a single cup free of the fingers or membrane 1712 without having to crush or substantially deform the cup as it pulls the cup free. Similar arrangements also apply to cup lid storage and dispensing apparatus.

In some embodiments, the fixing plate 1711 includes a base mount to centrally position the cups centrally within the dispenser tubes 1700 and to align correctly with the cabinet separator apertures 320. The base mount comprising a raised disc or trapezoidal extrusion of a smaller diameter than a cup opening to ensure central alignment of the cups while stacked. In some embodiments this alignment may be achieved through inserts within the interior of the dispenser tube 1700. The inserts comprise ridges or flanges positioned on the walls of a dispenser tube to mitigate displacement of a cup stack. In some embodiments these mounting or aligning ridges or flanges are 3D printed. In other embodiments they may be constructed of a suitable material such as PVC, acrylic sheet, ABS thermoplastic, aluminium, stainless steel, or other suitable metals.

The dispenser tubes 1700 may be designed of a length to allow a specific number of cups to be stored. In some embodiments, multiple dispenser systems are installed, allowing for greater numbers of cups to meet expected volumes of orders. In an embodiment, each tube holds 50 containers, and is installed with three dispenser tubes 1700 providing 150 containers per dispenser system 201.

In some embodiments, the cup and lid dispensers 1700 are configured to allow preparation of up to 600 coffee beverages without resupply of coffee preparation supplies.

The dispenser tubes 1700 may be constructed to allow for containers of differing sizes and diameters, and dispense cups or lids of paper, plastic, or other suitable construction.

In some embodiments, the dispenser tubes 1700 are constructed of rolled and spot-welded sheet metal tubes. The metal used may be aluminium, stainless steel, or other suitable metals. In these embodiments the fixing plates 1711 and mounting plate 1713 may be constructed from aluminium, stainless steel, or other suitable metals. In one embodiment, the fixing plates 1711 may be 5 mm thick aluminium plates, for example.

In some embodiments, the dispenser tubes 1700 and fixing plates 1711 may be constructed out of plastic such as PVC, acrylic sheet, ABS thermoplastic, or other suitable plastics.

The flexible membrane 1712 may be formed from rubber, with preformed holes to allow clearance around fastener holes. Washers may be added as spacers to prevent over-compression or distortion of the membrane 1712.

Some embodiments of spring ratings are provided in the below table:

| | Cup Spring | Lid Spring |
|---|---|---|
| Spring Rate (N/mm) | 0.0245 | 0.0465 |
| Free Length (mm) | 648.2 | 382.5 |
| Max Solid Length (mm) | 80 | 30 |

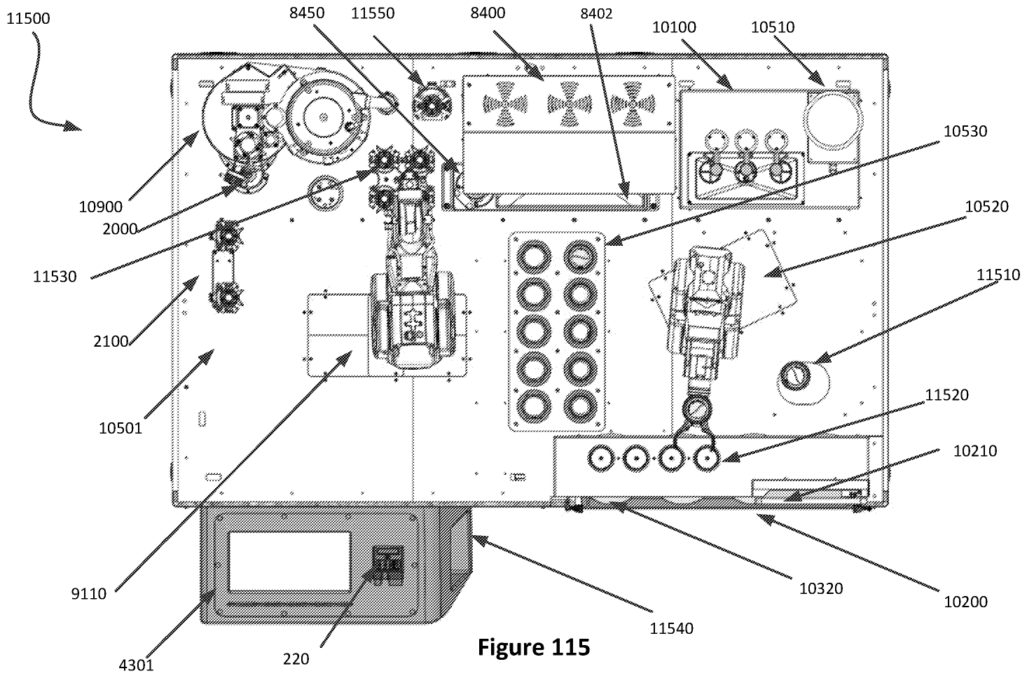

In some embodiments, a cup waste disposal 11510 (FIG. 115) is provided in the cabinet separator 310, to dispose of waste cups during a brewing operation.

Dose Control Station:

The dose control station 208 consist of a dose shaving unit 2000, having a rotating dose control blade 2010 in connection with at least one vacuum unit and tubing 2020, a weighing station 2100 with a weighing station mount 2120.

The dose shaving unit 2000 consists of a dose control blade 2010 rotating blade that accurately removes tamped ground coffee from a group handle basket 610 prior to brewing, as well as a vacuum unit and associated tubing 2020 to direct the grounds to the grind separation unit 3100 below the cabinet separator 310.

In some embodiments, the dose control blade 2010 may be a machined AISI 316 stainless steel component, coupled to a combined brushed DC motor and gearbox below the cabinet separator with machined spacing components.

The body of the dose shaving unit 2000 may be a custom designed CNC housing with internal protrusions or contouring to direct the coffee grounds into the vacuum tubing 2020, and mount directly to the table surface. The inline vacuum unit may be an Exair™ LineVac, for example. The inline vacuum unit pulls grinds from 4 inlet tubes below the dose blade through to the top of the grind separation unit 3100.

The dose shaving unit 2000 may have a dose shaving unit head 2030. In some embodiments the dose shaving unit head 2030 has a compatible diameter with that of the group handle basket 610 to provide a matched fit during dose control operations. In these embodiments the dose control blade 2010 is situated above the dose shaving unit head 2030 to protrude a distance upwards into a group handle basket to shave the dose to a required size. The dose shaving unit head 2030 may comprise a cylindrical machined tube section, providing a shielding function preventing shaved coffee grounds from contaminating other operations.

Weighing Station:

The puck weighing station 2100 may include a weighing station load cell 2110. In some embodiments, the weighing station load cell 2110 comprises a Model 1042 Tedea-Huntleigh™ 3 kg load cell for example. Suitable modifications may include a manufactured weighing station mount 2120 attached to the sensing end of the weighing station load cell 2110. The weighing station mount 2120 may include a weighing station mount channel 2130 adapted to interface with the group handle shank 620 with a tight tolerance, allowing for accurate pickup and placement of tools by a robotic brewing arm 232. In some embodiments the weighing station mount channel 2130 may comprise a hexagonal interface.

Weighing station 2100 may be mounted to the cabinet separator with an access hole below the unit for the weighing station load cell sensor wiring. The weighing station load cell may be enclosed in a custom housing that may comprise a sheet metal housing, and may include 3D printed upper and lower end stops to ensure the weighing station load cell 2110 isn't over/under loaded.

Cleaning Station:

The cleaning station 207 may comprise a puck removal station 2200 with a puck removal air supply nozzle 2220, puck removal water supply nozzle 2210, and a puck removal body 2230.

The puck removal system may be a custom designed unit with the purpose of removing coffee grounds and cleaning the group handle baskets 610 after the brewing process.

The body of the puck removal assembly may comprise a solid CNC fabricated aluminium housing, mounted to the cabinet separator 310 and have a sealing ring and O-ring 2240 fixed on the top surface of the assembly. This allows for a sealed fit between the puck removal unit head 2250 and the group handle basket 610 during the cleaning process. In some embodiments the puck removal body 2230 comprises a plurality of curved tubular sections, allowing the cleaning station 207 to be positioned in and around other cabinet systems. Configuring the puck removal body 2230 in a bent configuration may also prevent waste splashback into the puck removal unit head 2250 from lower cabinet waste systems during a cleaning operation.

In some embodiments, the puck removal unit head 2250 houses a puck removal air supply nozzle 2220, providing a regulated stream of air supplied from the compressor unit 2900, and a puck removal water supply nozzle 2210 to provide hot water routed in from below the cabinet separator 310 from the output of the group machine boiler. In some embodiments the puck removal unit head 2250 comprises a cylindrical head portion extending out from puck removal body 2230, and being of larger diameter than the puck removal body 2230.

Solid and liquid waste from the group handle basket 610 are washed down through the unit and the cabinet separator, and routed to the top of the grind separation unit 3100 via tubing. In some embodiments this tubing is 50 mm reinforced flexible tube. Water spray from the puck removal water supply nozzle 2210 is actuated electronically via valve mounted in the group machine 400. In some embodiments, the water supply nozzle 2210 may be a Tecpro™ BSB series full-cone narrow-spray stainless steel nozzle for example. Water supplied through the air supply nozzle 2220 serves to dislodge and wash out compacted coffee grounds from a group handle basket 610.

Air is supplied to the puck removal air supply nozzle 2220 from the compressor unit 2900 and is regulated and actuated by an appropriate valve. In some embodiments this valve may be a 3V210-08 Airtech™ solenoid valve for example. The puck removal air supply nozzle 2220 may be an EXAIR™ Atto Super Air Nozzle 1108SS for example. Air supplied through the air supply nozzle 2220 serves to dislodge compacted coffee grounds and dry group handle baskets 610 during cleaning operations.

Robotic Staging Arm:

The robotic staging arm 231 may be configured to grip cups to pull them from the cup dispensers 201, deliver them to the robotic brewing arm 232 via the staging rack 410 on top of the group machine 400, place them in a lidding bay, place them under the milk taps 1510, and deliver them to the collection shelf 4100. The robotic staging arm 231 may also be responsible for picking lids from the lid dispensers 2301, and installing them on the cups in the lidding bay. In some embodiments, the robotic staging arm may be an Epson Model C4-A601S™ for example, with 6 independent axes and a maximum payload of 4 kg. Coupled to the end of the unit are the staging arm cup gripper 2410 and lid suction end effector 2510, each acting as an actuatable engagement component, as described in detail below.

The robotic arm 231 may be mounted to the cabinet separator 310, directly above one of the cross-members of the lower cabinet frame 2800 for added stiffness/support. Inputs to the robotic arm 231, including power/control/sensor wiring and pneumatic lines (for actuating end effectors) are routed from below the table and up to the side of the robotic staging arm base 2420. Inputs may be enclosed in a 3D printed casing.

Pneumatic lines and end effector control wiring may also be internally routed from below the table up to the robotic arm 231 input at the staging arm base 2420.

In some embodiments, internal routing control outputs are externally routed to the robotic staging arm end effector assembly 2500 with 4 mm tubing, leaving enough tubing slack to allow for a full range of movement. These control outputs may be connected to a solenoid valve and vacuum generator, which are mounted to the base of the end effectors.

The robotic staging arm 231 may have at least one pneumatically actuated end effector mounted off of the staging arm end effector coupling unit 2520. In some embodiments, an end effector comprises a gripper end effector 2410 (pictured in open and closed positions in FIG. 25). Gripper end effector 2410 may be an SMC™ MHT2-32DZ 2-finger toggle pneumatic gripper, for example. The staging arm cup gripper 2410 may be mounted directly to the staging arm end effector coupling unit 2520, and may include custom designed, 3D printed cup grippers.

The staging arm cup grippers 2410 may be designed to accommodate minor cup misalignment by having a grip angle above 180 degrees. At least one sensor may be mounted at the back of the staging arm cup grippers to provide feedback as to whether or not a cup has been successfully picked up. In some embodiments, the at least one sensor may be a photo proximity sensor.

The lid suction end effector 2510 may be a custom unit comprising a vacuum generator—mounted on the bottom of the staging arm end effector coupling unit—that pulls air through a suction cup. The suction cup may be mounted inside an aluminium housing that fits concentrically over a lid and interfaces with the lid outer rim. The vacuum generator may pull air through the suction cup, gripping the top of the lid until it can be placed on the cup in the staging rack 410. The unit may also have at least one inline vacuum sensor providing feedback as to whether or not a lid has been successfully picked from the dispenser.

The pneumatic actuation of the robotic staging arm 231 may be controlled by a solenoid valve, for example.

Robotic Brewing Arm:

The robotic brewing arm 232 manipulates the group handles 600 to perform all stages of the brewing and cleaning processes (grinding, tamping, weighing, dose control, group engagement for brewing, and puck cleaning). The robotic brewing arm 232 may also manipulate cups, moving them from the staging rack 410 to the drip tray 500 for brewing and back. The robotic brewing arm 232 may be an Epson Model C8-A701SB™ for example, with 6 independent axes and a maximum payload of 8 kg. A robotic brewing arm cup gripper 2610 and jaw gripper 630 may be coupled to the end of the robotic brewing arm 232.

The unit may be mounted directly to the cabinet separator 310. In some embodiments this mounting comprises a 10 mm steel plate underneath the cabinet separator 310 sandwiching the cabinet separator 310 with the robotic brewing arm base 2620 for the purpose of increasing stiffness and minimizing deflection. Inputs to the machine, including power/control/sensor wiring and pneumatic lines (for actuating end effectors) may be routed from below the table and directly up through the robotic brewing arm base 2620. In some embodiments, the robotic brewing arm input lines are constructed or modified to either the side or bottom of the robotic brewing arm 232.

Pneumatic lines and end effector control wiring may be internally routed from below the table up to the machine output. In some embodiments, the pneumatic lines are externally routed up to the end effectors and comprise 6 mm tubing with enough slack to allow for a full range of movement. The pneumatic lines may also connect to solenoid valves mounted to the robotic brewing arm end effector coupling unit 2600.

In some embodiments, the robotic brewing arm 232 includes two pneumatically actuated end effectors mounted at 90 degrees to each other on a triangular aluminium robotic brewing arm end effector coupling unit 2600. The jaw gripper 630 opens and closes to grip and release a group handle shank 620. In some embodiments the jaw gripper 630 may be a 3 finger parallel style air gripper SMC MHSL3 with custom manufactured jaws to fit the geometry of the group handle 600.

The robotic brewing arm cup gripper 2610 (pictured in FIG. 27 with both open and closed gripper positions visible) may be an SMCT™ MHT2-32DZ 2-finger toggle pneumatic gripper for example. The unit may be mounted to the robotic brewing arm end effector coupling unit 2600, and be equipped with custom designed, 3D printed cup grippers. The pneumatic actuation may be controlled by a solenoid valve mounted at the robotic brewing arm base 2620. The gripper 2610 may be designed to accommodate cup misalignment by having a grip angle above 180 degrees.

Lower Cabinet Frame:

The lower cabinet 340 forms part of the system housing 350 in connection with the upper cabinet 330. The lower cabinet 340 comprises a lower cabinet frame 2800 that may be comprised of a steel box welded frame, for example, serving as support for all componentry. The lower cabinet frame 2800 may be made primarily from 50×50 box section of various 5 and 3 mm sections. Fork lift pockets may also be provided to facilitate movement and installation between warehouse and onsite locations. These may be constructed of larger sections to allow standard size and width fork lift tines to enter.

Both robotic arm systems 230 are affixed to this frame through the use of the cabinet separator 310, therefore ensuring no damage or movement of the machine occurs during rapid robotic movements as well as user interactions through vandalism or other accidental damage. Corrosion resistance may be added through black powder coating, acting as an aesthetic aid as minor sections of frame may be visible through outer covers, such as between cladding gaps and door clearances.

The left side of the lower cabinet frame 2800 may house the milk refrigeration unit, grind separation unit 3100, and bean vat 3120. In some embodiments a first cross member 2810 is installed in the lower cabinet frame 2800 to support the robotic brewing arm 232 as well as a lower cabinet vertical mounting plate 2811 where pneumatic valves may be mounted. This provides a stabilising function to the operations of the robotic brewing arm 232, and may reduce overall cabinet vibrations during the brewing process.

In some embodiments the centre of the lower cabinet frame 2800 houses an air compressor 2900 and pneumatic system in the rear. The water supply vat 3610 may also be housed in a water supply enclosure 2821, with two parallel upper waste vats 3400 above. In this section, a vacant area is be provided for group machine 400 inputs and outputs, as well as cup and lid dispensers 201 protruding through the top plate. The lower cabinet frame 2800 also features a water system control valve mounting bracket 2822, allowing the unit to be switched from in-use mode to fill mode. In this embodiment a second cross member 2820 is also installed at the top of the frame to provide support for the group machine 400 from below the table surface.

The right hand side of the unit may house a hydraulic pump, espresso pump, and uninterruptible power supply (UPS) box on the floor plate. These may surround the server rack 2840, which may house at least one robotic control system and a primary electrical box. The rear right of the unit may feature electrical power boxes and a lower waste vat 3300. A perpendicular support member 2830 may be provided below the table surface support a robotic staging arm.

Design considerations of the lower frame may be based around simplicity of manufacture and componentry for both cost reduction and lead times, whilst attempting to maintain user safety and visual appeal.

Server Rack:

All major electronic units such as the two manipulator controllers and the electronics enclosure may be housed within the server rack 2840. This may be of custom design, with a steel powder coated housing around the two robotic controllers to aid in splash protection. The electronics enclosure does not fall into this protection due to the complex geometry required in proximity to a cup dispenser.

Due to the standard rack unit dimensions of the manipulator driver unit, the rack itself may conform to standard bolt spacing on the front face.

Cladding:

In some embodiments, the lower cabinet frame 2800 may be clad in aluminium panels of 3 mm 5052-0 aluminium that are laser cut to required shapes and sizes. In some embodiments these may be painted, powder coated, etched, or chemically treated to provide a pleasing aesthetic or additional protection.

Ventilation holes may be spaced around the cladding to allow airflow to enter and exit the lower cabinet frame 2800 around key thermal generating equipment, such as the compressor 2900 and electronic control units.

These may be simple square panels with support material included to ensure no harmful interaction is possible between the machine internal components and general public. Door positions are based around the service access panels for daily and extended maintenance periods. In some embodiments over centre trigger latches may be used to secure these, utilising simple quarter turn locking mechanisms internally to ensure machine security.

Cladding may be affixed with screws, in some embodiments these may be self-tapping M5 Phillips™ drive pan head screws for example.

Mounting:

External doors may be affixed using suitable hinges allowing full access for service requirements. In some embodiments these may be Pinet™ 90° concealed hinges to minimise door gaps. Hinges may be selected based on maximum mass allowances as well as adjustment capacity.

Internal components may be affixed with a variety of fasteners. Wiring and tubing may utilise a combination of stick on zip tie mounts as well as rubber insulated permanent p-clips for routing purposes. P-clips may vary from 6 mm internal diameter to 35 mm internal diameter, allowing for many different branch locations to be adequately mounted to the frame members. All other internal systems may be screwed in place using self-tapping screws similar to that of the clad.

Cabinet Separator:

The cabinet separator 310 may consist of a single sheet of 5 mm AS 304 laser cut stainless steel with laser cut apertures 320. By maintaining a single piece construction, accuracy between components is improved greatly while increasing stiffness of the main surface. Due to the inherently corrosive nature of coffee and water, stainless steel is the best option for longevity of finish and resistance to scratching or marking during service conditions.

All surface components may utilise the cabinet separator 310 as their main bolting and alignment surface, with certain key systems such as the robotic brewing arm 232 may employ additional plates to improve rigidity. The surface itself may be grounded to maintain electrical safety, providing a secondary electrical earth for all other components above the cabinet separator 310.

In some embodiments, laser cut design functions both as a primary alignment mechanism, achieving high tolerances for a low cost, as well as reducing lead times when compared to machining techniques such as milling. By performing a single planar manufacturing technique, post machining was required on bolt positions specified as countersunk. In some embodiments this may be performed manually.

Air Compressor:

The pneumatic power source 211 for the coffee preparation system 110 may comprise an air compressor 2900. In some embodiments this may comprise a Chicago HUSH100™ air compressor, for example, with a 100 L capacity and operating pressure of 8 bar (116 psi). In some embodiments, air may be routed through a series of three pneumatic filters to remove particulate matter down to 0.01 microns and oil content down to 0.01 mg/m³. The pneumatic filters may be Airfilter Engineering™ G30 series for example. The pneumatics system may provide pressurized air to the dose control system 208, grinding station 203, bean delivery system, cleaning 207 as well as all robotic end effectors 2401, 2601.

In some embodiments, removal of external fittings such as wheels, handles, or mounting frames may be required when using an existing stock air compressor to fit the compressor within the lower cabinet frame 2800.

Each of these pneumatic systems may be controlled by individual solenoid valves and be individually pressure regulated.

Suitable specifications of some air compressors may be indicated by the below table:

| Requirement | Value |
|---|---|
| Receiver Volume (L) | 100 |
| Power (kW) | 0.78 × 3 |
| Operating Noise (dB) | 70 |
| CFM | 16 |
| Weight (kg) | 76 |
| Dimensions (L × W × H cm) | 108 × 37 × 82 |

In some embodiments, air delivery may be achieved with push connect fittings ranging from 12 mm outer diameter (OD) at outlet of tank to 6 mm OD to each individual system, with the exception of the robotic staging arm 231 utilising 4 mm OD tube to suit internal OEM tube specifications. Appropriate tube dimensions were selected based on flow rate requirements including a basic safety factor to ensure adequate airflow whilst maintaining serviceable minimum bend radii for tube routing purposes.

Valves:

In some embodiments, valves for the non-robotic system components are solenoid valves. In such embodiments, the solenoid valves may be SMC™ VX210HA two-way solenoid valves for example. The simple control mechanism of binary on-off conditions and integrated 6 mm push connectors allow simplified mounting and integration with other system components.

An embodiment of system valve specifications are found in the below table:

| Requirement | Value |
|---|---|
| Port size (in) | 1/8 |
| Push connect | 6 |
| diameter (mm) | |
| Cv | 0.23 |
| b | 0.63 |
| C | 0.63 |
| Max operating | 1.0 |
| pressure (MPa) | |
| Weight (g) | 220 |

Valves required for robotic arm systems 230 may be selected based on compatibility with existing components. Port fittings may be selected to suit the respective internal line diameters of each robotic arm system 231, 232.

An embodiment of robotic arm system valve specifications are found in the below table:

| Model | SY3120T-5LZ-C4-F1 | SY3120T-5LZ-C6-F1 |
|---|---|---|
| Push connect | 4 | 6 |
| diameter (mm) | | |
| Function | 2 position single | 2 position single |
| Max operating | 0.7 | 0.7 |
| pressure (MPa) | | |

Air lines and fittings: Pneumatic systems may use 6 mm OD and 16 mm OD polyurethane push connect tubing, with a low bend radius of 20 mm enabling complex routing paths and tight packaging within the lower frame.

Regulators may be used in both the staging arm cup gripper 2410 and brewing arm cup gripper 2610 in order to control the overall grip pressure, reducing component damage as well as the incidence of cup loss.

Power Distribution:

Power distribution boxes are located at the back right of the lower cabinet frame 2800, and may be accessible via a right hand cladding door. Primary 3 phase power may be provided by two 20 A 220-240 V machine inputs and distributed and routed to all required components. DC power may be converted from the AC source by means of 5V, 12V, and 24V AC-DC rectifiers located in the electronics box.

Grind Separation Unit:

The waste management unit 213 may comprise a grind separation unit 3100 that has the purpose of separating the solid and liquid components of puck removal waste and dose control processes from the cleaning station 207. Waste may be routed through the top of the unit which filters through a calico bag. Solid waste may be retained in the bag for disposal and bags are replaced at regular service intervals, with liquid waste filtered through into the collection tray at the bottom of the waste management unit 213.

Liquid waste may be pumped to the upper waste vats 3400 via a single 12 volt auto priming low pressure pump, triggered by a float switch as liquid accumulates in the collection tray. The pump may be located in the cavity at the bottom behind the bean vat. The inclusion of the pump allows for versatile wastewater placement, removing the dependence on gravity fed inlet pipes.

The unit may be a custom component, made of 1.5 mm bent and welded stainless steel. It may attach to the lower cabinet frame 2800 via linear drawer slides to allow for waste bag removal. The bags may attach to the unit by a drawstring at the top and may be machine washable for reusability.

In some embodiments, a pneumatically actuated grind separation unit swing door assembly 3200 may be installed between the grind separation unit 3100 and the cabinet separator. This unit acts as a sealing aperture and prevents steam and coffee grounds from rising from the grind separation unit 3100 into the upper cabinet 330 during cleaning and dose control operations. In some embodiments a pneumatic cylinder may be coupled to a 2 way solenoid valve to actuate a 3D printed door. The pneumatic cylinder may comprise a Festo™ ADN25 compact pneumatic cylinder for example.

Bean Vat:

The ingredient supply unit 212 may comprise coffee bean storage, such as a bean vat 3120. The bean vat 3120 may comprise a welded steel enclosure mounted to the lower cabinet frame 2800 via drawer hinge. It may be accessible via a left cladding door on the front of the machine, and provide storage for the unground coffee beans.

In some embodiments, the bean vat 3120 may have a volume of 40 L, providing a safety factor of 1.2 above the estimated bean volume required for 600 cups of coffee. The bottom of the bean storage unit may taper towards a bean vat outlet 3121, where 50 mm reinforced flexible tubes couple the bean vat 3120 to a vacuum system, and up through the table surface to a grinder bean hopper inlet through a feeder tube 930. The vacuum system may comprise an Exair™ Line Vac, for example.

Refrigeration System:

The ingredient supply unit 212 may also comprise a refrigeration system. In some embodiments, the refrigeration system provides a total volume of 210 L allowing for 80 L of milk storage, providing close to 150% excess volume to account for adequate airflow, milk output line routing, and the packing efficiency of the milk boxes. In some embodiments, the refrigeration system may comprise a Polar™ DL816 refrigeration unit for example, the overall dimensions of which are suitable to allow the unit to fit under the cabinet separator 310 and within the constraints of the lower cabinet frame 2800.

In some embodiments, internal shelving may be removed from the unit to allow a greater volume of milk to be refrigerated. Modifications may include drilling holes the back left hand corner of the top face of the refrigeration unit for the routing of the milk output lines, with grommets to seal the holes around the milk line tubing. A temperature sensor (with its signal output routed to controller 240) may be added to the machine for feedback purposes.

In some embodiments, the refrigeration system may be capable of storing 8 milk boxes, each with a volume of 10 L. These may be coupled by food safe push-connect fittings and Teflon food safe tubing, which routes through the top of the fridge and across the inside of the lower frame to the milk foaming station. Tubing may be wrapped in insulation tape to reduce the influence of the high temperatures inside the lower frame on the milk sitting in the milk lines.

Lower Waste Vat:

A lower waste vat 3300 may be located below the milk foaming station 204 and the robotic staging arm 231 in the lower frame cabinet 2800, between an electrical power box and a server rack 2840.

In some embodiments, the lower waste vat may comprise a welded steel container with dimensions of 22 cm×40 cm×30 cm (height) and a volume of approximately 27 L. Waste is routed from the drip tray 500 to the top of the lower waste vat by 1″ reinforced tubing, which feeds into the waste lines from the milk drip trays 1520 directly above the lower waste vat 3300.

The unit may be constructed with a removable top panel for cleaning purposes, designed to be replaced with another identical unit such that the full lower waste vat 3300 can be taken offsite for draining and cleaning. This may be achieved by turning off an input valve and removing an input line from a barbed fitting on the vat.

Upper Waste Vat:

An upper waste vat 3400 may comprise a combination of two welded steel vats located in the lower frame cabinet 2800 above a water vat 3610, accessible via a middle cladding door on the front of the unit.

In some embodiments, the vats may have a volume of 38 L (Total=76 L) and sit on roller ball bearings allowing removal from the coffee preparation system 110 once drained. The waste input to the upper waste vats 3400 is provided via a pump from the drip tray 500 in the base of the grind separation unit 3100.

Waste fed from the cleaning station 207, dose control station 208, and grinding station 203 may be filtered in the grind separation unit 3100 with the solid waste remaining in the grind separation unit 3100 and the liquid waste being pumped to the upper waste vats 3400. The outlet of the upper waste vats may be accessible by a valve underneath the upper waste vats 3400, which may be opened to drain waste for disposal. Outlet barbs may be required to be removed from the machine for cleaning.

Hydraulic System:

A hydraulic circuit 3600 may be provided to pump water from the supply source to the on-board water vat 3610 during a maintenance procedure, and to pump water from the water vat 3610 to the group machine 400 water input for use in coffee brewing and cleaning procedures. The water vat 3610 may comprise a jerry can or other vat of filtered water, supplied by maintenance personnel.

In some embodiments, the system comprises a Lowara™ BGR050 as a primary (low pressure) pump 3620, and a La Marzocco™ RPM C008410 as a high pressure pump 3630 for example. In this configuration, the low pressure pump 3620 is used to fill the water vat 3610. The low pressure pump 3620 may be self-priming, use bacteria resistant stainless steel components, and be approved for drinking water. During the USE operation mode, the low pressure pump 3620 feeds the high pressure pump 3630 which delivers water to the group machine 400 at the required pressure. The hydraulic circuit may be controlled via at least one manual shut off valve, accessible via the front centre cladding door.

This circuit configuration allows the system to be switched manually from USE to FILL mode by maintenance personnel for system restocking. The refill procedure may require that a supply of fresh water be connected to the fill port (via CPC Colder quick-connect acetyl valve fittings), and both valves be turned from USE to FILL mode. Once complete, but before the pump starts drawing air through the system, valves are turned back to USE mode and a quick connect hose is removed.

In some embodiments, the water vat 3610 may be a custom designed, food safe, welded plastic water vat. The vat may be arranged to hold over 140 L of water and connect directly to the hydraulic circuit via a fill/drain port at the rear of the tank. The top of the tank having a vacuum relief opening and a larger port that can be opened for access during cleaning.

Upper cabinetry: The automated coffee preparation system 110 is contained within a system housing 350. The system housing 350 comprises an upper cabinet 330 and a lower cabinet 340. The upper cabinet 330 comprises an upper cabinet frame 3900. The upper frame 3900 may comprise a square, T-channel aluminium frame with 4 mm polycarbonate panels around the sides and top of the machine, for example. Two primary front panels as well as two back panels may be provided on tracks and may be opened and closed to allow access to the machine. L-brackets attach to the lower members of the upper cabinet frame 3900 via T-slot fasteners and attach to the top plate with M8 fasteners. A spacer strip may be situated between the top frame and the cabinet separator.

The upper cabinet frame 3900 may include a delivery station 209. The delivery station 209 comprises a collection shelf 4100 and collection area housing 4120. The collection area housing 4120 can be mounted to the front of the frame 3900 via the T-slot channels in the aluminium frame segments. A completed coffee order is passed through this section by the robotic staging arm 231 and delivered to the customer.

An order display assembly 360 may be mounted above the collection area housing 4120, into to a T-slot channel in the vertical member of the upper cabinet frame 3900 with an aluminium T-slot channel swiveling arm. This order display assembly 360 may be housed in an aluminium casing and mounted with a Studio Proper™ Mounting Disk for example, which allows display of the order name and order progress to the customer, as well as promotional and instructional media.

The collection area housing 4120 features at least one collection area sliding door 4110. In some embodiments, four collection area sliding doors 4110 have mounted sensors 4000 that act as safety shutoffs if any of the doors are not in the closed position. In some embodiments, the door safety sensors 4000 comprise SICK™ RE1 non-contact magnetic safety sensors, for example. The collection area sliding doors 4110 may also be equipped with quarter-turn key locks to ensure closure during operation.

Collection Area:

The delivery station 209 acts a delivery portal and provides a means to deliver the coffee to the customer, while impeding access to the interior workings of the upper cabinet 330. The collection area housing 4120 may be composed of CNC milled plates to allow for precise locating features and accurate alignment of the plates. The unit may mount to the upper frame via t-channel fasteners.

At least one collection area sliding door 4110 may be situated on the collection area housing 4120. In some embodiments the sliding doors on the machine side and on the consumer side are vertically actuated by a stepper motor and screws concealed within the unit. In some embodiments the stepper motor may be a NEMA™ 23 stepper motor, and the screws may be and 12 mm×500 mm NSK™ lead screws (with NSK™ WBK pillow blocks) for example.

In some embodiments, the robotic staging arm 231 is able to deliver the coffee and the customer is able to retrieve it without ever having access to the interior of the machine, by limiting access through alternating the opening of the collection area sliding doors 4110. The doors may be equipped with limit switches that engage at the end of the door's travel to ensure the motor does not drive the door into the end stops. In some embodiments, a spring mechanism may travel on the ball screw that compresses when an object physically impedes the door, lowering impact force if a customer were to get their fingers caught between the moving door and the collection area housing 4120.

In some embodiments, the collection area has two collection shelves 4100, each of which may have two coffee delivery locations, allowing for a total of 4 coffees delivered per order. Two webcams or other forms of camera may be installed within each shelf of the collection area with image processing software to allow identification of cups in the collection area. This mitigates the issue of uncertainty as to whether cups have been removed from the airlock by the customer and allows the robotic staging arm 231 to dispose of uncollected orders.

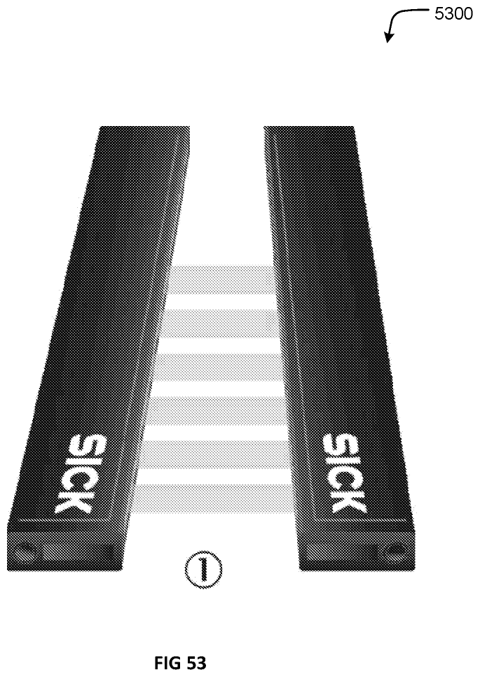

In some embodiments, collection area light curtains 5300 (FIG. 53) are installed at the front of the unit, which have horizontal light beams that may be sent across the front of the collection area housing 4120 to a receiver on the opposite side. The receiver detects when the light is broken and provides feedback to so that door movement can be stopped when a physical object crosses the plane of the collection area sliding door 4110. This operation decreases the chance that a customer will interact with the collection area sliding door 4110, which could potentially lead to injury. In some embodiments, the collection area light curtain 5300 comprises a SICK™ SPL light curtain for example, having light beams spaced 40 mm apart.

The interior components of the delivery station 209 may be concealed in the collection area housing 4120, comprised of folded aluminium for aesthetic purposes and to impede access to all moving components. The collection area housing 4120 may be a painted and finished 3D printed enclosure, which has access holes for the previously mentioned light curtain 5300. The interior of the delivery station 209 may have LED strip lighting fixed to the interior surfaces to highlight the product delivered to the consumer.

Ordering Interface Assembly:

An ordering interface assembly 4300 may comprise an ordering interface terminal 4301 comprising an interactive device (e.g. a tablet computer with a touch screen), a payment terminal 220. The payment terminal 220 may be comprised in the ordering interface assembly 4300 constructed of an aluminium sheet metal housing mounted to the left cladding door on the front of the coffee preparation system 110, with the ordering interface terminal 4301 mounted within a mounting recess defined in the housing of ordering interface assembly 4300.

The ordering interface assembly 4300 may comprise a hinged access door with access door cut-outs defining a recess to allow customers access to the touch surface of the ordering interface terminal 4301.

When open, the ordering interface assembly 4300 may conceal the body of the interface device, power cable, and POS communication and power wiring. The unit may feature two steel angle iron braces along the inner surface of the door cladding to provide support. The locking mechanisms may comprise Southco™ E3-13-30 compression latches for example.

The device providing the ordering interface terminal 4301 may be a tablet device such as an iPad, that may be secured with a Studio Proper™ iPad P/O/S Mount Disk for example.

In some embodiments, the order display assembly 360 comprises a display screen mounted on the top right hand side of the coffee preparation apparatus 250, and comprises a digital display affixed to the upper cabinet 330 or upper cabinet frame 3900.

The display screen may be configured to display a notification indicating an order is ready for collection at the delivery station 209. In some embodiments, the order display assembly 360 displays promotional and instructional media via the display screen.

Staging Arm Process:

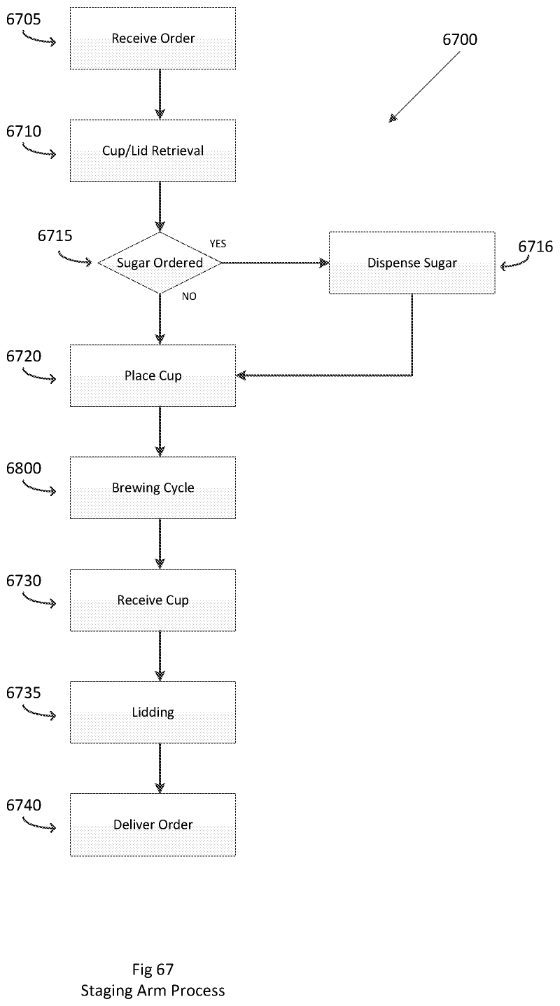

FIG. 67 depicts a flow chart of some embodiments for a robotic staging arm order fulfillment process 6700. In such embodiments, a customer coffee order is received via ordering interface terminal 4301 or via ordering web application server 130 at the coffee preparation system 110 at 6705. This order at 6705 may comprise at least one coffee with or without additives such as sugar or milk.

At 6710, upon receiving an order at 6705 a robotic staging arm 231 may collect a number of cups and lids corresponding to the number of separate coffee beverages specified by the received coffee order from a cup/lid dispenser 201 and place them pending handoff at a staging rack 410 using a robotic staging arm cup gripper 2410.

At 6715, if a coffee order contains a sugar dose, the robotic staging arm 231 may position the cup at the sugar dispensing station 205 to receive a corresponding sugar dose at 6716 prior to the brewing cycle 6800. In some embodiments, the sugar order stage 6715 may be triggered after the brewing cycle 6800.

At 6720, the robotic staging arm 231 may place the cup at a staging rack 410 within the beverage brewing station 202 for hand off to a robotic brewing arm 232. During 6800, if additional orders have been received, the robotic staging arm 231 may prepare cups in the same procedure described above until the maximum number of simultaneous orders has been reached, and/or the staging rack 410 is at capacity.

At 6730, the robotic staging arm 231 may collect a brewed coffee order for transfer to a lidding station for lid placement (lidding) at 6735. In some embodiments, the staging rack 410 may be used as the lidding station, obviating the need for relocation. In other embodiments, a separate lidding station may be used. Lidding may be achieved by the staging arm lid suction end effector 2510. In some embodiments, the lids are collected from the lid dispenser 201 at 6710. In some embodiments, lids may be collected and placed on cups at 6735.

After an order is lidded at 6735, the robotic staging arm 231 may transfer the order to the delivery station 209. The delivery station may have a collection area sliding door 4110 on the interior and exterior of the upper cabinet 330, configured to allow access to a robotic staging arm 231 to place a brewed coffee order upon the collection shelf 4100 during an order delivery stage 6740. At 6740, an interior collection area sliding door 4110 may then close, restricting access to the upper cabinet 330. The collection shelf 4100 may then be accessible by a customer by activation of the external collection area sliding door 4110.

In some embodiments, the order of the staging process 6700 described above may be adaptable by the coffee preparation system 110 to maximize efficiency and order output.

Brewing Arm Process:

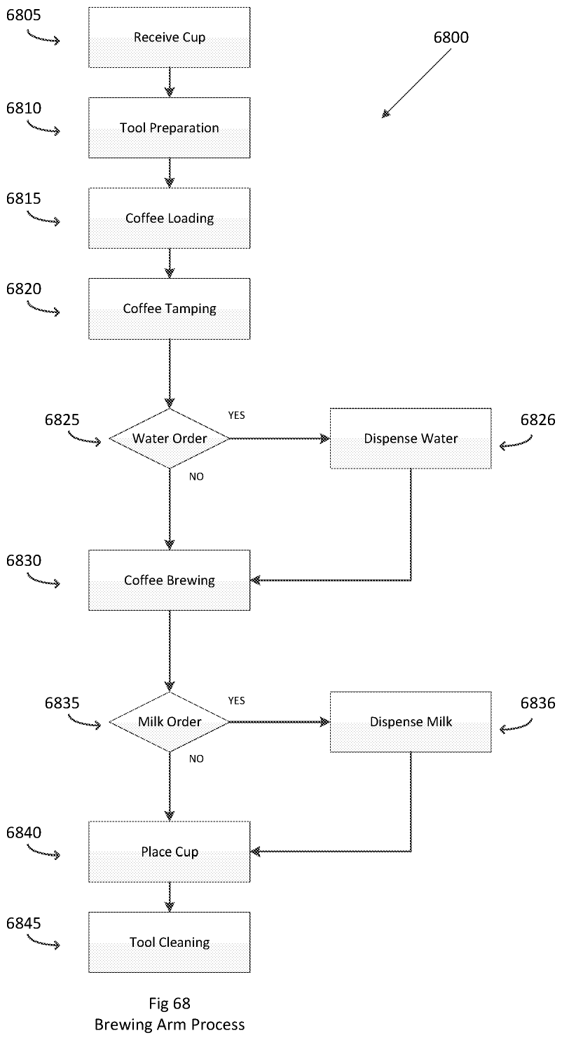

FIG. 68 depicts a flow chart describing an embodiment of the brewing process 6800. At 6805, a robotic brewing arm 232 may receive a cup from a staging rack 410 to undergo the brewing process 6800. At the tool preparation step 6810 the brewing arm jaw gripper 630 may pickup a group handle 600 from a tool holder 700 in preparation of receiving coffee at 6815. In some embodiments, the robotic brewing arm 232 may select a group handle 600 with a single or double spout depending on the coffee order.

At 6815, a group handle 600 is moved by the robotic brewing arm 232 to a grinding station 203 to receive a dose of coffee grounds corresponding to the coffee order. The dose (amount) of coffee grounds intended to be delivered from the doser is pre-configured during setup of the system 110 and can be re-configured via the controller 240. For the present disclosure, it is preferred that 22 grams of coffee grounds is set as the dose amount for dispensing into the filter basket of the group handle 600, although other dose amounts can be set. A predetermined variation from that set dose amount is permitted (without requiring dose adjustment), such as 0.1 or 0.2 grams, for example. The robotic brewing arm 232 may then transfer the group handle 600 to a group handle basket seat 1610 of a tamping station 206. The tamping station 206 may then provide a compacting action at 6820 to the grounds within the group handle basket 610. In some embodiments, the compacting action may be defined by the coffee order, allowing for a more tightly or loosely compacted puck depending on optimal coffee bean requirements.

At 6825, depending on order requirements, the robotic brewing arm 232 may place the cup under a mixer tap 420 to dispense a dose of hot or cold water into the cup at 6826. After this process, the robotic brewing arm 232 may transfer the group handle 600—(now with compacted coffee puck in the group handle basket 610) to be interfaced and locked in position at a group head 430 at a beverage brewing station 202. The robotic brewing arm 232 may transfer the cup to a cup platform 2310 on or over the drip tray 500 ready to receive an espresso dose from the brewing machine 400.

At 6830, the group machine 400 at brewing station 202 may provide an espresso dose according to the corresponding coffee order into the cup or cups stationed on the cup platforms 2310. The drip tray load cells 2320 may weigh the espresso dose to ensure order or system requirements have been met before the robotic brewing arm 232 collects the cup for additional processing after brewing.

At 6835, the robotic brewing arm 232 may transfer the cup to a milk foaming station 204 to receive a milk dose in accordance with order requirements. The quantity, style, and type of milk (full cream, skim, soy, or other) may be dependent on order requirements. At the milk foaming station 204, the robotic brewing arm 232 may place the cup on a milk drip tray 1520 under a milk tap 1510 that corresponds to the ordered milk type. After this optional process, the robotic brewing arm 232 at 6840 may transfer the cup to a hand over point to be received by a robotic staging arm 231 to complete the order. In some embodiments this hand over point may be a staging rack 410 at a beverage brewing station 202. The staging rack 410 may be on top of the brewing station 202.

After the cup has been placed at 6840 for order completion by a robotic staging arm 231, the robotic brewing arm at 6845 may initiate a tool cleaning and puck removal process for the spent puck within the group handle 600 at a cleaning station 207. After a tool cleaning process has been completed, the robotic brewing arm 232 may transfer the group handle 600 to a tool holder 700 for storage.

In some embodiments, the order of the brewing process 6800 described above may be adaptable by the coffee preparation system 110 to maximize efficiency and order output. In particular, the milk dispensing actions may be carried out by staging arm 231 as part of the process 6700, rather than by brewing arm 232 as part of process 6800.

System Volume Usage Estimations:

| Milk | | |
|---|---|---|
| Dose Per Cup | 0.12 | L |
| Waste Per Cup | 0.002 | L |
| Cups per day | 600 | Cups |
| % Full | 60 | % |
| % Skim | 30 | % |
| % Soy | 10 | % |
| Total Volume | 73.2 | L |
| Req | | |
| Safety Factor | 1.2 | |
| Volume Req | 87.84 | L |
| (Actual) | | |
| Volume Full | 52.704 | L |
| Volume Skim | 26.352 | L |
| Volume Soy | 8.784 | L |

| Beans | | |
|---|---|---|
| Dose Per | 22 | g |
| Cup | | |
| Total Mass | 13.2 | kg |
| Bean Density | 0.39 | kg/L |
| Volume | 33.85 | L |
| Required | | |
| Safety | 1.2 | |
| Factor | | |
| Volume Req | 40.62 | L |
| (Actual) | | |

Water (Espresso)

| | | |
|---|---|---|
| Yield | 60 | g |
| Puck Retention | 22 | g |
| Purge Volume | 30 | ml |
| Handle Rinse | 60 | ml |
| (/50 cups) | | |
| Total Water | 82 | ml |
| Per Cup | | |
| Handle Rinse | 720 | ml |
| Water/Day | | |
| Volume Req | 49.92 | L |
| (base) | | |
| Safety | 1.2 | |
| Factor | | |
| Volume Req | 59.9 | L |
| (actual) | | |

| Waste | | | | |
|---|---|---|---|---|
| Water | 84 | L | 50.34% | Puck |
| (Puck | | | | |
| Removal) | | | | |
| Water | 0.864 | L | 0.52% | Drip Tray |
| (Handle | | | | |
| Rinse) | | | | |
| Water | 21.6 | L | 12.94% | Drip Tray |
| (Purge) | | | | |
| Water | 15.84 | L | 9.49% | Puck |
| (Retention) | | | | |
| Water | 2.52 | L | 1.51% | |
| (Tray Clean) | | | | |
| Beans | 40.62 | L | 24.34% | Puck |
| Milk | 1.44 | L | 0.86% | Barissima |
| | | | | Drip Tray |
| Volume Req | 166.8794 | L | | |
| (Actual) | | | | |

| Waste Location | | | Total Waster |
|---|---|---|---|
| Location | Volume | | Percentage |
| Puck | 140.4554 | L | 84.17% |
| Drip Tray | 24.984 | L | 14.97% |
| Barissima | 1.44 | L | 0.86% |
| Drip Tray | | | |

| Sugar | | |
|---|---|---|
| Sugar Per | 1 | Tsp |
| Order | | |
| Volume | 5 | ml |
| Density | 900 | kg/m3 |
| Mass Per | 0.0045 | kg/m3 |
| Cup | | |
| Volume | 3 | L |
| Required | | |
| Safety | 1.2 | |
| Factor | | |
| Volume | 3.6 | L |
| Required | | |
| (Actual) | | |

Total Volumes

| | | |
|---|---|---|
| Full Milk | 87.84 | L |
| Skim Milk | 26.35 | L |
| Soy Milk | 8.78 | L |
| Beans | 40.62 | L |
| Fresh | 146.42 | L |
| Water | | |
| Sugar | 3.6 | L |
| Waste | 166.87 | L |

Pneumatic Usage Estimations:

| System Air Requirement Estimate Table | | | | |
|---|---|---|---|---|
| | | | Cycle | Cycle |
| | Rate | | On | Off |
| System | (L/min) | | Time (s) | Time (s) |
| Bean | 438.78 | EXAIR Aluminium | 5 | 180 |
| Conveyor | | Line Vac 1.25 6082 | | |
| Sugar | 132 | EXAIR Aluminium | 5 | 180 |
| Conveyor | | Line Vac 3/4 6080 | | |
| Puck | 235 | EXAIR Nano Super | 6 | 30 |
| removal | | Air Nozzle 1110SS-NPT | | |
| Milk | 300 | | 1 | 30 |
| Grinder | 71 | EXAIR Atto Super | 8 | 30 |
| | | Air Nozzle 1108SS | | |
| Bean | 438.78 | EXAIR Aluminium | 5 | 180 |
| Conveyor | | Line Vac 1.25 6082 | | |
| Sugar | 132 | EXAIR Aluminium | 5 | 180 |
| Conveyor | | Line Vac 3/4 6080 | | |
| Puck | 235 | EXAIR Nano Super | 6 | 30 |
| removal | | Air Nozzle 1110SS-NPT | | |
| Milk | 300 | | 1 | 30 |
| Grinder | 71 | EXAIR Atto Super | 8 | 30 |
| | | Air Nozzle 1108SS | | |

Compressor Duty Cycle Data (Chicago Air HSUH100)

| | | |
|---|---|---|
| Switch on Pressure | 90 | PSI |
| Switch off Pressure | 112 | PSI |
| Tank Size | 100 | L |
| Compressor Fill Rate | 10.56 | CFM** |
| Compressor Fill Rate | 4.98256 | L/s |
| Max Air Consumption Allowable | 2121.78 | L/s |
| Average Air Consumption | 1.815 | L/s |
| Compressor Duty Cycle | 36 | % |

**Note this is adjusted assuming rated 16 CFM is for 0 psi and rated at 66% at 8 bar based on average compressor loss

Brewing Station:

The Brewing Station 202 requires an electricity input, which may be 20 A. A water pump may be powered through electricity supplied to the Brewing Station 202. The water pump may be a high pressure water pump. The Brewing Station 202 interior comprises two pressure transducers and a temperature sensor. The temperature sensor provides additional monitoring and control capabilities. The group head operation and the hot water dispenser of the Brewing Station 202 may be controlled using the instructions received from a Java™ based Controller Application executed by controller 240.

Robotic Arms Controllers and Drivers:

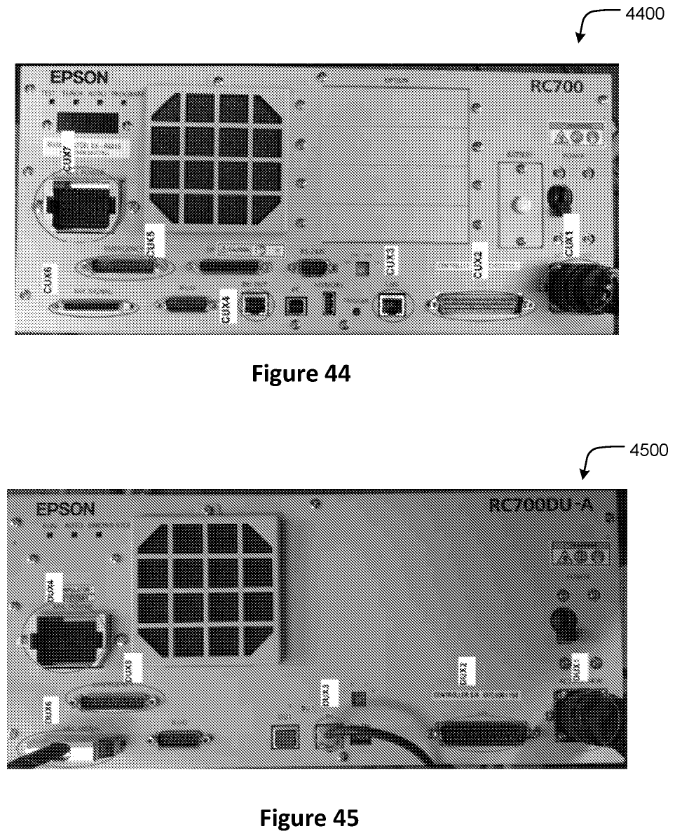

The Robotic Staging Arm 231 and the Robotic Brewing Arm 232 may be controlled by a Robot Controller Unit (Robot CU) 4400 as shown in FIG. 44 and Robot Driver Unit (Robot DU) 4500 as shown in FIG. 45. The Robot CU 4400 and Robot DU 4500 may require 15 A electricity input. The Robot CU 4400 may receive instructions from and provide output to the Coffee Preparation System Controller 240. The Robot CU 4400 may pass instructions to and receives output from the Robot DU 4500. The Robot DU 4500 may directly controls the Robotic Brewing Arm 232. The Robot CU 4400 may directly control the Robotic Staging Arm 231. In some embodiments a modified Epson™ RC700 Controller may be used as the Robot CU 4400 and a modified Epson™ RC700DU-A may be used as the Robot DU 4500.

Milk Foaming Station:

The Milk Foaming Station 204 may be comprised of three Milk Foaming Devices 1500. Each Milk Foaming Device 1500 may be a modified Barissima™ UNO milk foaming device. The modifications may comprise removal of an original housing and replacement with a custom housing for the device. The original Barissima™ UNO milk foaming device comprises a touch screen to receive instructions from a human operator. The embodiments of the comprises Milk Foaming Device 1500 comprises modifications to allow automatic electronic control of the Milk Foaming Device 1500 by the Coffee Preparation System Controller 240.

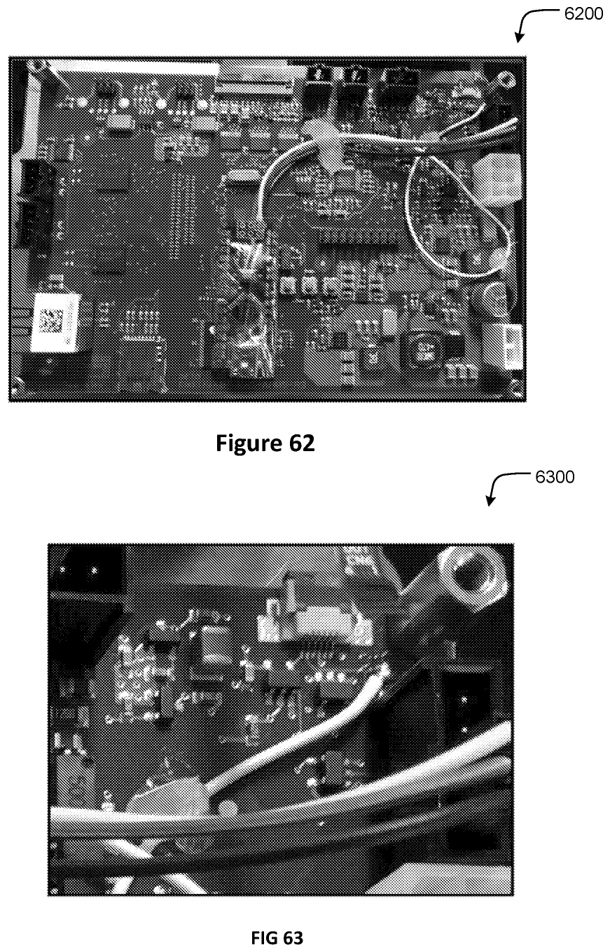

The modifications include installation of a foaming station microcontroller 6200 as shown in FIG. 62 in communication with an internal touch screen controller board to override an original touch screen unit. FIG. 63 illustrates modifications to internal touch screen controller board 6300. The foaming station microcontroller 6200 may be an Arduino™ Nano or another suitable programmable microcontroller. Further, in some embodiments, an original nozzle detection sensor may be removed or bypassed to increase the speed of production of foamed milk from the Milk Foaming Station 204 and achieve better electronic control. The original nozzle detection sensor may be bypassed using a 2 pin Molex connector and just shorting the connectors of the original nozzle detection sensor.

The foaming station microcontroller 6200 may comprise a USB port which may be routed to a USB port in the custom housing for the Milk Foaming Device 1500. The USB port may allow for firmware updates to the foaming station microcontroller 6200 and initialisation of milk frothing configurations without opening the Milk Foaming Device 1500 enclosure.

The Milk Foaming Device 1500 may also comprise a solid state relay. The solid state relay may be used to reset the Milk Foaming Device 1500 using software controls (i.e. by the control system triggering the relay). In some embodiments, a Celduc™ 25 model S0942460 may be used as the solid state relay. The control signal for the solid state relay is wired to a 2 pin panel mounted Molex connector on the bottom of the Milk Foaming Device 1500 enclosure.

The foaming station microcontroller 6200 is further configured as an I²C slave with the same address as the original touch screen unit in order to emulate it. The foaming station microcontroller 6200 may execute a touch screen emulator program that emulates the original touch screen controller behaviour. The foaming station microcontroller 6200 upon receiving a command from the Coffee Preparation System Controller 240 stores the received command in a variable. The touch screen emulator program in order to emulate a touch pulls the interrupt pin a “low” state. When the “low” state is registered by the touch screen controller board, it requests the co-ordinates associated with an emulated touch from the foaming station microcontroller 6200. The foaming station microcontroller 6200 responds with co-ordinates based on the stored variable value. The foaming station microcontroller 6200 after communicating the co-ordinates brings the interrupt pin a “high” state to indicate an end in its communication. If the Milk Foaming Device 1500 fails to dispense or does not respond to commands then it may be restarted using a power control relay.

A firmware update to the to the foaming station microcontroller 6200 may be initiated by placing one single backup file on a USB stick and plugging it into the USB port of the Milk Foaming Device 1500. The Java™ based Controller Application running on the Coffee Preparation System Controller 240 may trigger a firmware update which may take around 30 seconds and includes a restart. It is recommended to do a power cycle after a firmware update to ensure that the state of the foaming station microcontroller 6200 is known.

Pneumatic System:

Pneumatics of the Coffee Preparation System 110 may be driven by a compressor unit 2900 which supplies compressed air to the various required subsystems or stations that require compressed air. Supply to the subsystems or stations may be controlled via pneumatic solenoid valves. A Coffee Preparation System Controller Application 6901 may control the compressor unit 2900 by transmission of commands or signals though an Actuator Microcontroller 4700. In some embodiments, a Chicago™ HUSH100 Oil Free Air compressor may be used.

Hydraulic System:

Water supply of the Coffee Preparation System 110 may be driven by a water pump which supplies water to the various required subsystems or stations that require water. The water pump may be a low pressure pump which may fill the on board fresh water vat from an external supply, as well as to move water from the vat to the Brewing Station high pressure pump. In some embodiments a Chicago™ HUSH100 Oil Free Air compressor may be used. The water pump may draw 800 W of 240 VAC power while in operation.

FIG. 49 illustrates a waste separation pump control circuit 4900 according to some embodiments.

Grinding Station:

A grinding station 203 may be a coffee grinding device modified to allow electronic control of its several functions. In some embodiments, a Mazzer Robur™ coffee grinder modified for electronic control may be used as a grinding station 203. A custom electrical enclosure may house capacitors, contactor and control relay, as well as accommodate an IEC C14 power socket. A stepper motor may be added to actuate the grind size adjustment gear. Sensors may be added to regulate the required amount of coffee beans in the bean hopper, and a motor may be added to the dose barrel to allow uniform distribution of the ground coffee.

Compacting or Taming Station:

A Tamping Station 206 may be a coffee tamping device modified to allow electronic control of its several functions. In some embodiments, a Puqpress™ Automatic Coffee Tamper modified for electronic control may be used as a Tamping Station 206. Original enclosure of the Puqpress™ Automatic Coffee Tamper may be removed. The Tamping Station 206 may comprise a sensor that detects when a Group Handle 600 may be in a position to be tamped. A switch may be wired off the Tamping Station 206's control PCB to allow external access to a tamp extending feature for cleaning purposes.

Milk Refrigerator:

The Coffee Preparation System 110 comprises a Milk Refrigeration System. The Milk Refrigeration System comprises a temperature sensor to allow electronic monitoring of the temperature inside the Milk Refrigeration System by the Coffee Preparation System Controller 240. The Coffee Preparation System Controller Application 6901 may access output produced by the temperature sensor through a sensor microcontroller 5000.

Power Distribution:

The distribution of power within the several stations and subsystems of the Coffee Preparation System 110 is handled by two distribution enclosures, each comprising of a 3 phase 20 A lead and associated plug. DIN rails are used for mounting the inner hardware to the boxes. Main isolators and RCDs for each phase and primary system are included for safety shutdown purposes. The distribution boxes feature DIN rail mounted power sockets in the appropriate sizes to suit the 10 A, 15 A and 20 A devices in the system. DC power supplies are hardwired to reduce complexity.

The following table summarises the power requirements of various components in some embodiments:

| | Component | Voltage | Current | Power |
|---|---|---|---|---|
| Component | Example | (VAC) | (A) | (W) |
| Brewing | La Marzocco | 220/240 | 20 | 4600 |
| Station 202 | Linea | | | |
| Brewing High | Linea High | 220/240 | 1.5 | 300 |
| Pressure Pump | Pressure Pump | | | |
| Robotic | EPSON C4-A601S | 200/240 | 15 | 2500 |
| Staging Arm | (DRIVER RC-700) | | | |
| 231 | | | | |
| Robotic | EPSON C8-A01SB | 200/240 | 15 | 2500 |
| Brewing Art | (DRIVER RCDU-700A) | | | |
| Milk Foaming | Barissima | 240 | 13 | 2700 |
| Unit | | | | |
| Compressor | Chicago Air | 240 | 11.4 | 2340 |
| unit 2900 | Compressor | | | |
| Hydraulic | Low Pressure | 220/240 | 3.5 | 800 |
| System | Pump | | | |
| Grinding | Mazzer Grinder | 230/240 | ~4 | 900 |
| station 203 | | | | |
| Tamping | PUQ Press | 110-230 | 0.8 | 60 |
| Station 206 | | | | |
| Milk | | 220-240 | 1.8 | 280 |
| Refrigeration | | | | |
| System | | | | |

The above mentioned power requirements were estimated based on the peak power draw of each of the components. The estimation was conducted in a simulated service period when all subsystems had reached their associated steady state temperatures and pressures.

Coffee Preparation System Controller:

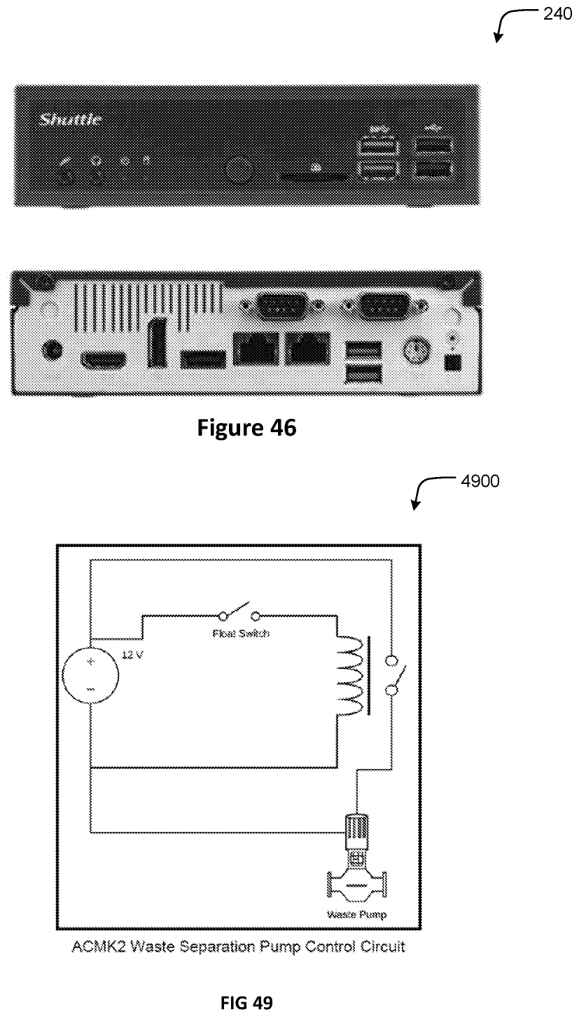

The Coffee Preparation System Controller 240 (Control System) may include a small form factor PC, which may run Java™ Applications and other services, for example. Thus, the controller 240 is or comprises a computing device that comprises at least one processor, memory, a network interface and standard input and output ports for data communication with other parts of the automated coffee preparation system 110. Some embodiments may use a Shuttle™ DH110 XPC Slim 1.3 L Barebone PC as the controller 240, for example. The controller 240 may comprise an Intel core i3 CPU (Dual Core with hyper threading) and 8 GB of DDR3L as RAM, for example. The controller 240 may comprise a 256 GB ADATA M.2 storage drive and an intel mini PCI-e (network interface) card that provides WLAN on IEEE 802.11b/g/n enabling wireless communication, for example. A USB Wi-Fi adapter may be added to the controller 240 for connectivity redundancy, for example. The controller 240 may comprise more than one Ethernet port to enable redundant communications. FIG. 46 illustrates front and back views of a small form factor PC that may serve as a Coffee Preparation System Controller 240 according to some embodiments.

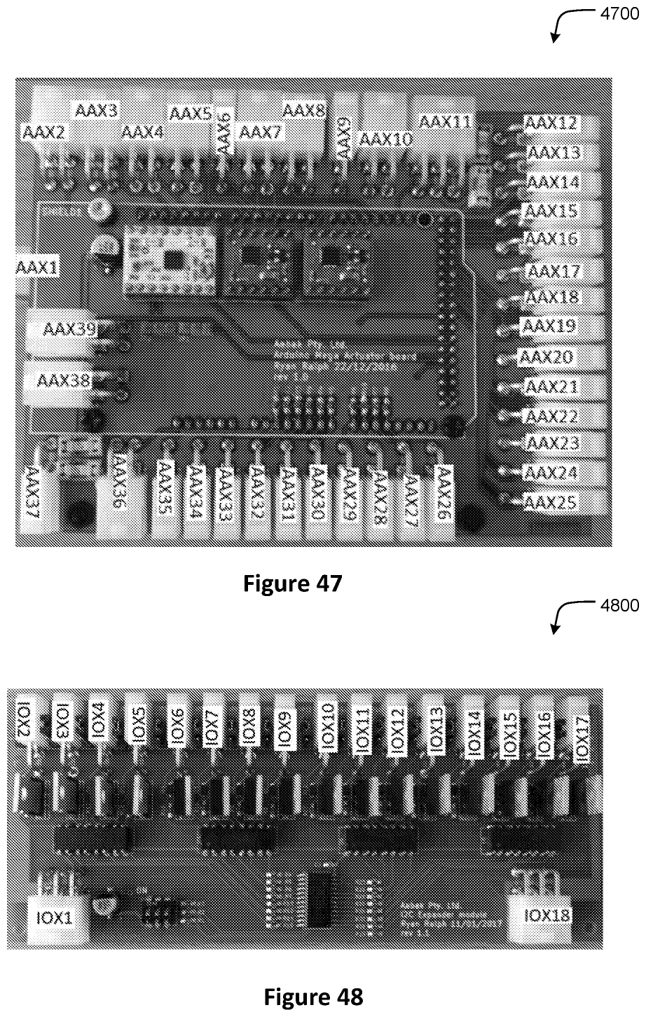

Actuator Board: An Actuator Microcontroller 4700 as shown in FIG. 47 may incorporate several connectors for actuators used in the Coffee Preparation System 110. The Actuator Microcontroller 4700 may be connected to the Coffee Preparation System Controller 240 through a USB cable or other suitable communication medium. A suitable microcontroller such as Arduino™ MEGA 2560 may be used as the Actuator Microcontroller 4700. The Actuator Microcontroller 4700 may also house one or more motor speed controllers and a 6 v stepper motor driver.

In some embodiments, an IO Expander Board 4800 as shown in FIG. 48 may be utilised to allow connections to a number of 12 v or 24 v controlled valves and other miscellaneous actuators. The IO Expander Board 4800 may have 16 or more pins, with each individual pin selectable for 12V or 24V inputs. The IO Expander Board 4800 may be addressable and it may be daisy chained with additional IO Expander Board 4800s. Each pin may have jumper beside it allowing selection of an output voltage for the pin (12V/24V).

Stepper Motors and Drivers:

The supply of sugar from a Sugar Dispensing Station 205 may be physically actuated using a stepper motor. The opening and closing of doors controlling access to a collection shelf 4100 may be physically actuated using another one or more stepper motor. A NEMA™ 23 stepper motor may be used in some embodiments. Stepper motors may receive instructions with motor direction and number of steps from the Coffee Preparation System Controller 240 through the Java™ based Controller Application. In some embodiments an RS Pro™ Hybrid, Permanent Magnet Stepper Motor may be used as the stepper motor.

Grind Adjustment Stepper:

A grinding station 203 may also be driven by a stepper motor. A Dual Shaft Nema™ 24 CNC Stepper Motor may be used in the grinding station 203. The stepper motor of the grinding station 203 may be driven by a stepper driver such as, a STEPPERONLINE™ Digital Stepper Driver DM542T.

Brushed Motors:

Parts of the grinding station 203 and grinder dose tube 920 may be driven by brushed DC motors. In some embodiments, the motors may be controlled by a Single Brushed DC Motor Driver Carrier such as a BD65496MUV.

Valves:

Two types for valves used in the Coffee Preparation System 110; pneumatic valves and hydraulic valves. Pneumatic valves may be used for a grinder hopper 910 feeding tube in the grinding station 203, a puck removal body 2230, grind separation door, and any robotic arm end effector. Hydraulic valves may be used to electronically dispense hot water in the Brewing Station 202 and a Cleaning station 207.

The robotic arms may utilise SMC™ SY3000 or SY5000 Series 5 port solenoid valves to pneumatically actuate the Brewing Arm Jaw Gripper, as well as both sets of Cup Gripper, for example. The grind separation swing door may also uses the same series of valve for actuation. The valves may operate at 24 VDC with a peak power consumption of 0.35 W, for example. The valves may be controlled by the Bot I/O board. One advantage of the selected valves is a low current output requirement from the Robot CU (around 20 mA).

In some embodiments, the grinder dose tube 920, puck removal station 2200, Lid Suction End Effector, and dose shaving unit 2000 may use a VX210HA Solenoid valve from SMC™, for example. The valves may operate at 24 VDC with a peak power consumption of approximately 4.5 W, for example. The valves may be controlled by the Actuator Microcontroller 4700. In some embodiments, Lid Suction End Effector valve may be controlled by the BOT I/O Board.

The hydraulic valves may be supplied with 240 VAC power. The hydraulic valves may be controlled by relays connected to the Actuator Microcontroller 4700. In some embodiments, the Brewing Station Microcontroller 6400 as shown in FIG. 64 may have integrated relays as well as connections for 240V power and the valve control output.

Waste Water Pump:

Waste from the puck removal station 2200 and general cup waste is separated by a Grind Separation Unit 3100. Liquid waste may be collected in a small tray which can be fitted with a float switch and a draining outlet. The outlet may be connected to a 12 VDC water pump which turns on when the liquid level actuates the float switch. Outlet of a waste water pump is connected to the two upper waste vats.

The waste water pump may be part of an independent closed-loop system which is may not monitored by the Coffee Preparation System Controller 240. A float switch may drive a relay which can be connected to the waste water pump. The relay may be implemented as the float switch switching current can be lower than the current draw of the waste pump.

Sensor Board:

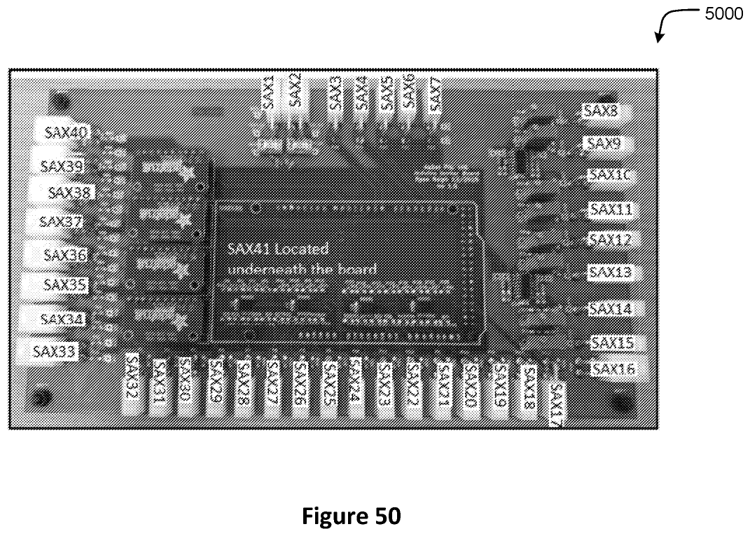

A sensor microcontroller 5000 as shown in FIG. 50 may act as a connection point for the various sensors in the Coffee Preparation System 110. The sensor microcontroller 5000 may also perform a translation of raw sensor voltages into a serial data stream. The serial data may be sent via a USB communication channel directly to the Coffee Preparation System Controller 240 where it may be read by a Java™ based Controller Application, for example.

The sensor microcontroller 5000 may comprise varying types of inputs. The inputs may include: 16 analog inputs with 16 bit resolution, 16 analog inputs with 10 bit resolution, and adjustable comparators. The 16 bit resolution inputs may use a Texas Instruments™ ADS1115 analog to digital signal converters on a breakout board from Adafruit™, for example. The analog to digital signal converters may communicate a digital value to the sensor microcontroller 5000 using 1-C protocol, for example. The 10 bit resolution inputs may use the onboard analog-to-digital-converters of the sensor microcontroller 5000, for example. An Arduino™ Mega 2560 may be used as the sensor microcontroller 5000, for example.

The adjustable comparator may take an analog voltage as input and compare it to a reference voltage set by an adjustable 10 turn potentiometer. The input and the reference voltage may be fed into a comparator and the digital output is fed into the digital inputs of the sensor microcontroller 5000. Some embodiments may not comprise adjustable comparators.

Temperature Measurement:

Two types of temperature sensors may be used for temperature measurements. A brew temperature sensor may be a 10K ohm NTC™ thermistor encased in 316 SS, for example. The fridge temperature sensor may be a 10K PTC™ thermistor in a stainless steel enclosure, for example. Calibration using the Steinhart-Hart Equation was completed for both systems.

Pressure Measurements:

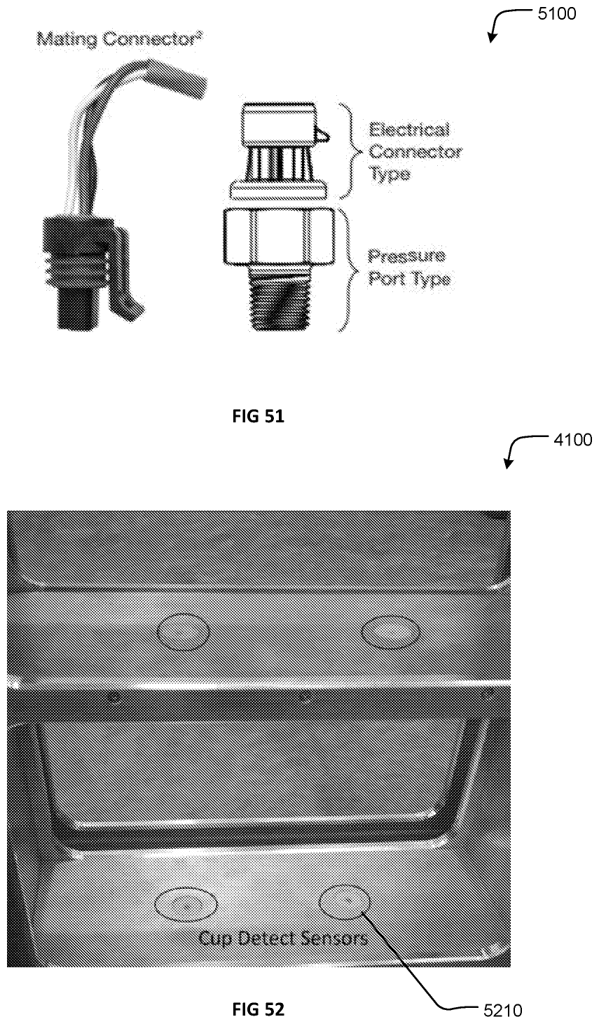

Pressure may be measured by pressure sensors. In some embodiments the pressure sensors may comprise Honeywell™ PX3 Series Pressure Transducers, which may use piezoresistive sensing technology with ASIC (Application Specific Integrated Circuit) signal conditioning, for example. The unit may be encased in a brass housing and may use a Metri-Pack 150 electrical connector, for example. The pressure sensor may be fully calibrated and temperature compensated from −40° C. to 125° C. [−40° F. to 257° F.], for example. The pressure sensors may be fitted on the steam and hot water boilers inside the Brewing Station 202, as well as the compressor. FIG. 51 illustrates a pressure transducer 5100 according to some embodiments.

Light Dependant Resistor:

Light Dependant Resistors (LDRs) may be used to measure ambient light using analog input of the sensor board. These sensors may be used to detect cups in the collection shelf 4100, as well as level sensing for the beans in the grinder hopper 910. In some embodiments, detect cups in the collection shelf 4100 may be done using a computer vision detection system. FIG. 52 illustrates some cup detection sensors 5210 on a collection shelf 4100 according to some embodiments. The cup detection sensors may be based on a light dependent resistor.

Airlock Light Curtain:

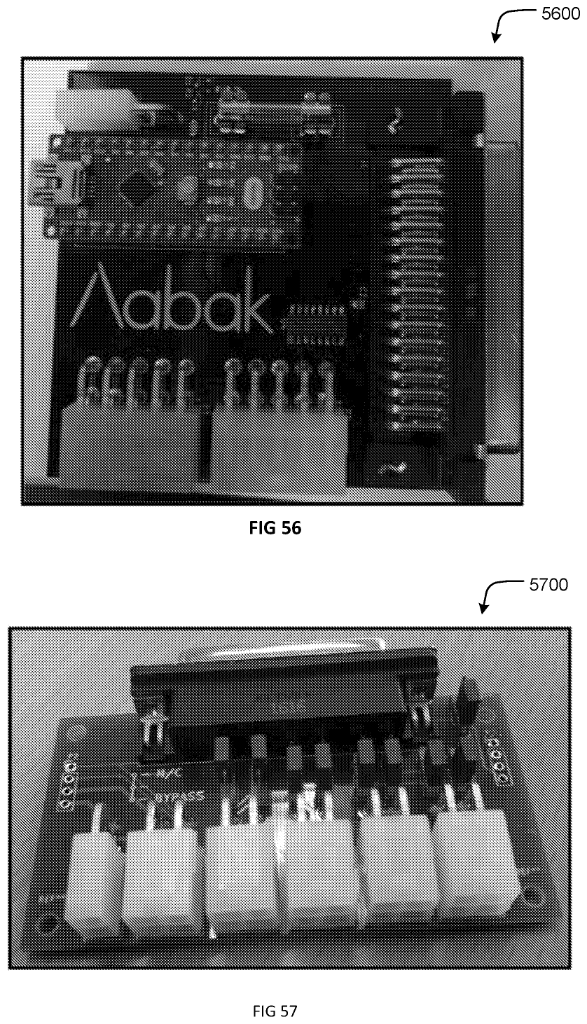

The collection shelf 4100 may have a light grid array (light curtain) sensor to determine if an object impedes the path of a customer side the collection shelf 4100. In some embodiments, sensor SPL-S280PPS2W04 Slim model from SICK™, which has a 40 mm beam spacing, may be used as the light curtain sensor. The light curtain may function as a safety sensor or to detect interference by a customer in the collection shelf 4100. The light curtain sensor may be powered by 24 VDC and its output may be fed into the Robot CU via a Robot IO board 5600 as shown in FIG. 56, for example. The signal may be read by the Coffee Preparation System Controller 240 and the Actuator Microcontroller 4700 may be sent a command to stop access to the collection shelf 4100 if a breaks in the light curtain is detected. FIG. 53 illustrates a light curtain 5300 according to some embodiments.

Door Safety Sensors:

To facilitate compliance with EN ISO 13849-1 and EN 62061 (IEC 62061) safety requirements and principles regarding safety of machinery and safety-related parts of control systems, door safety switches may be installed inside the upper cabinet. In some embodiments, SICK™ Magnetic Safety Switches the RE1 series from SICK™ which are compact non-contact safety switches with a long service life may be used. One of these safety switches, in conjunction with a suitable safety module, may facilitate compliance with the above mentioned safety guidance and principles.

Load Cells:

The Coffee Preparation System 110 may have two variants of a deflection type load cell that may be used for more precise mass measurements. In some embodiments, two 600 g load cells (Tedea Huntleigh™ 1004-00.6-JW00-RS) may be located in the Drip Tray for measuring the ‘coffee shot’ mass of brewed coffee and a 3 kg (Tedea Huntleigh™ 1042-0003-F000-RS) for a weighing station 2100 that measures the mass of coffee grounds in a group handle basket 610. To read the load cell strain gauge signals, a specific signal processor may be used within each load cell.

Each load cell may be connected to an Avery Weigh-Tronix™ ZM201 weight indicator. The weight indicator may be packaged in different enclosures to be more compact, IP rated and easily mountable inside the Coffee Preparation System 110. The signal processors used for reading the load cell strain gauges may be powered by 12 VDC and may use TCP/IP for communication with the Java™ based Controller Application. The load cell signal processors may execute a suite of software to allow for the upload or download of configuration files, identification of the unit on the network and calibration of the load cell.

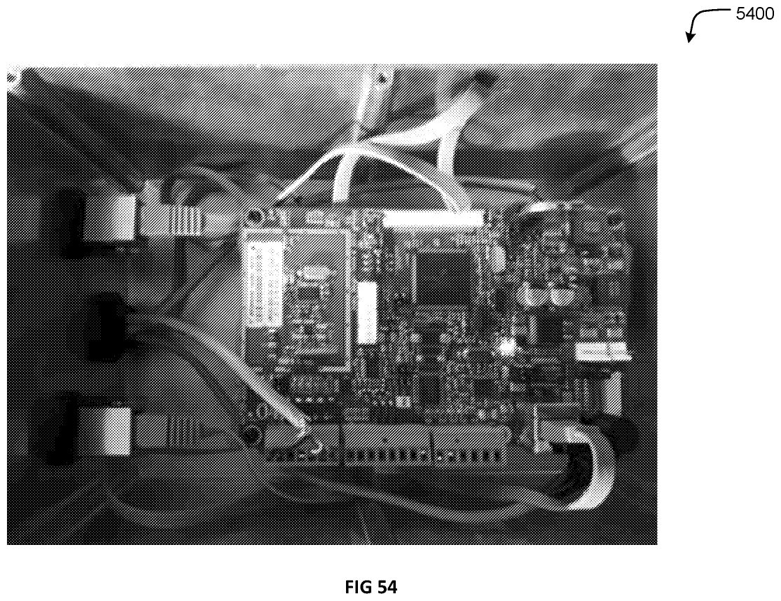

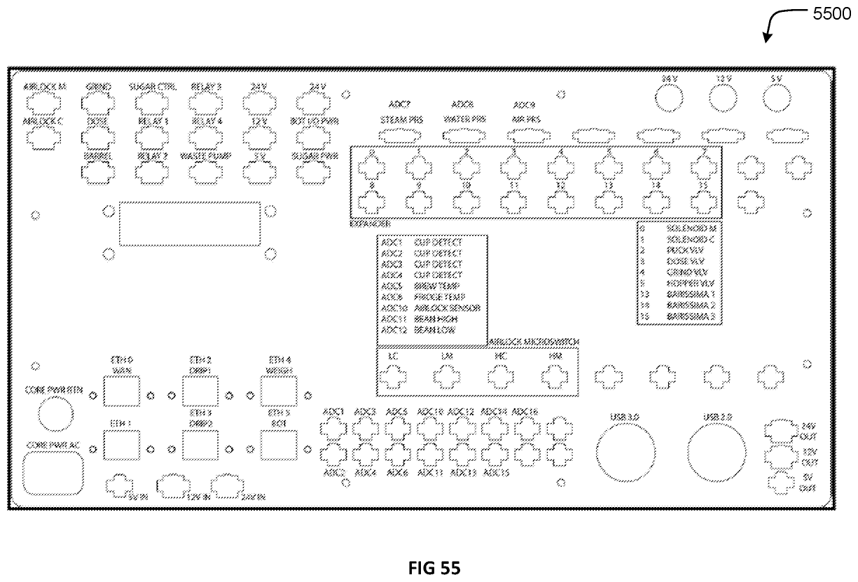

The load cell signal processors may be repackaged in an IP66 enclosure with two PCBs in one enclosure. One PCB may be for the drip tray load cells and another PCB enclosure for the weighing station. Repackaging may provide a more compact and better safeguard against water damage in case of leakage due to the positioning of the load cells. IP rated ethernet cables may pass through cable glands in the enclosures. FIG. 54 illustrates a Load Cell Signal Processor 5400 according to some embodiments.

Electronics Enclosure:

The Coffee Preparation System 110 may comprise an electronics enclosure that may serve as a main enclosure and house most of the electronics and DC power distribution. DIN rails may be placed inside the electronics box to allow the use of block terminals and easier arrangement of stepper motors. The following components may be located inside the electronics enclosure: stepper drivers for the collection shelf 4100 and the grinding station 203, the Coffee Preparation System Controller 240, DC Power Distribution terminals, Actuator Microcontroller 4700, sensor microcontroller 5000, IO Expander Board 4800, Ethernet Switch, Status lights for various DC voltages (5, 12, 24 VDC), etc. A front plate of the electronics enclosure may have openings that allow a male molex housing to be inserted for connecting to the various systems. Connections to the loom may be labelled.

The front plate may provide a breakout for all the connections inside of the electronics enclosure. Some ports may be dedicated for measuring the voltages on different voltage rails within the electronics box. An HDMI output may be provided for displaying information from the Coffee Preparation System Control System 240. The display may provide for general troubleshooting or support operations, for example. FIG. 55 illustrates a front plate of an electronics enclosure 5500 according to some embodiments.

Robot IO Board:

The A Robot IO Board 5600 provides an interface between the 5V logic running on the controllers within Coffee Preparation System 110 to the 24V logic running on the Robot CU and DU. It serves as a breakout for a 50 pin connector as well as a logic level converters in order to start the software running on the Robot CU.

TP Bypass:

The Robot CU may requires that a Teach Pendant plugged in or a TP “bypass” plug in order to function. The teach pendant may make up part of a safety circuit with its emergency stop button as well as a deadman switch and auto/teach select key switch. In some embodiments, Teach Pendants provided by the manufactures of the Robotic Arms may be used.

Safety Board:

A Safety Board may have a number of molex connectors as well as a main DB-25 connector into the Robot CU and DU. The safety board may require an external 24V input for powering the safety door circuit as well as at a minimum a 4 pin connection for an emergency stop button. The safety door circuits may be bypassed using the jumpers on the board and switching them to a “N/C” state. As a matter of safety the emergency stop button may be configured to not be bypassed. FIG. 57 illustrates a safety board 5700 according to some embodiments.

Wire Loom:

Cable harness, also known as the wire harness or wiring loom, is an assembly of cables and/or wires which transmit signals or electrical power. There may be two main origins for the cable harness in the Coffee Preparation System 110, mainly the electronics box for signals and DC power distribution and the power distribution boxes for AC power distribution. The electrical cables may be colour coded depending on their intended use and/or equipotential voltage.

Cable sizing for the Coffee Preparation System 110 may be carried out using parameters such as length of harness needed, power requirement for the systems, use environment and availability of cables. Connectors in Coffee Preparation System 110 can be categorised as general (spade, quick connect, . . . ) and specialised (IEC, molex . . . ). Molex and IEC connectors were chosen because of their abundance and multiple configurations. The Molex MINI-FIT JR. Series 4.2 mm Pitch is one of connectors used in the machine with Molex MINI-FIT, 5556 Series Number Crimp Terminals and Molex MINI-FIT, 5558 Series Number Crimp Terminals. The loom may be modelled using Solidworks™ software to get an approximation in length and size of the loom. The CAD may give a better perspective on the routing path and the possible interference in the chosen route. Generic connectors may be used in the CAD. The positions for P Clips and other mounting features may also added to the 3D model.

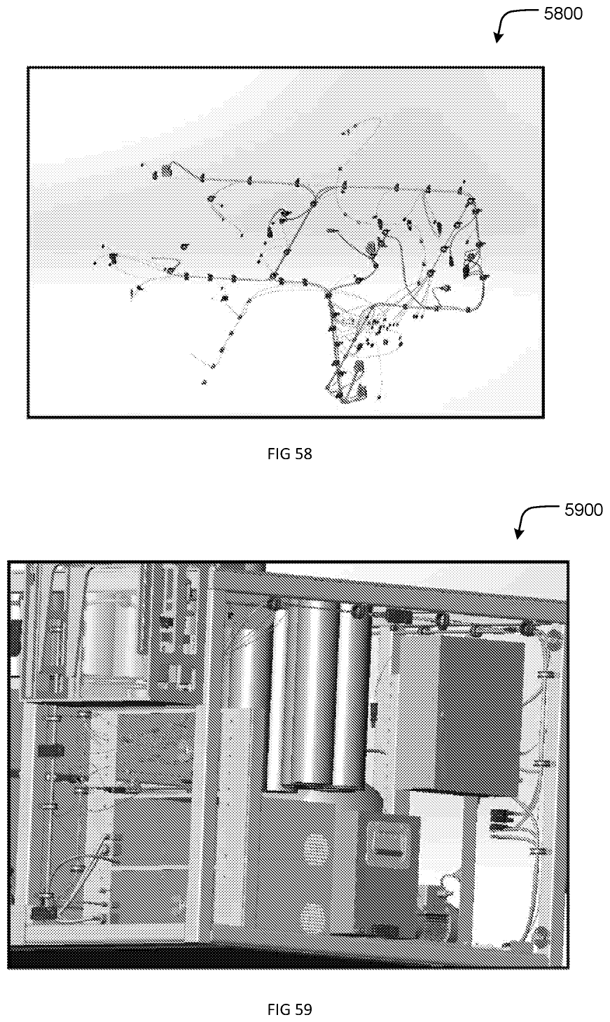

FIG. 58 illustrates the skeleton of a wire loom 5800 according to some embodiments. FIG. 59 illustrates a wire loom with a cabinet 5900 according to some embodiments.

Communications:

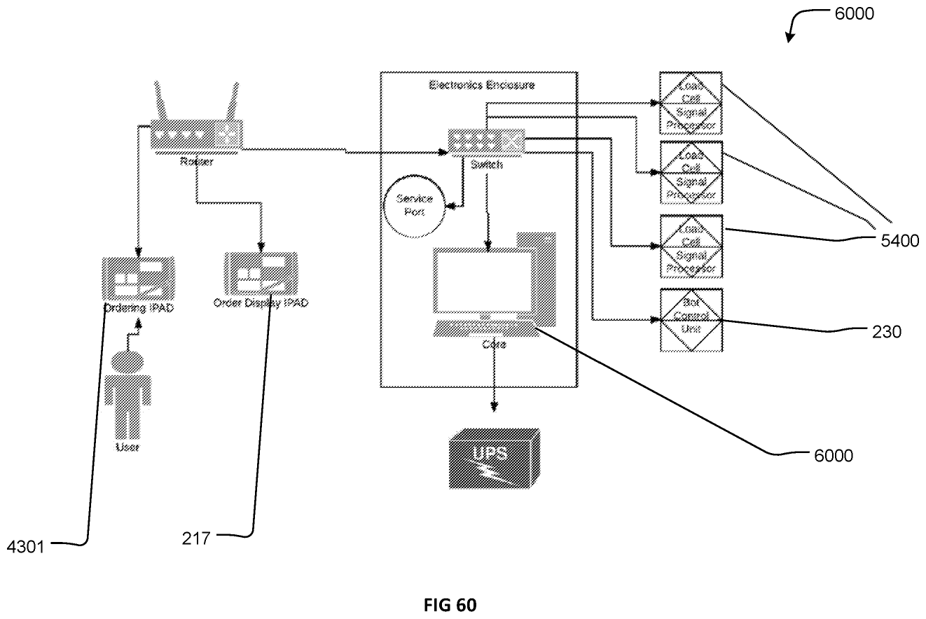

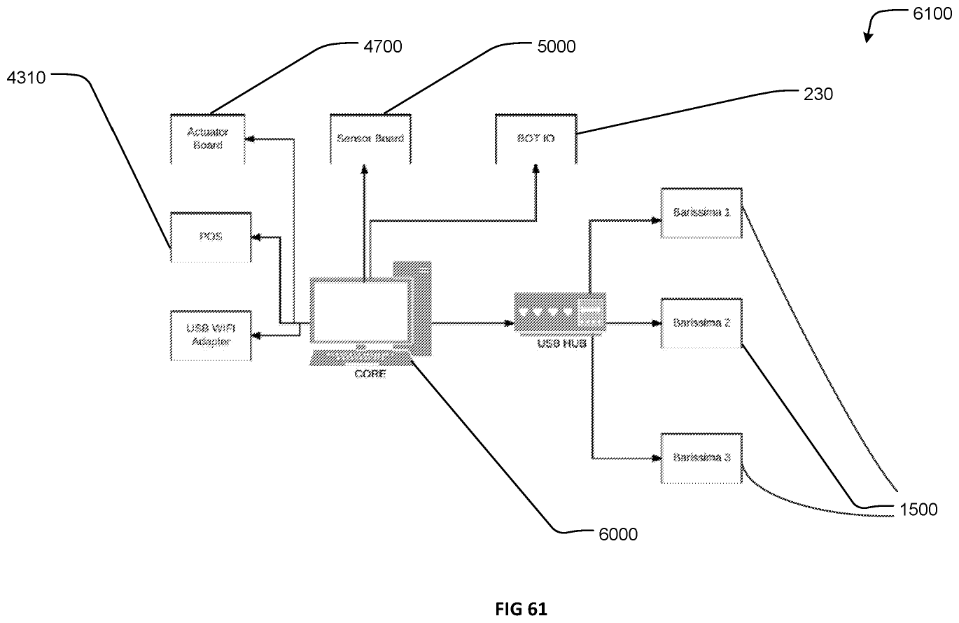

An unmanaged Ethernet switch may be used inside the Electronics Box to handle communications, the systems connected are the Coffee Preparation System Controller 240, load cell signal processors and the Robot CU. A WAN port may be included to provide an internet connection for analytics and payments processes. For easier maintenance and troubleshooting a service port may be included in the electronics box. The Actuator Microcontroller 4700, sensor microcontroller 5000, foaming station microcontroller 6200, POS may use Universal Serial Bus communication means. FIG. 60 illustrates a router driven communications network 6000 according to some embodiments. FIG. 61 illustrates a USB port driven communications network 6100 according to some embodiments.

Dose Control:

The weighing station 2100 is designed to improve accurate adjustments (reductions) to the mass of ground and tamped coffee within group handle basket 610. This may be achieved this with a motor coupled to a metal blade that spins after the dosed and tamped basket has been placed over it. This blade shaves off a small amount of coffee which is then deposited into an opening below and air may be used to remove the coffee and stop it from building up. A Crouzet geared DC motor which is controlled via the Actuator Microcontroller 4700 may be used. A motor driver may be controlled via pulse width modulation (PWM) and a direction input allowing 8 bit speed control (255 steps) in both directions. In order to control the depth of the scraping or wiping motion and effectively control the mass, tool height of the Robotic Brewing Arm may be adjusted. When the tool is lower to the table more coffee is removed. The movement is controlled to prevent aggressive scraping that may cause the coffee puck to dislodge.

Puck Removal:

A puck removal station 2200 provides for cleaning the group handle and any remaining coffee leftover from the brewing process. One way this is achieved is by spraying steaming hot water at the basket in the group handle and then blasting high pressure air in order to dry it. An air line from the compressor may run to the puck removal system with a 24V control valve, similarly for the hot water a hose runs from the Brewing Station 202 to the puck removal station 2200 with an internally housed 240V control valve. The control of both of these valves can be driven from the Actuator Microcontroller 4700 with the air valve routed through the IO Expander Board 4800 and the water valve controlled via the Brewing Station 202 control relay.

Brewing Station Control Board:

A Brewing Station 202 control PCB may provide for control of functionality of the Brewing Station 202. The Brewing Station 202 control PCB may receive the signals from a 12pin molex connector, coming from the electronics box, and using MOSFETs to pass instructions to the Brewing Station 202 using a standard 16 pin IDC ribbon cable connector. In some embodiments, Brewing Station 202 control PCB may use optoisolators and isolate the control signals from the Brewing Station 202 control circuitry. In some embodiments, two off the shelf 4× relay development boards may be used to implement this functionality.

Grinder Control Box:

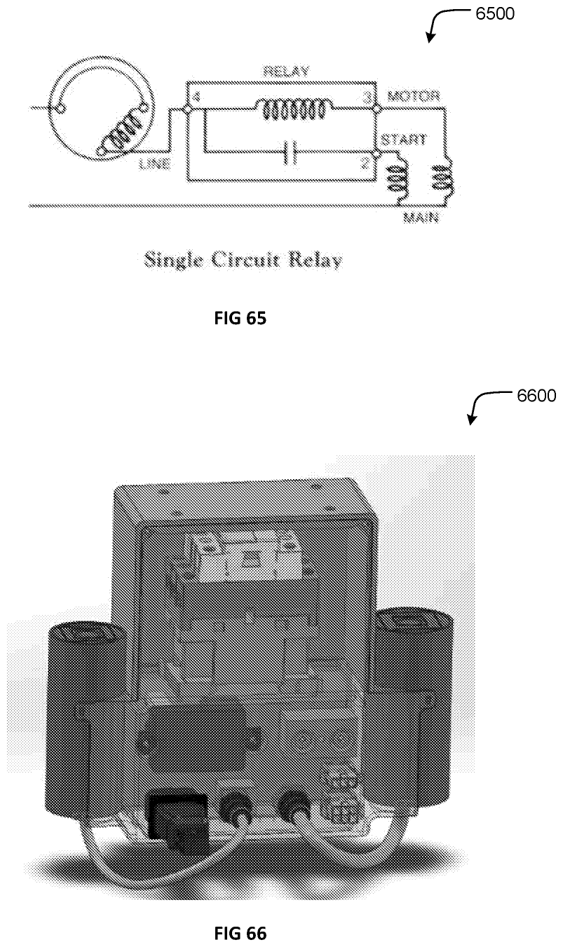

A grinding station 203 control box may houses most of the electrical components that comprise the grinding station 203. The main components include a 240V contactor, 5V logic level relay, motor soft starter and capacitors. Any original main switch and fill/safety microswitches may be removed and bypassed. The wires from the main switch connected to terminals A and A′ may be connected to one or more normally open terminals of a logic level relay which provides a signal in order to start the grinding station 203 motor. Original power connections may be removed and replaced by an IEC panel mount connector. The logic level relay may also be connected to a panel mount connector, a molex 3pin which has 5V, signal and ground connected to it. A protective earth wire may be connected to the grinder body, enclosure and any other metal components of the grinder. FIG. 65 illustrates a grinding station power box relay 6500 according to some embodiments. FIG. 66 illustrates a model of a grinding station power box 6600 according to some embodiments.

Firmware Upgrades:

Firmware of the foaming station microcontroller 6200 may be upgraded by removing the microcontroller from the foaming station and using a USB cable to upgrade the relevant firmware. In some embodiments, memory of the foaming station microcontroller 6200 may be accessible over a network and the firmware upgrade may be conducted wirelessly. Similarly, firmware of the Robot IO Board and the Actuator & Sensor Boards may be either upgraded through a physical connection such as a USB or wirelessly over a network.

Service Oriented Architecture:

Various components of the Coffee Preparation System are controlled by software applications designed to incorporate principles of Service-Oriented Architecture (SOA). Software design based on SOA allows greater modularity of various components. It allows one component to be upgraded or improved without significant impact to rest of the dependent or related software components. It further improves overall efficiency of the system. SOA based architecture also enables faster deployment.

A ordering application 6903 may be deployed on the ordering interface assembly 4300. The ordering interface assembly may comprise a tablet device or other similar input device providing a user interface. In some embodiments, the ordering application 6903 may be deployed on an Ordering Web Application Server 130. When deployed on the Ordering Web Application Server 130, the ordering application 6903 may be accessible through a public network as a webpage or as a dedicated application (“app”) on a mobile device. The ordering application 6903 allows a customer to identify themselves and place an order. The order may comprise one or more beverages. The order further comprises details of beverage choices and related configurations, for example nature of milk or amount of sugar. The ordering application 6903 may be configured to obtain or download configurations for its user interface from a remote server. The remote server may be part of a cloud service, such as Amazon™ Web service. For the present disclosure, each server described herein is a computing device or a collection of computing devices performing server functions in cooperation with various client devices, such as a customer mobile device and each automated coffee preparation system 110, and/or data storage devices, such as databases.

The ordering application 6903 may display a status that the system is ready to accept orders. An order menu may be displayed allowing a customer to choose and customise their order. The ordering application 6903 may subsequently prompt the customer to make a payment using a debit card, credit card, cash or other similar payment facilities. After confirmation of the payment from a payment network or a cash management system, the order may be posted to the Coffee Preparation System Controller 240 for further processing and fulfillment. The Coffee Preparation System Controller 240 upon receipt of the order may send a confirmation of receipt to the ordering application 6903. The confirmation may comprise an identifier for the order to facilitate collection.

A delivery application 6907 may be deployed on a delivery terminal. The delivery terminal may comprise a tablet device or other similar input device providing a display interface. The delivery application 6907 may be configured to obtain or download configurations for its display interface from a remote server. The remote server may be part of a cloud service, such as Amazon™ Web service. The delivery application 6907 may display processing status of one or more accepted orders. The delivery application 6907 may display a queue of multiple orders and their respective statuses. The delivery application 6907 may indicate the status of an order in the form of a completion percentage.

In some embodiments, the payment terminal 220 comprises an ordering interface assembly 4300, having a card validation interface 4310 to facilitate payments for orders. The card validation interface 4310 may communicate with the Coffee Preparation System Controller 240 through a communication port, such as a USB port. After an order is received by the Coffee Preparation System Controller 240, a payment request may be created and forwarded to the payment terminal. The customer may be prompted to present a credit card, a debit card, cash or other similar payment facility at the card validation interface 4310 for initiation and confirmation of a payment. After confirmation of a payment, the card validation interface 4310 may return a payment approval tag associated with an approved order.

In some embodiments, a Quest™ UT430 Self service, unattended EFTPOS payment terminal may be used for the payment terminal 220. In some embodiments, the payment terminal 220 may communicate with the Coffee Preparation System Controller 240 through a Payment Processing Module 6511. The Payment Processing Module 6511 may be developed using the C# programming language. In some embodiments, order details may be communicated in the form of XML messages or requests. The Payment Processing Module 6511 may retrieve configuration parameters or setting from one or more remote servers. In some embodiments, the remote servers may be part of a cloud service such as Cloud EFTPOS provided by Quest™.

Online Order Cycle:

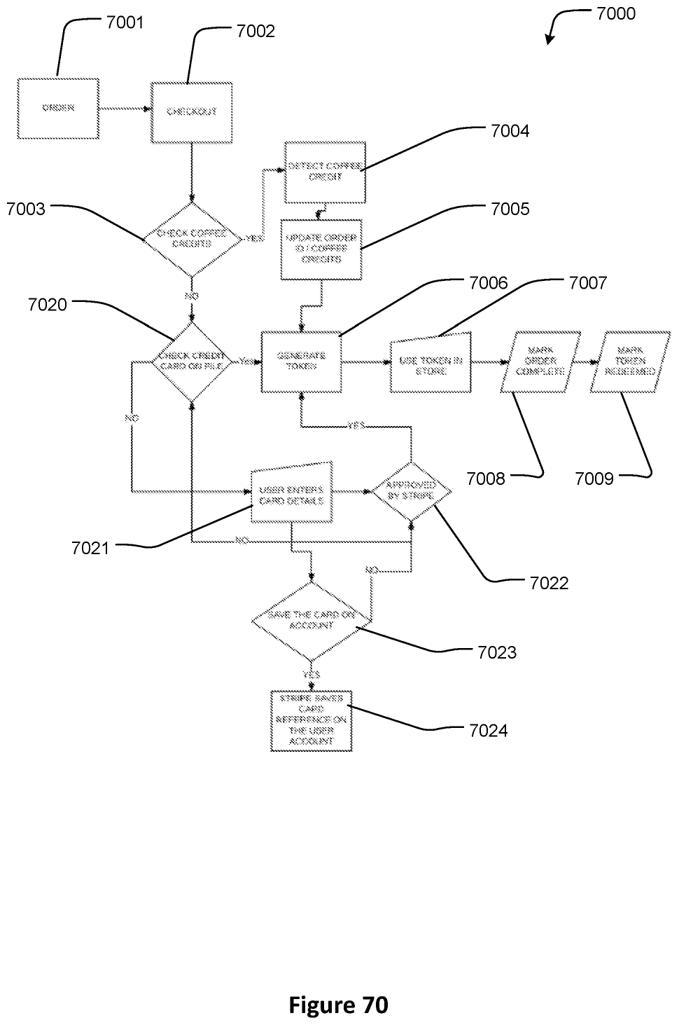

In some embodiments, an order may be processed according to the flowchart 7000 as shown in FIG. 70. At step 7001, a customer may identify themselves using a swipe card and place an order with the necessary details of one of more beverages. At step 7002 the customer may initiate a checkout. At steps 7003 and 7004, the customer's coffee credit may be checked to ascertain if the customer has sufficient credit for the order. At step 7005, the customer's coffee credits may be updated and at step 7006 a token may be generated for the customer's order. After step 7003, if a customer does not have any coffee credits, at step 7020 stored records of credit cards or debit cards or other payment credentials for the customer may be checked. If the customer does not have any stored payment credentials, then at 7021 the customer may be prompted to enter payment credential details such as credit card or debit card details for example. At step 7023, the customer may be further prompted to save payment credential details for future use. If the customer approves, then the payment credential details may be saved at step 7024. If the customer does not approve, payment for the order may be processed at step 7022 and a token may be generated at step 7006. At step 7007, the generated token may be used to process the order. At step 7008, the order may be marked as completed or fulfilled and at step 7009 the token may be marked as redeemed.

Dashboard Server:

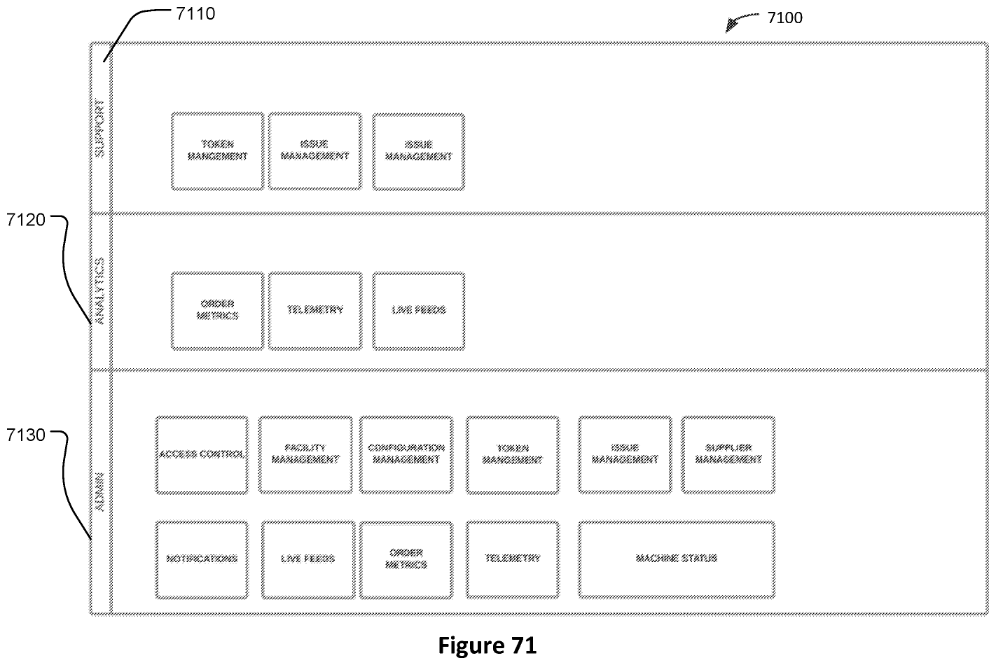

In some embodiments, several function may be centralised in a Coffee Preparation Array Configuration Server 120. FIG. 71 shows some logical dashboard components 7100 of the Coffee Preparation Array Configuration Server 120 according to some embodiments. One or more support dashboards 7110 may be included. In some embodiments, support dashboards 7110 may comprise a token management system, and an issue management system, for example. One or more analytics dashboards 7120 may be included. In some embodiments, analytics dashboards 7120 may comprise an order metrics system, an issue management system, and a live feed system for example. One or more administration dashboards 7130 may be included. In some embodiments, administration dashboards 7130 may comprise access control, facility management, configuration management, token configuration management, issue management, supplier management, notification management, live feed configuration, and machine status dashboards, for example.

Data generated may be stored in one or more databases. In some embodiments, a MySQL database may be used. The stored data may be represented in graphical representations such as charts to allow observations of trends, providing support services and aiding decision making processes. The stored data may be used to evaluate optimum resupply or servicing schedules.

Data generated from sensors may also be stored. The stored sensor data, such as data from pressure transducers or from load cells, may be stored in a relational database such as MySQL. In some embodiments, the sensor data may be stored in a NoSQL database such as Dynamo DB on Amazon Web Service™. The stored sensor data may be graphically represented to allow monitoring of the status of Coffee Preparation Systems 110 and to aid in capacity planning. Capacity planning may comprise scheduling resupply of coffee beans, milk or other necessary ingredients for preparation of beverages.

Total Order metrics may be categorised as total orders, total coffees, and total revenue. The analytics dashboard may give a snapshot of the types of coffee ordered over time. Various time parameters available may be lifetime, last 6 months, last month, last 7 days and last 24 hours, for example.

Various store configuration and administration tasks may be performed using the administration dashboards 7130. The administration dashboards 7130 may have access to create, update and delete tokens.

The support dashboards 7110 may enable service and support personnel to carry out support tasks. In some embodiments Jira™ Helpdesk may be integrated to the support dashboards 7110 to monitor and control customer support.

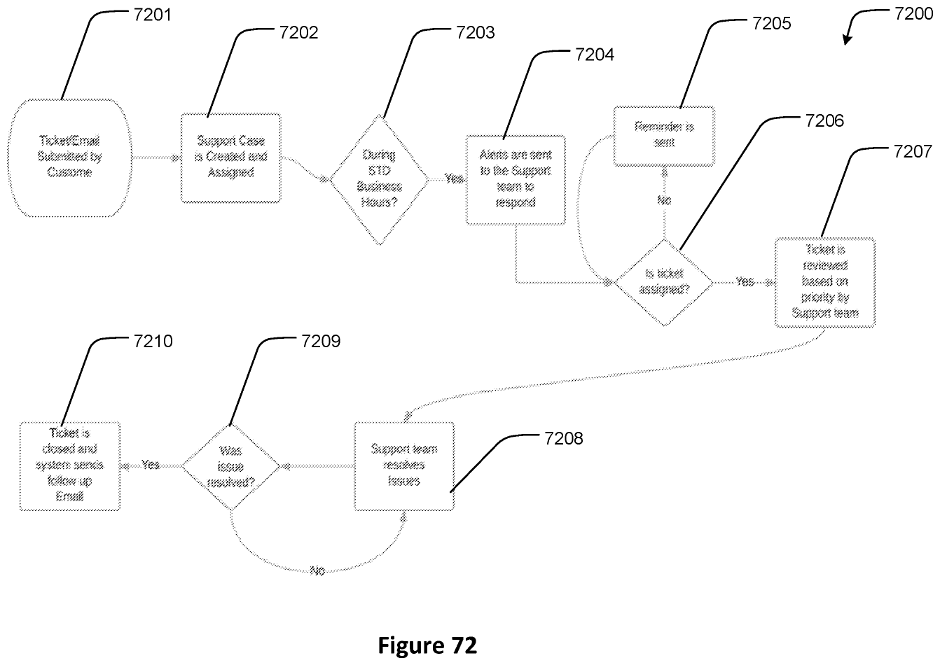

FIG. 72 illustrates a flowchart 7200 for a support procedure according to some embodiments. A user or customer may send an email to a designated support email address at stem 7201. At 7202 a support case may be created and assigned to a personnel. At step 7203 the relevant business hours may be assessed and at step 7204 alerts might be sent to support teams. Through steps 7205, 7206, 7207, the ticket may be assigned and prioritised. Through steps 7208 and 7209, the relevant issue may be addressed and resolved. At step 7210, the support ticked may be closed and the customer may be notified.

The dashboards may incorporate several software technologies. In some embodiments Ubuntu may be used as the operating system. Java™, PHP, NodeJS, Python, Obj-C and Swift may be used as programming languages. Data communication between subsystems may be facilitated though XML or JSON based formatting. Wordpress, WooCommerce and Laravel frameworks may be used for relevant web applications or dashboards.

Machine Power Up Sequence:

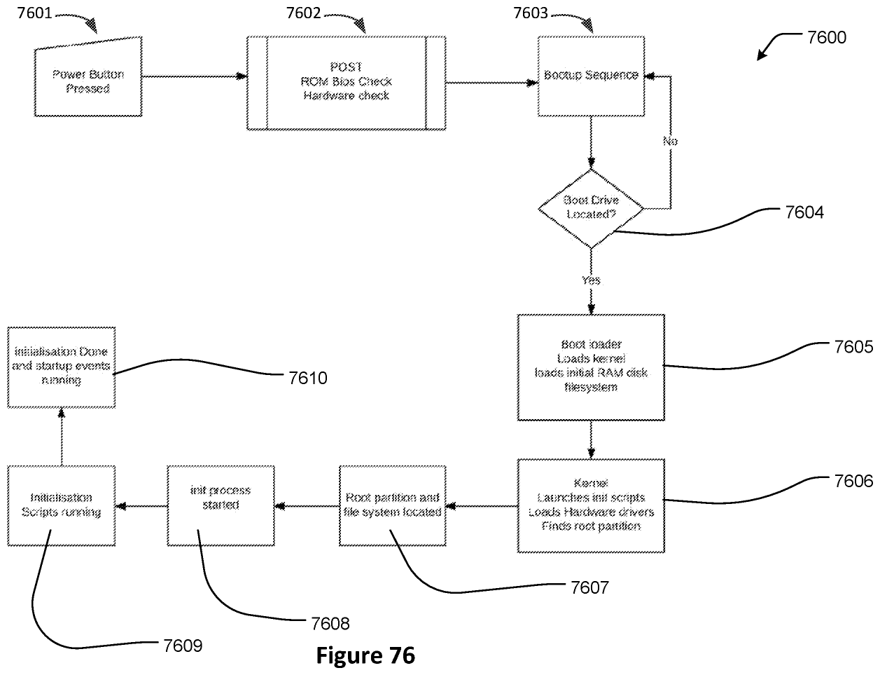

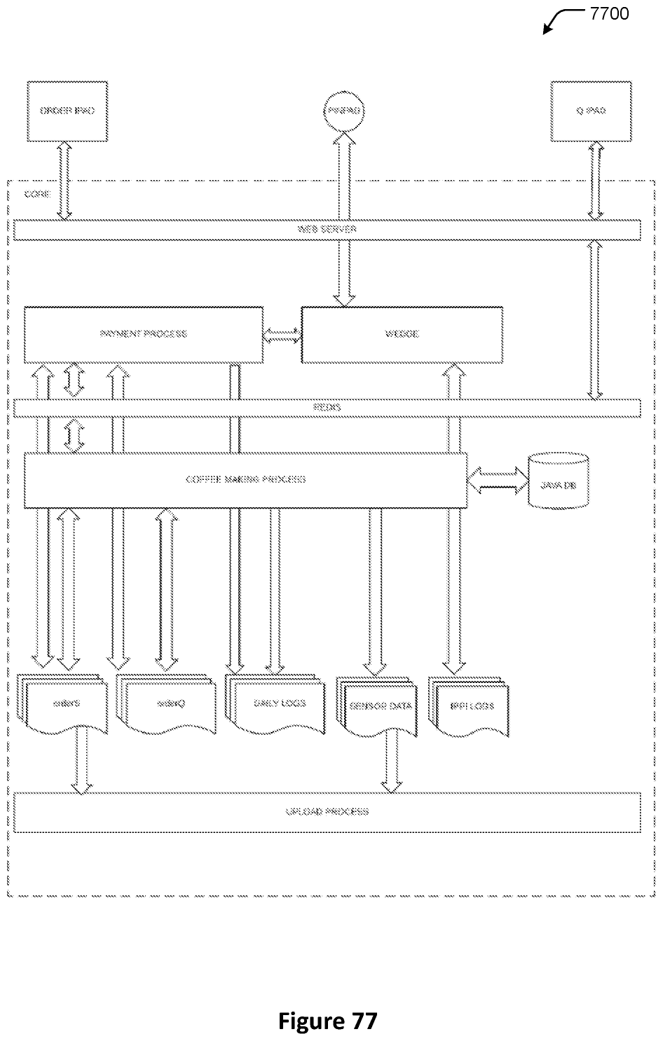

FIG. 76 illustrates a power up sequence flow 7600 for the Coffee Preparation System Controller 240. The firmware of the Coffee Preparation System Controller 240 may be modified in some embodiments to perform certain specific functions. One function may be to configure the controller to automatically power-on after a power failure. Another function may be to allow the controller to be woken up by a LAP Function.

When a power button for the Coffee Preparation System Controller 240 is pressed at step 7601, a power-on self-test (POST) is performed at step 7602. During the POST step, the status of all the hardware, bios chip and ROM is determined. If all components are determined to be functioning properly, the firmware looks for an operating system (OS) to load.

Steps 7603 to 7606 comprise a boot sequence which looks through a sequence of drives to find a drive containing the operating system (OS). Looking to the appropriate boot drive, the BIOS will first encounter a boot record, which tells it where to find the beginning of the OS and the subsequent program file that will initialize the OS. A boot loader stored in a first sector of a hard disk, a Master Boot Record, will begin the next phase which consists of loading a kernel and an initial ram disk file systems.

The kernel provides access to hardware and other services. A bootloader starts the kernel running. A file system which is present in memory, called an ‘initrd’ for ‘initial ram disk’, is used to limit kernels to a reasonable size and permit separate modules for separate hardware. Both the kernel file to load and the initial ram disk are normally specified as options to the boot loader. The kernel launches the init script inside the initrd file system, which loads hardware drivers and finds the root partition.

After the kernel is running, remainder of the operating system is brought online through other steps, including step 7607. First, the root partition and filesystem are located, checked and mounted. Next, an initialisation process may be started at step 7608 which may run initialization scripts. After completion of initialisation, startup events may be executed on run at step 7610.

Core Computing Activities: The Coffee Preparation System Controller 240 may comprise several modules or subsystems. A Data Upload Module 6913 may upload order and sensor data to a cloud storage device. In some embodiments an Amazon™ S3 storage service may be used as cloud storage. In some embodiments Apache2 webserver and Redis™ in-memory database may be used as an intermediary or middle layer between the several subsystems or modules. In some embodiments Ansible™ configuration management tool may be used to manage the configuration of several subsystems. All application events and the machine events may be recorded in one or more log files which may be generated on a daily basis. To improve system stability various monitoring services may be implemented. Monitoring services may control the state of the application and may create the component level dependencies. Process flow may be monitored between services and applications to reduce fault tolerance and increase the reliability.

Figure illustrates data flow 7700 across several components of the Coffee Preparation System Controller 240, according to some embodiments. A payment process and a wedge process executed by a Payments Processing Module 6911 may process a payment associated with an order. After completion of the payment, coffee preparation process may be initiated by invoking a Robotic Arm Control Module 6905 or a Grinder Control Module 6915 or any one of the other relevant modules. Individual modules within the Coffee Preparation System Controller Application 6901 may interact with each other using an in memory database to pass state and flow control signals. Data generated as part of the operation of the Coffee Preparation Controller 240 and any Sensor Data may be temporarily stored locally and subsequently uploaded by the Data Upload Module 6913 to the Coffee Preparation Array Configuration Server 120 or any other sever or database for storage and further processing.

Coffee Preparation System Controller Application:

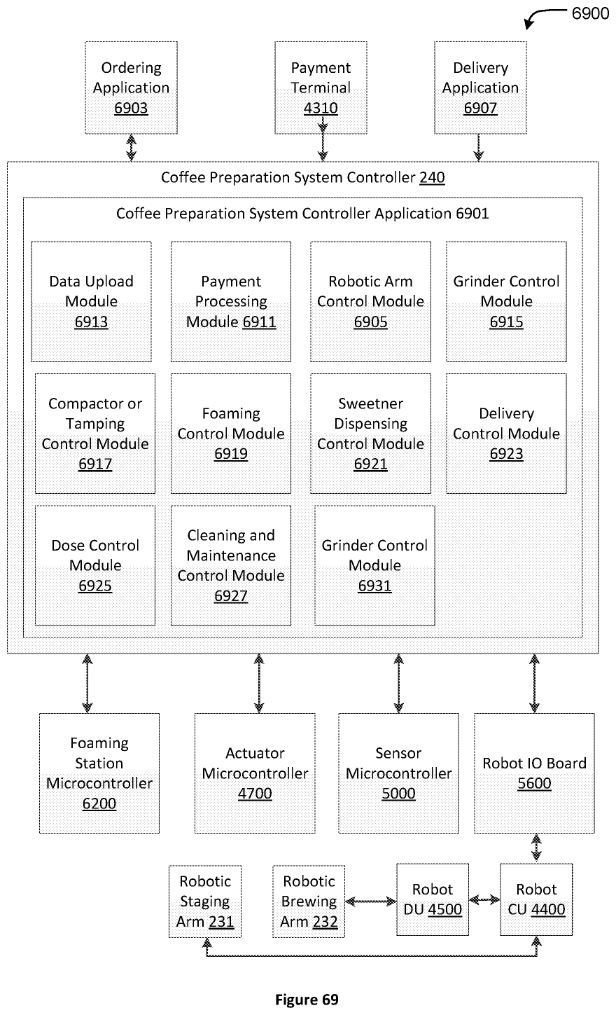

FIG. 69 illustrates part of a coffee preparation system 6900 according to some embodiments. The Coffee Preparation System Controller 240 may be configured to execute a Coffee Preparation System Controller Application 6901. The Coffee Preparation System Controller Application 6901 may comprise several modules handling specific functions of the overall coffee or beverage preparation process. Concurrent functioning of the several modules may be managed by thread management programming techniques. The Coffee Preparation System Controller Application 6901 may be a Java™ based application in some embodiments.

Robotic Movements:

Each robotic arm movement may correspond to a unique identifier number. The unique identifier number may be configured on the Robotic CU. The Robotic Arm Control Module 6905 may invoke the Robotic CU to initiate a specific movement based on a specific unique identifier. The Robotic Arm Control Module 6905 may be a Java™ based application in some embodiments. When the Robotic Arm Control Module 6905 sends a movement command to the Robotic CU, the Robotic CU may run a movement function that the given unique identifier number is associated with. Each movement function may be a series of movement commands operating through individual points. The Robotic CU may also ensure that the manipulator is in a correct starting point for the movement before the function is called, and then proceeds to execute the command. In some embodiments, commands from Epson™ RC+ Programming Language may be used by the Robot CU.

A heartbeat command may be used by the Robotic Arm Control Module 6905 to verify a connection to the Robot CU is still live. Response to the heartbeat command may be an echo of the command. Similarly a movement command may include an identifier of a movement to be performed by the robotic arm. The response may be an echo of the command and may be sent at completion of the movement. An end effector command may be used to actuate an end effector on an arm. Parameter of the end effector command may comprise an end effector identifier and on or off state of that end effector. The response may the end effector identifier after completion of the command or movement.

A tool offset command may be used to move the robotic arm a certain amount in a given axis of a current tool. Parameters for the tool offset command may include a tool identifier, and a measure of required movement. The response may be a tool identifier after completion of the requested movement. A speed command may be used to change speed of a robotic arm. The command may be speed identifier and a response may be an echo. A world offset command is a command similar to the tool offset command. The difference is that, the world offset command may be based on a different world co-ordinate system as opposed to a tool co-ordinate system. A tool change command may be used to change an active tool used by a robotic arm. For example, the tool change command may be used to change between two or group handles or filter baskets. Parameters for the tool change command may include a tool identifier.

In a manner similar to the above examples, sensor query commands may also be used by the Coffee Preparation System Controller Application 6901 to query a status of one or more sensors through the sensor microcontroller 5000.

Overall Automated Beverage Preparation Operation:

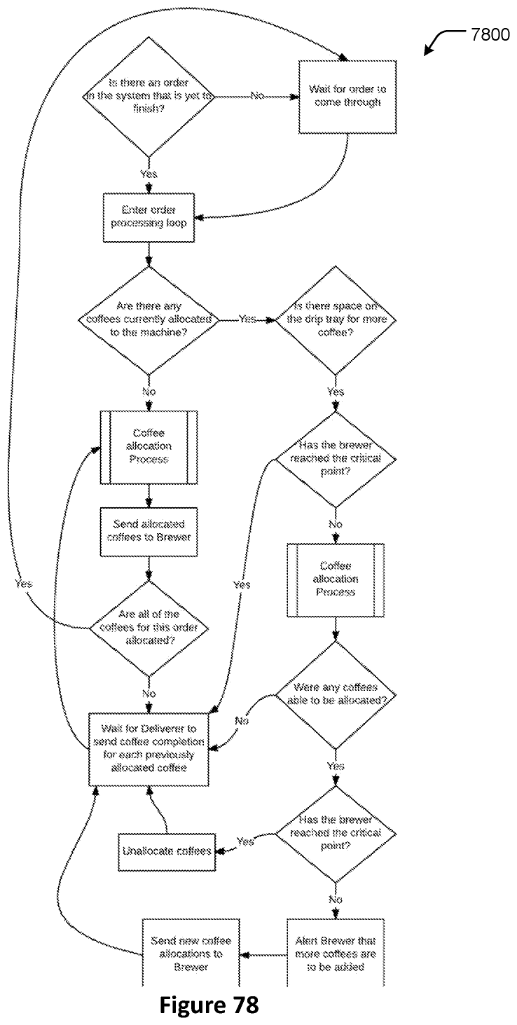

In some embodiments, the overall operation of the Coffee Preparation System 110 may include three stages: Order Processing, Coffee Allocation, Automated Brewing, and Delivery. FIG. 78 illustrates a flowchart 7800 for an order processing flow according to some embodiments. The order processing stage may include listening for new orders, awaiting completion of previous orders and invoking coffee allocation flow to processing new orders. The coffee preparation system controller 240 initially waits for an uncompleted order through the ordering application 6903. If no order has been detected, the controller may enter a wait phase until an order is received. If an order has been received, the coffee preparation system controller application 6901 initiates an order processing loop.

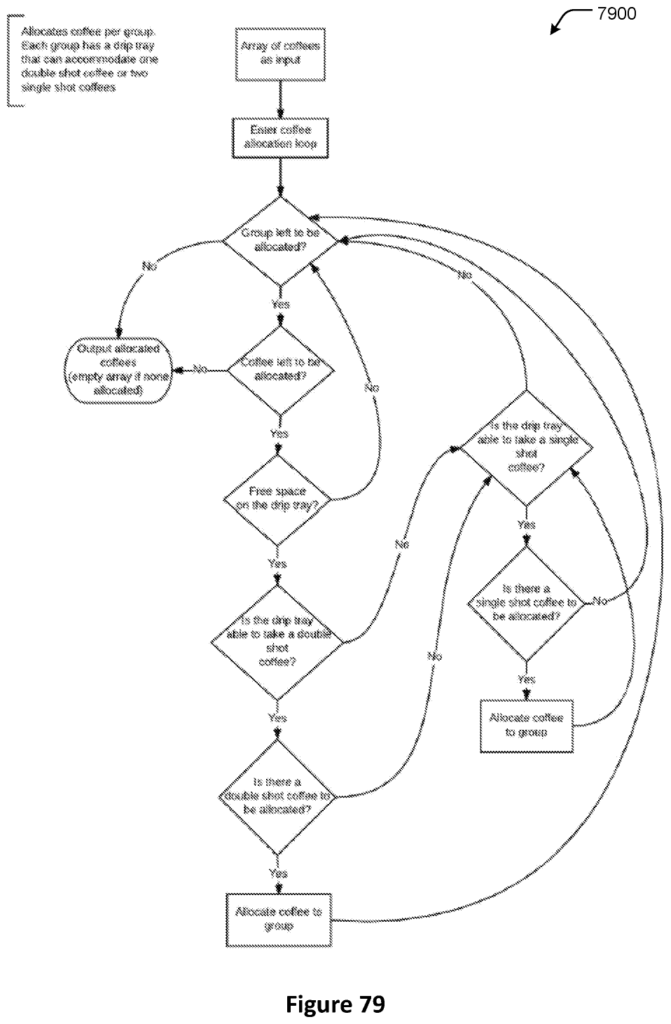

In the order processing loop, the controller 240 identifies first whether any coffee orders are currently allocated to the machine, and if any orders are currently allocated, the controller 240 then checks whether there is capacity on the drip tray 500 to receive another cup. If there is capacity on the drip tray 500, the system then checks whether the group machine 400 has reached the critical point of maximum holding capacity. If the critical point has not been reached, then the controller application 6901 initiates a coffee allocation process 7900 as depicted in FIG. 79. After the coffee allocation process concludes, the controller application 6901 checks whether the group machine 400 has reached the critical point. If at this stage the brewer has reached the critical point, then the coffees are unallocated and the controller application 6901 waits for the deliverer through the delivery control module 6923 to send a coffee completion notification for each previously allocated coffee. This then triggers an additional coffee allocation process stage, as shown in the flow chart 7800 as if no orders were currently allocated to the machine, until all coffees for the order have been allocated.

If, after an order processing loop has been initiated, no coffees have been currently allocated to the machine, then the controller 240 proceeds directly to the coffee allocation process as depicted in 7900. After the coffee allocation process concludes, the controller 240 then sends allocated coffees to the group machine 400 for a brewing process. After the brewing process concludes, the controller 240 checks whether all of the coffees for the order are allocated. If not, then the controller 240 reverts to the coffee allocation process 7900 and repeats this cycle until such a time as all coffees for the order are allocated. The controller 240 then enters a wait phase until another order is received.

FIG. 79 illustrates a coffee allocation flow 7900 according to some embodiments. The coffee allocation flow 7900 may include seeking available group handles or available slots in drip trays and allocating an order for a coffee to a group handle. In detail, the coffee allocation process 7900 allocates coffee per group head 430, where each group head 430 has associated with it a drip tray 500 that can accommodate one double shot coffee or two single shot coffees. The group size may correspond to the capacity of each group head 430 on the group machine 400. Beginning with an array of coffees as input, a coffee allocation loop is entered, wherein the controller application 6901 checks whether a group head 430 is left to be allocated. If there are no group heads 430 to be allocated, the brewing system performs a brewing cycle outputting allocated coffees, or emptying the array if there are no allocated coffees.

If a group head 430 has not yet been allocated, the controller application 6901 checks whether a coffee is left to be allocated to a group head 430. If not, then all coffees have been allocated and a brew cycle outputs the allocated coffee. If there are remaining coffee orders that have not yet been allocated to a group head 430, the controller application 6901 checks for free cup space on the drip tray 500 beneath the group head 430. If there is no capacity, the process 7900 reverts to the prior stage of checking if a group is left to be allocated. If there is free space on the drip tray 500, then the controller application 6901 checks whether the drip tray 500 has capacity to fill a double shot coffee order. If there is capacity for a double shot coffee order on the drip tray 500, and there is a double shot coffee awaiting allocation, then the coffee is allocated to that group. If there is no capacity for a double shot coffee on the drip tray 500, or there is no double shot coffee to be allocated, the controller application 6901 checks whether there is capacity on the drip tray to take a single shot of coffee. If there is capacity for a single shot, and a single shot of coffee is available to be allocated, then the controller application 6901 allocates the single shot coffee order to the available group head 430. If there is no capacity for a single shot on the drip tray, or there is no single shot coffee to be allocated, the controller application 6901 reverts the coffee allocation process to the initial check stage of whether there is a group left to be allocated.

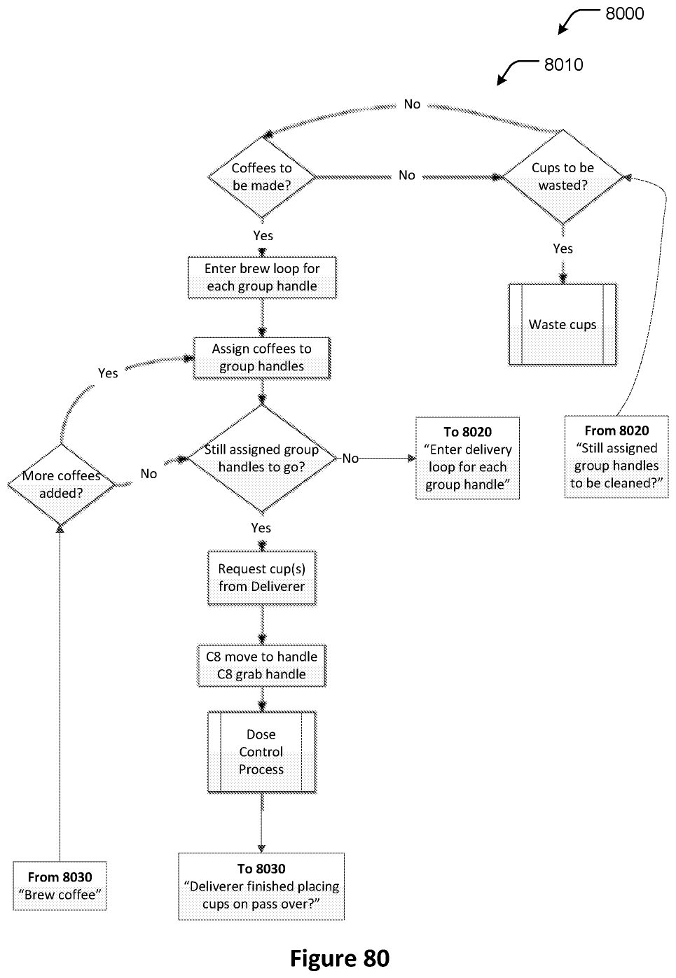

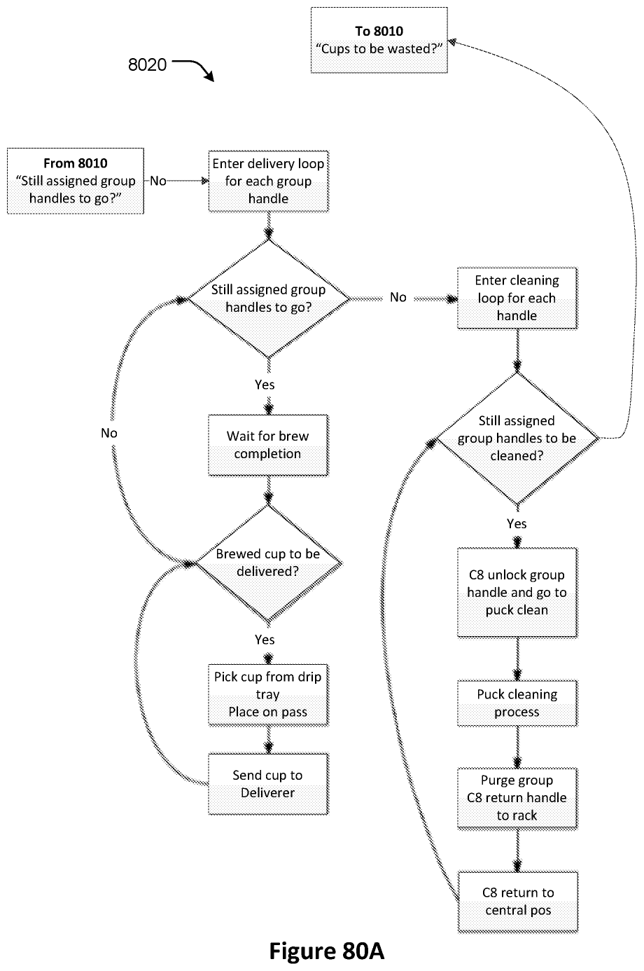

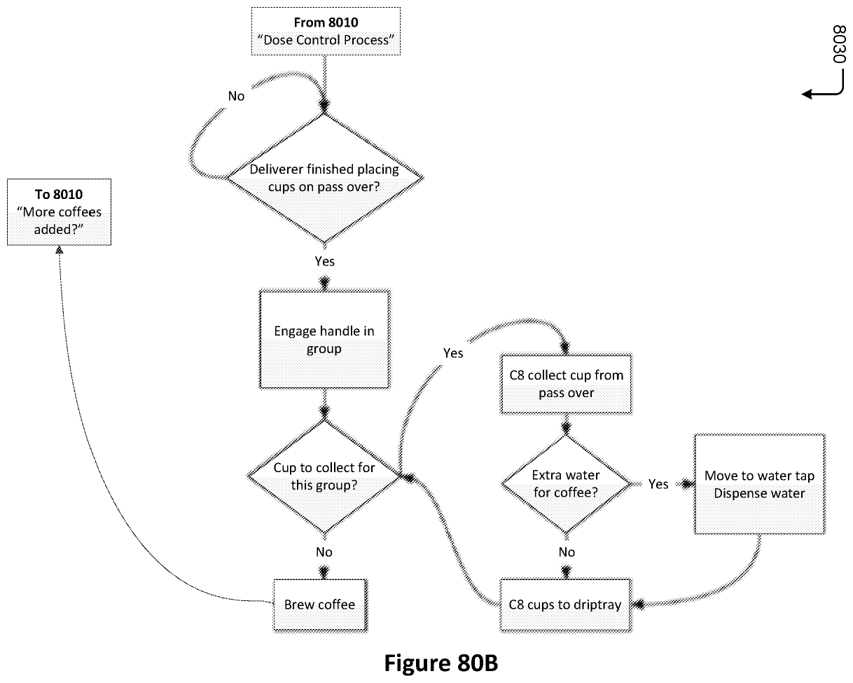

FIGS. 80, 80A and 80B together illustrate an automated beverage brewing process 8000 according to some embodiments. Process 8000 includes sub-processes 8010 (FIG. 80) for beverage preparation initiation and dose control, sub-process 8030 (FIG. 80B) for beverage brewing and sub-processes 8020 (FIG. 80A) for order completion and handle cleaning. The automated brewing process 8000 may include passing instructions to the brewing arm to engage a group handle 8930 and brew coffee, initiate intermediate cleaning processes, if necessary, and other related brewing processes. As shown in FIG. 80, the brewing operation 8000 at first receives a brewing order and identifies whether a coffee is to be made. If a coffee is to be made, a brew loop is commenced for each group handle 8930, after which coffees are assigned to group handles 8930. If a currently assigned group is available to go, a cup is requested from an available deliverer, where a deliverer may be one of the robotic brewing or staging arms 232, 231. The robotic brewing arm 232 may then be instructed to move to the group handle and grab the handle to perform a dose control process. After the dose control process, the controller application 6901 detects whether the deliverer has finished placing a cup on a pass over point, which may comprise a staging rack 410. The controller application 6901 waits until a deliverer has finished placing a cup on a pass over point before the group handle 8930 is engaged in the group head 430, after which the controller application 6901 detects whether a cup is awaiting collection for the group head 430.

If a cup is required, then the brewing arm 232 undergoes a collection operation from the pass over point, and further detects whether extra water is required for this coffee order. If extra water is required the cup is moved to a water dispenser to receive a water dose from the dispenser before continuing in the process by having the brewing arm move the cup to the drip tray 500. This process is repeated if additional cups are required for this group. If no further cups are required, the system performs a coffee brewing operation, before deciding whether more coffees are to be added to the coffee order.

Should there be no coffees requiring brewing, the controller application 6901 then detects whether there are cups to be wasted, and if so performs a wasting operation. Else, the controller application 6901 reverts to the prior state.

If there are no assigned group handles requiring orders, the controller application 6901 enters into a delivery loop for each group handle, wherein if there are assigned group handles have not completed their brewing cycle, the process waits for brew completion, decides whether the brewed coffee within the cup is to be delivered, and if so directs a brewing arm 232 to pick the cup from the drip tray and place the cup on the pass over point, and then sends the cup to the deliverer. This operation reverts the process to the prior stage of checking whether the brewed cup is to be delivered. If not, the system is then reverted to a prior stage where it checks whether still assigned group handles are to go.

If, at this stage the handles have completed their available orders, the system enters a cleaning loop for each group handle 8930. This sub process checks whether the assigned group handles are to be cleaned, and if yes, the brewing arm 232 is directed to unlock the group handle and move it to a puck cleaning station 207, initiate a puck cleaning process, purge the group head 430, and return the group handle 8930 to a tool rack before returning to a central position within the cabinet.

If there are no currently assigned group handle 8930 to be cleaned, the system reverts to its initial state.

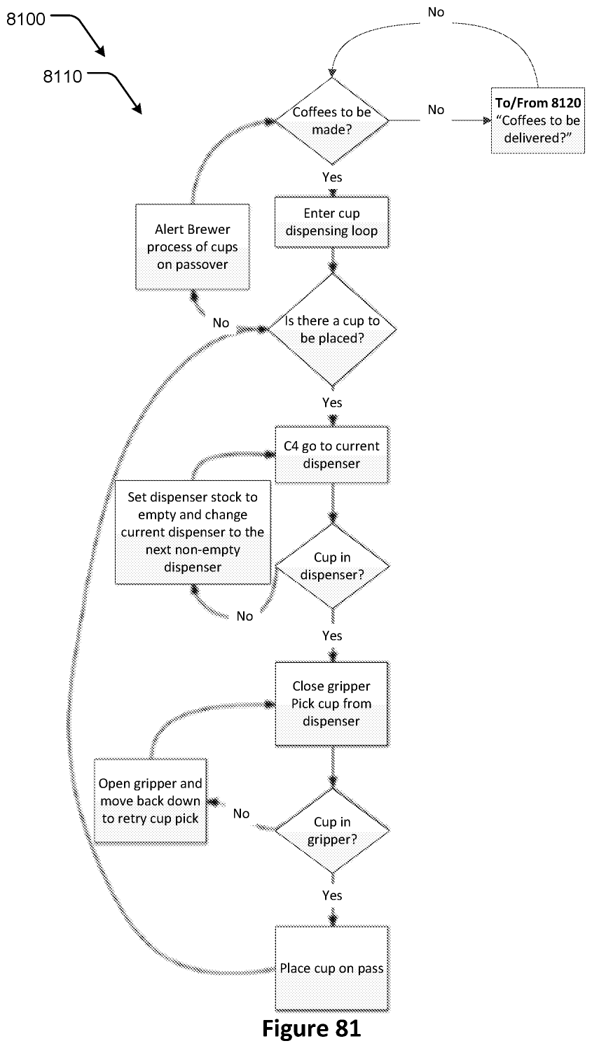

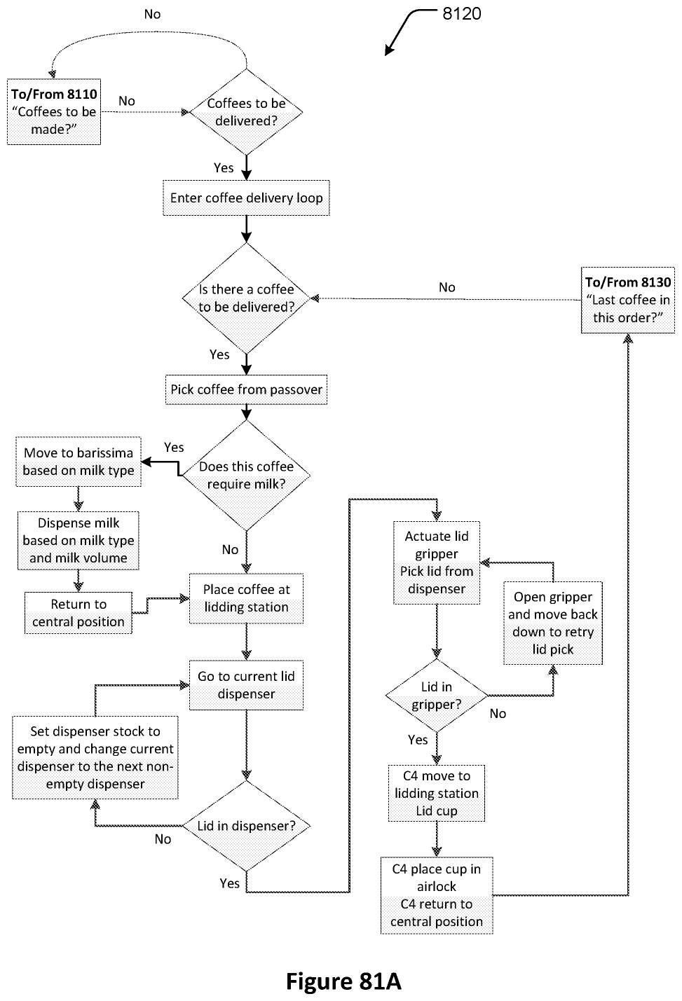

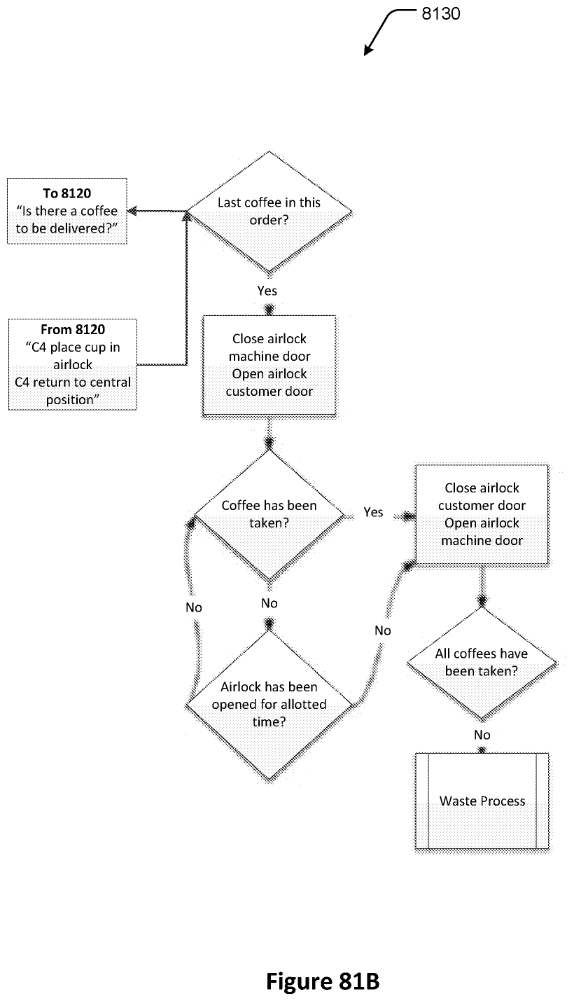

FIGS. 81, 81A and 81B together illustrate an automated coffee delivery process flow 8100 according to some embodiments. The automated coffee delivery process flow 8100 may include addition of milk to a brewed cup of coffee, placement of a lid on a prepared cup of coffee, delivery of prepared coffee to the collection shelf and other related delivery processes. The coffee delivery process flow 8100 further comprises a coffee preparation sub-process 8110, a coffee delivery sub-process 8120, and an airlock (delivery portal) operation sub-process 8130.

At the initial state, the controller application 6901 detects whether a coffee is to be made, and if so the process enters the coffee preparation sub-process 8110. Under this sub-process, the controller application 6901 enters a cup dispensing loop, wherein if a cup is to be placed the staging arm 231 moves to a current dispenser, and if a cup is available in the dispenser, the staging arm 231 closes its gripper and picks a cup from the dispenser. If no cups are available at the dispenser, the stock level is set to empty and the current dispenser is changed to the next non-empty dispenser.

The controller application 6901 then detects whether a cup is in the robotic staging arm gripper, and if so it places the cup on the pass over point. If there is not a cup in the robotic staging arm gripper then the gripper is opened and moved back down to retry the cup pick. After a cup has successfully been placed on the pass over point, the control application 6901 reverts to prior stage where it detects if a further cup is to be placed. If no further cups require placement, the brewer process is alerted of cups on the pass over point and the process reverts to its initial state.

If there are no coffees required to be made, the system instead initiates a coffee delivery sub-process 8120, where the controller application 6901 enters a coffee delivery loop if there are coffees to be delivered, else the process reverts to its initial state. In the coffee delivery loop, the controller application 6901 first checks whether a coffee is available to be delivered, and if so, directs a brewing arm 232 to pick the brewed coffee from a pass over point. If this coffee requires milk, it then moves the picked coffee to the milk foaming station 204 under the required milk type tap. The milk is dispensed based on milk type and milk volume, and the brewing arm with coffee cup is returned to a central position.

After the milk foaming operation, the coffee cup is placed at a lidding station, and a lid is picked from a lid dispenser if a lid is available. If no lids are in the dispenser, the dispenser stock is set to zero and the current dispenser is changed to the next non-empty dispenser. After a lid is confirmed to be in the dispenser, the lid gripper on the staging arm 231 is actuated to pick the lid. If the lid is detected within the gripper, the staging arm 231 moves to the lidding station and places the lid on the cup, before placing the cup in the airlock and returning to a central position. If no lid is detected within the gripper, the gripper is opened and moved back to retry the lid pick until a lid is confirmed within the gripper.

If the lidding operation is completed, the controller application 6901 checks whether there are any remaining coffees in the order. If not, the coffee delivery sub-process 8120 is reiterated, checking whether a coffee is to be delivered again. When the last coffee in the order is placed in the airlock, an airlock sub-process 8130 is initiated. At the first stage of the airlock sub-process 8130, the airlock machine facing door is closed, and the customer facing door is opened. The controller application 6901 then checks whether a coffee has been taken from the airlock. If a coffee has not been taken, the controller application 6901 checks whether the airlock has been opened for an allotted time, before reverting to the prior stage to check whether a coffee has been taken.

When a coffee has been taken from the airlock, the customer side door is closed, and the machine side airlock opens, before the controller application 6901 checks whether all coffees have been taken. If all coffees have not yet been taken, the controller application 6901 then initiates a waste process operation. If all coffees have been taken, the process reverts to the initial stage of checking whether any coffees are to be delivered.

Dose Control Module: A dose control module 6925 may be configured to communicate with weighing station load cell 2110 or other load cells. The dose control module 6925 may receive measured weight information from a relevant load cell and based on the measured weight and stored optimum weights, the dose control module may further generate calibration signals for other relevant modules.

Grinder Control Module:

A Grinder Control Module 6931, calibrates the fineness or coarseness of the coffee beans ground by the Grinding Station 203. The mass of a prepared coffee beverage may vary according to the nature of coffee beans used in the preparation, degree of roasting of coffee beans, fineness of grinds used, degree of compaction of grinds, the pressure of water passing through compacted grinds, temperature of water passing through compacted grinds, the duration of passage of water through compacted grinds and other relevant factors. Slight variation in any of the listed or other factors may result in a variation of the mass of a prepared coffee beverage. The inconsistency in mass of the coffee beverage may impact the concentration of a final prepared coffee beverage. Inconsistency in concentration of the coffee beverage may result in inconsistency in the quality and flavour of the prepared final coffee beverage.

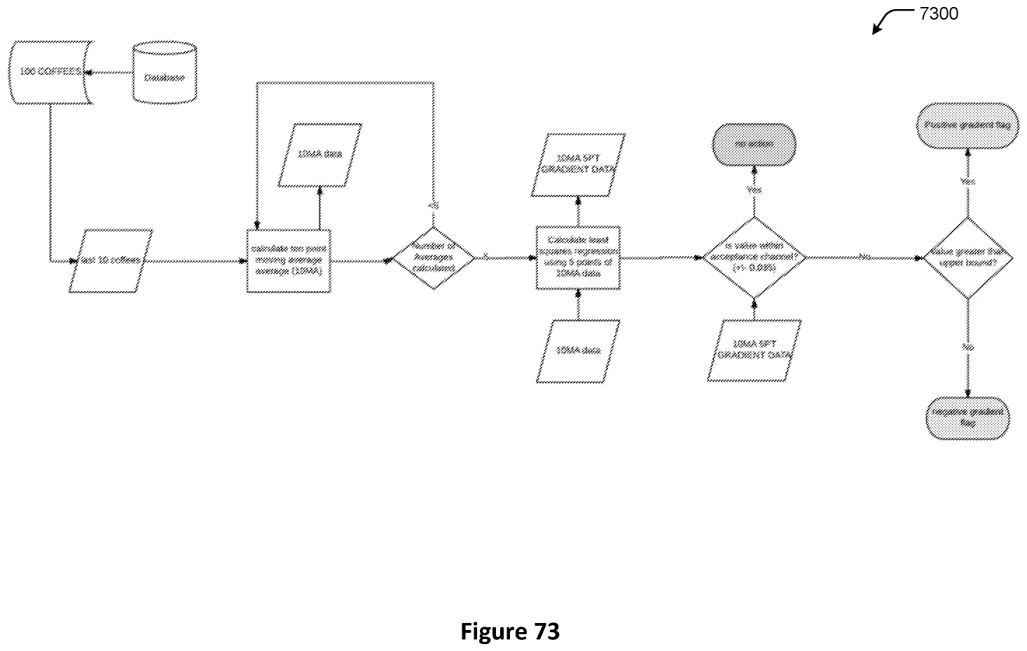

FIG. 73 illustrates a grind control flow chart 7300 according to some embodiments. Drip tray 500 may measure the mass of a prepared coffee beverage. The measured mass may be recorded in a local database by the Coffee Preparation System Controller 240 for ever cup of prepared coffee beverage. A sequence of recorded mass of prepared coffee beverages may be used to calculate a moving average. In some embodiments the sequence of recorded mass of prepared coffee beverages may be used to calculate a regression value. In some embodiments, a least squares regression method may be used to calculate the regression value. The calculated regression value may be compared with an acceptable range of regression values. In some embodiments the acceptable range may vary from −0.035 to 0.035, for example.

As shown in flowchart 7300, if the calculated regression value is above an upper bound, a positive grinding gradient flag may be raised by the Coffee Preparation System Controller 240. The positive grinding gradient flag may indicate more than expected water is passing through the compacted ground coffee beans to produce a more diluted coffee beverage with a greater than expected mass. If the calculated regression value is below a lower bound, a negative grinding gradient flag may be raised by the Coffee Preparation System Controller 240. The negative grinding gradient flag may indicate less than expected water is passing through the compacted ground coffee beans to produce a more concentrated coffee beverage having a lower than expected mass.

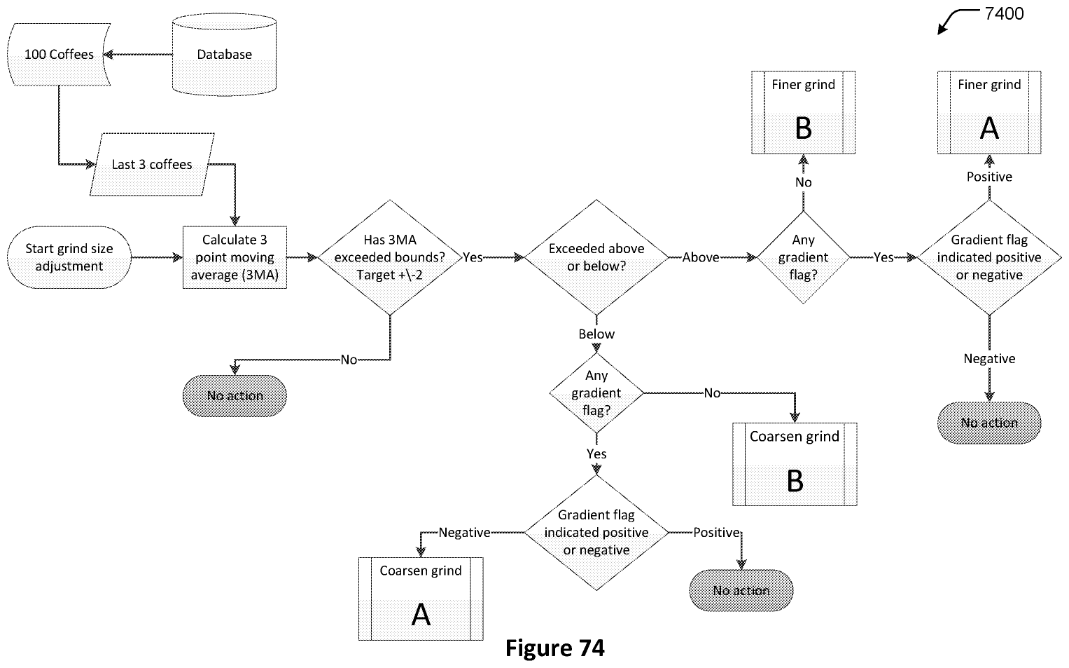

FIG. 74 illustrates another grind control flow chart 7400 according to which coarseness or finesses of grinding by the grinding station 203 may be manipulated or calibrated. If a positive grinding gradient flag is raised by the Coffee Preparation System Controller 240, then in response the Coffee Preparation System Controller 240 through the Actuator Microcontroller 4700 may calibrate grind adjustment stepper motor of the grinding station 203 to increase fineness of ground coffee beans. Increasing the fineness of ground coffee may reduce the amount of water passing through the compacted ground coffee beans and may bring the concentration or strength of the prepared coffee beverage back to an optimum level.

If a negative grinding gradient flag is raised by the Coffee Preparation System Controller 240, then in response the Coffee Preparation System Controller 240 through the Actuator Microcontroller 4700 may calibrate the grinding station 203 to decrease fineness of ground coffee beans. Decreasing the fineness of ground coffee may increase the amount of water passing through the compacted ground coffee beans and may bring the concentration or strength of the prepared coffee beverage back to an optimum level.

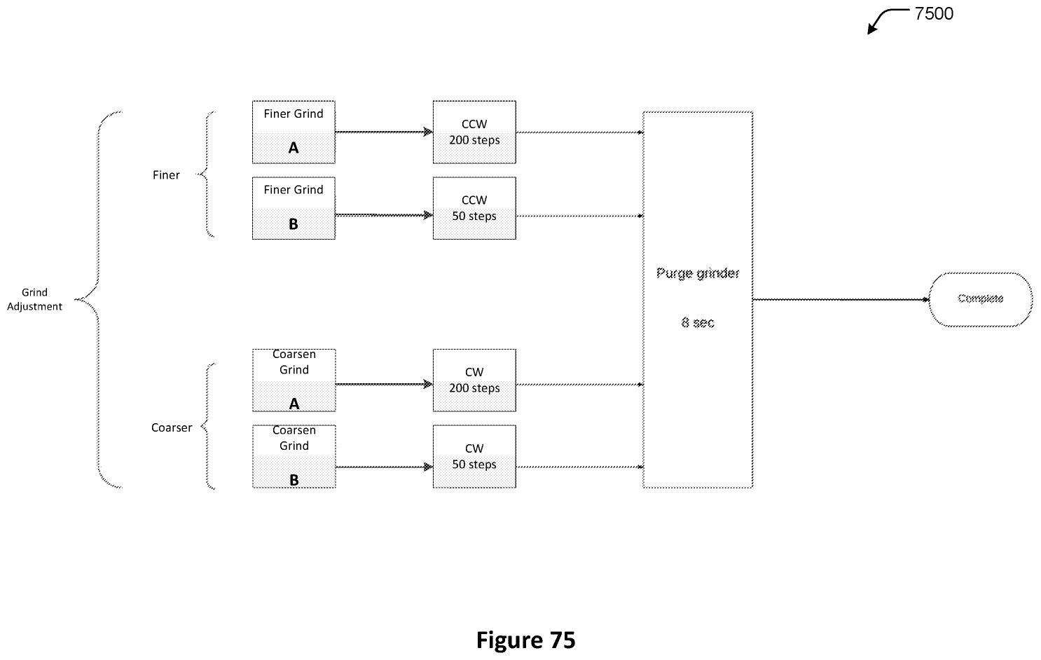

FIG. 75 illustrates a flowchart 7500 showing the flow of manipulation or calibration of the grinding station 203 according to some embodiments. The grind adjustment stepper motor of the grinding station 203 may be instructed by the Coffee Preparation System Controller 240 to rotate the coarseness control of the grinding station 203 by 50 or 200 steps in either direction, for example. For example, if a finer grind is required, then a first fineness adjustment can be made (e.g. rotate the stepper motor counter-clockwise 50 steps) or a second, larger, fineness adjustment can be made (e.g. rotate the stepper motor counter-clockwise 200 steps). In another example, if a coarser grind is required, then a first coarseness adjustment can be made (e.g. rotate the stepper motor clockwise 50 steps) or a second, larger, coarseness adjustment can be made (e.g. rotate the stepper motor clockwise 200 steps).

A Cleaning and Maintenance Control Module 6927, controls the operation of the cleaning station 207. A Dose Control Module 6925, controls the operation of the Dose Control Station or Doser 208. A Delivery Control Module 6923, controls the operation of the Delivery Terminal 207. A Sweetener Dispensing Control Module 6921, controls the operation of the Sugar Dispensing Station 205. A Foaming Control Module 6919, controls the operation of the Milk Foaming Station 204. A Compactor or Taming Control Module 6917, controls the operation of the Tamping Station 206.

FIG. 82 is a block diagram illustrating automated beverage preparation based on a location of a client device, such as a smartphone. In some embodiments, an automated or remote order may be placed for a beverage. The automated or remote order may be based on a fixed schedule or the occurrence of a trigger event. The trigger event may include the transgression of a client device 8210 into a defined or pre-determined geo-fenced area. In some embodiments, an order may be placed remotely through a client device to a particular coffee preparation system 110 at a specific location based on a pre-determined schedule.

In FIG. 82, block diagram 8200 shows the coffee preparation system 110 in communication with a geo-fence and ordering server 8220 and the client device 8210. In some embodiments, the functionality of the geo-fence and ordering server 8220 may be partly or fully provided by the coffee preparation array configuration server 120 or the web server 130 or both. In this context, the geofence acts as a virtual geographic boundary that enable software executing on the server 8220 to trigger an order response when a previously configured client device 8210 enters or leaves a particular area.

The client device 8210 may comprise a smartphone or a handheld computing device comprising a processor, memory, a location tracker 8212 and other components necessary for the operation of the various functions of the client device 8210. The location tracker 8212 may comprise multiple communication radios, such as a GPS component, a cellular network component, a wifi components, a Bluetooth component, for example. The location tracker 8212 provides geo-location functions.

The various components of the location tracker 8212 individually or in combination determine the location of the client device 8210. The determined location and other relevant information may be transmitted to the geo-fence server 8220 over a communications network 8230. The client device 8210 further comprises a special-purpose software application 8214 executing on the client device 8210 that is capable of facilitating automated or remote ordering to initiate coffee preparation. Further functions of the application 8214 may include management of geo-fence boundary data 8212 and user preference data 8218, including payment data and any other relevant functionality. The geo-fence data 8212, and user preference data 8218 from multiple client devices may also be backed up on the geo-fence server 8220 in the geo-fence data backup 8222 and user preference data backup 8224 data stores on the geo-fence server 8220.

The geo-fence server 8220 may communicate with an automated coffee preparation system 110 over the communication network 8230 in the coffee preparation system array to intermediate communication originating from client device 8210. The geo-fence server 8220 may also store the location of each of the coffee preparation systems 110 and provide the stored location information to client device 8210, for example through application 8214. Based on a list or mapped display of available coffee preparation systems 110 in a certain geographic area, a user may define a geo-fence. For example, a user may select a coffee preparation system 110 and define a geo-fence boundary in the form of circle with a radius of 500 m or 1 km around the coffee preparation system 110, for example. The geo-fence may also be in the form of a polygon drawn around a particular coffee preparation system 110. The user defined geo-fence data may be backed up in the geo-fence data backup 8222 data store on the geo-fence server 8220.

The user preference configuration data 8218 includes saved preferences of users which may include whether the user a client device 8210 should automatically place an order to a particular automated coffee preparation system 110 upon entry into a geo-fenced area. The user preference configuration data 8218 may include coffee preparation preferences, such as the type or style of coffee to be made, whether milk should be added and if so, which kind of milk, whether sugar or other sweetener should be added, how many espresso shots should be included, etc. Additionally, the user preference configuration data 8218 may specify that more than one coffee is to be prepared in the same user order.

In some embodiments, the user preference configuration data 8218 may include time of the day or day of the week preferences to automatically place an order to a particular automated coffee preparation system 110. For example, a user through the application 8214 executing on his or her client device 8210 may define a preference for placing an automated order every Monday, Tuesday and Friday if the user's client device passes through a defined geo-fence between the periods of 7 am to 10 am. In some embodiments, a user's automated order may be scheduled and not necessarily driven by transgression into a geo-fenced area. For example, a user may have a saved preference for delivery of a prepared specific beverage, every 9 am on a weekday. The user preference configuration data module 8218 may also store payment credentials to enable payment for the coffee order to be effected through a nominated user account.

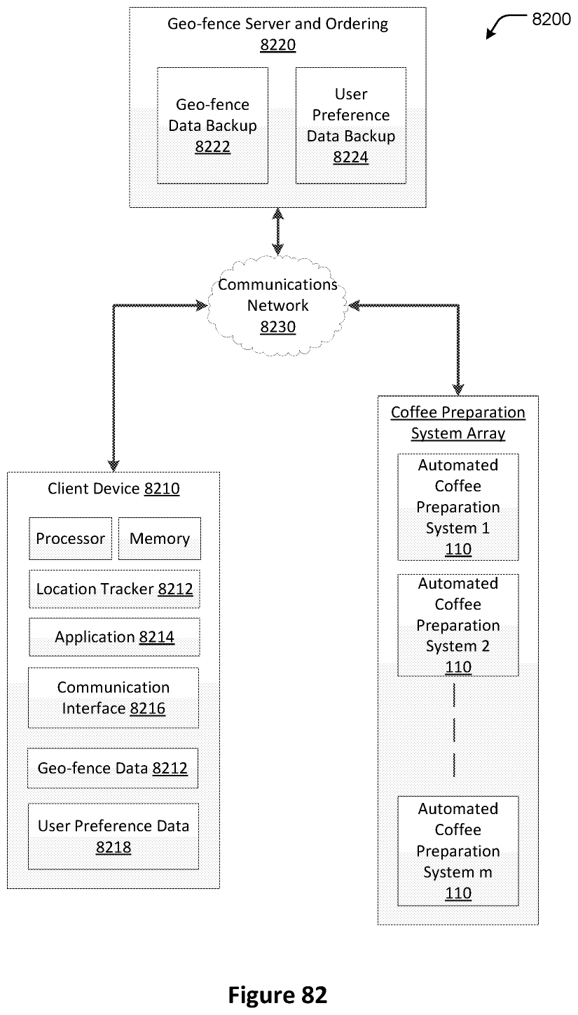

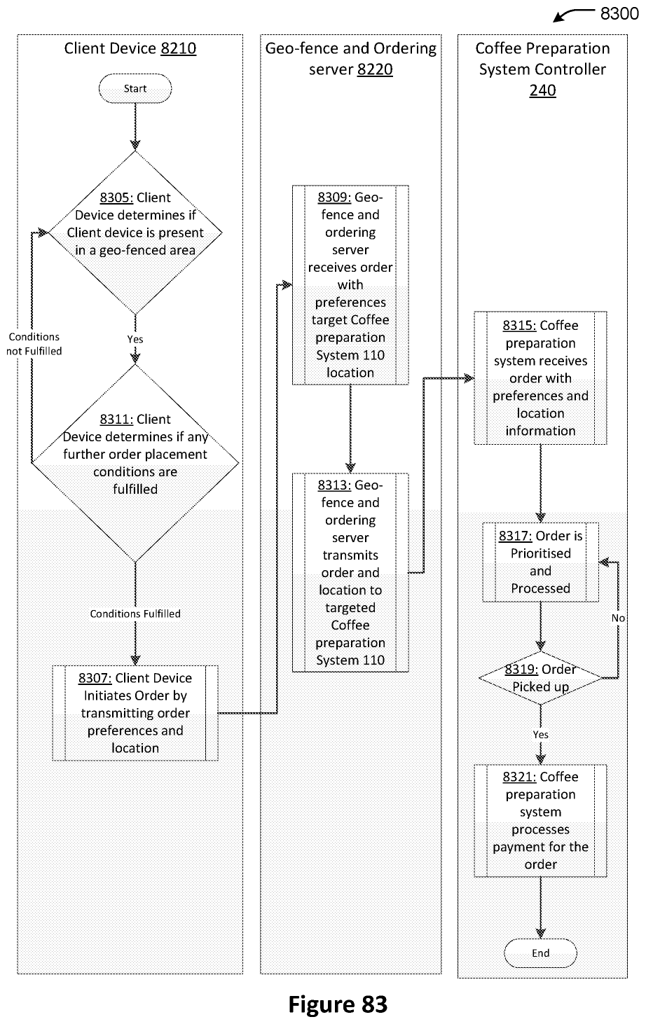

In FIG. 83, flowchart 8300 illustrates the process of placement of an automatic order by the client device 8210 and the subsequent interaction with the geo-fence server and the coffee preparation system controller 240 within the automated coffee preparation system 110, according to some embodiments. Before the execution of the process, the client device 8210 will have received and stored geo-fence data 8212 and user preference data 8218. The user preference data 8218 may also include stored payment credentials accessible to the geo-fence server 8220. At step 8305, the client device 8210, based on its location and stored geo-fence data 8212, determines if the client device 8210 has entered into the pre-defined geo-fenced area. At step 8311, the client device may check further conditions, such as whether the user has placed any day-of-the-week or time-of-the-day limitations on the placement of an automated order. If the conditions are deemed to be fulfilled, then control may be passed to step 8307, wherein an automated or remote order is initiated by transmitting the user preference information to the geo-fence server 8220. The user preference information may include the details of the preferred beverage, for example, a café latte with skimmed milk and no sugar.

At step 8309, the geo-fence server 8220 receives the user preference information including the beverage preference, client device location information, the location or identity of the coffee preparation system 110 to be targeted for the particular order. At step 8313, the geo-fence server 8220 transmits the automated order to the targeted coffee preparation system 110. The geo-fence server 8220 may also transmit payment credentials of the user to be charged after the preparation of the automated order. The coffee preparation system controller 240 of the targeted coffee preparation system 110 receives the automated or remote order at step 8315.

In some embodiments, the coffee preparation system controller 240 may receive the location of the client device 8210. In some embodiments, the coffee preparation system controller 240 may receive intermittent updates of the client device's location. The available location information may be used by the coffee preparation system controller 240 to prioritise or queue orders at step 8317. For example, an order originating from a client device that is currently 50m away from the coffee preparation system may be prioritised above an order originating from a client device that is currently 150m away. As updated location information is made available to the coffee preparation system controller 240, automated coffee preparation orders for which preparation has not yet commenced may be reordered or re-prioritised based on the updated location information.

After the preparation of a beverage associated with an order, the coffee preparation system 110 may store the prepared beverage until the client device is in a close proximity of the coffee preparation system 110. The prepared beverage is made available to be picked up by the user from one of the delivery portals or stations 10240. The particular delivery portal or station 10240 that the pre-ordered coffee is located in (and can be manually retrieved from) may be notified to the user via the output display 10210 or via the application 8214 on the client device 8210, for example. The controller monitors retrieval of the prepared coffee beverage from the designated delivery portal using image capture of the interior of the delivery portal. In some embodiments, the monitoring may be achieved by the light curtains 5300. In some embodiments, the monitoring may be achieved by a proximity or position sensor mounted within the delivery portal. In some embodiments, the monitoring may be achieved with a small camera disposed in a top interior section of each delivery portal. After a prepared beverage is picked up from the delivery stations 10240, the coffee preparation system controller 240 may charge the payment credentials of the user for a relevant charge associated with the automated order at step 8321.

In some embodiments, the coffee preparation system controller 240 may vary the price of a beverage according to a period of idleness of the automated coffee preparation system 110. During operation of the automated coffee preparation system, if no automated orders or remote orders or orders through the ordering interface terminal 4301 are received for a first predetermined period of time, for example for 5 minutes or 10 minutes; then the coffee preparation system controller 240 may reduce a normal set price of one or more available beverages. The reduction in price may be a predetermined monetary value, for example, 10 cents or 20 cents, or may be a percentage of the normal price, such as 2%, 3%, 4%, 5%, 6%, 7%, 8%, 9% or 10%, for example. The reduced price of beverages may be displayed on the delivery terminal 217 or made available to the user's client device 8210 through the application 8214.

Multiple iterations of incremental reduction in advertised price of beverages may occur, if the coffee preparation system remains in an idling state over multiple predetermined periods of time. For example, if no orders are received for a first time period, such as 5 minutes, the advertised price for a beverage may be reduced by a first predetermined amount, such as from $4.00 to $3.90. If no orders are received again over the second (subsequent) time period, such as 5 minutes, then the advertised price for a beverage may be further reduced by a second predetermined amount, such as from $3.90 to $3.80. This reduction in price may be repeated until a defined minimum price level is reached. For example, coffee preparation system controller 240 may be configured to reduce the advertised price of beverages to no lower than $3.00.

If after a reduction in advertised price, an order is received either locally through the ordering interface or remotely from a client device 8210, the coffee preparation system controller 240 may incrementally increase the advertised price of beverages back to the normal set price values. In some embodiments, coffee preparation system controller 240, after receiving an order after a reduction in advertised price, may instantaneously increase the advertised price of subsequently ordered beverages back to the original price values.

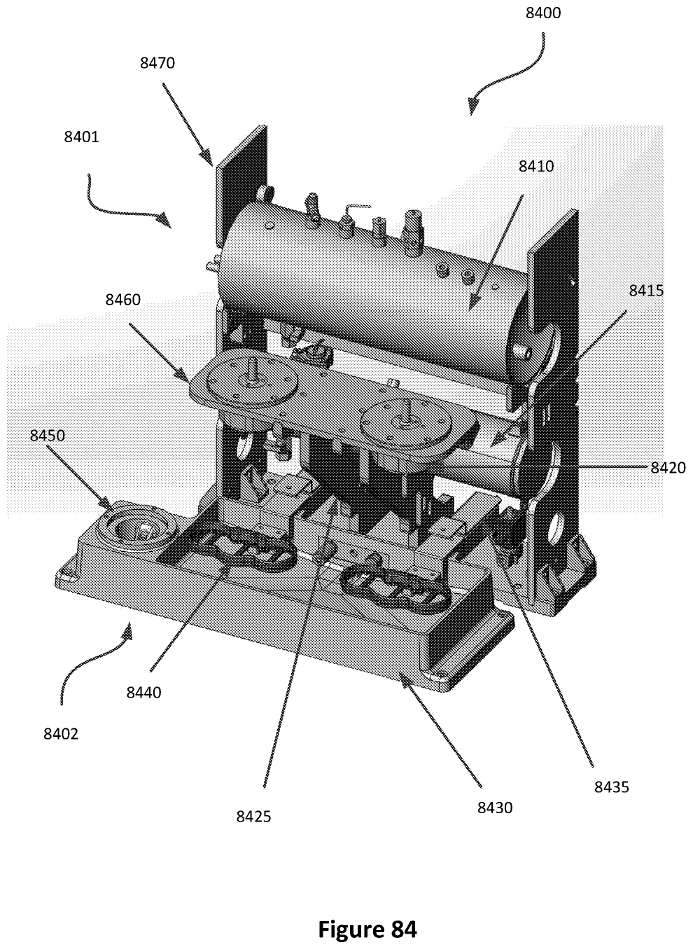

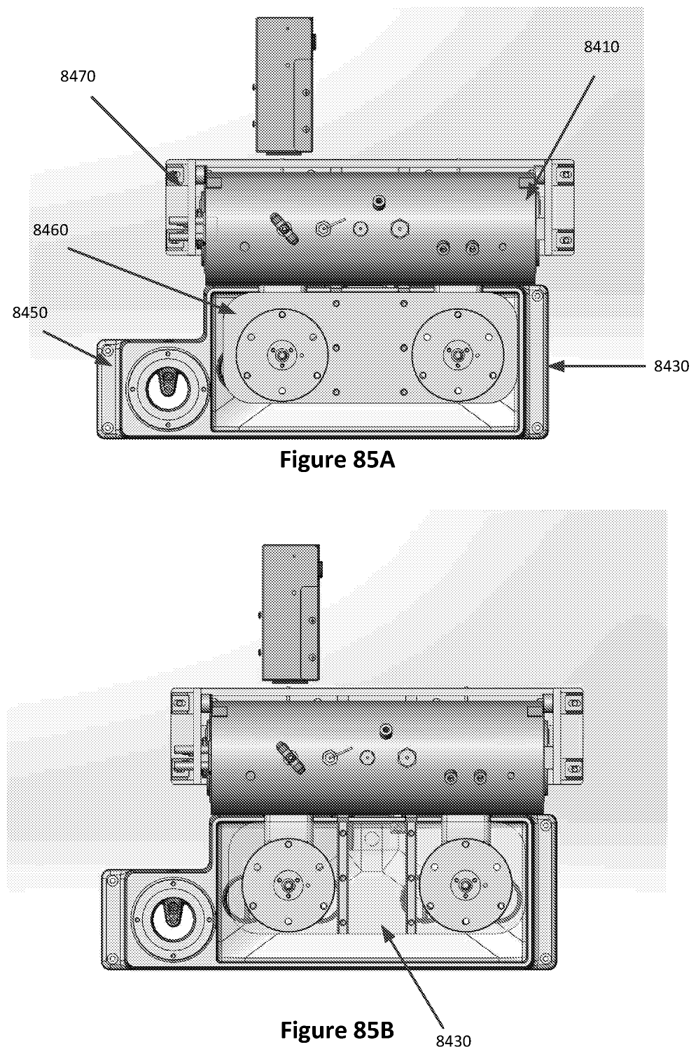

FIG. 84 depicts an alternative embodiment of a beverage brewing station 8400, which may include at least one group machine 8401 and a drip tray 8402 with integrated cleaning station 8450.

The group machine 8401 may comprise a commercially available café grade coffee brewing machine, suitable for brewing of espresso coffee, consisting of one or more points of engagement for group handles 8930. In some embodiments, the brewing machine, which can also be described as an espresso machine, comprises one or more group heads 8420 for delivery of brewed coffee, a steam boiler 8410, and brew boiler 8415. The boilers 8410, 8415, may be horizontally oriented arranged in a vertical stack along a boiler frame 8470 which is affixed to the cabinet separator surface 310. The vertical arrangement may provide greater cabinet space within the coffee preparation system 110, and improved clearance for a robotic brewing arm 9100. In some embodiments, a single boiler may be provided for coffee preparation, and arranged to provide hot or superheated water for the brewing process and the cleaning process.

In one embodiment, the brewing station 8400 may be a modified La Mariocca™ Linea Classic Two Group Machine for example, which is understood as a machine that has demonstrated strong performance in the above areas, and modified by removing the machine housing and reorganising the boilers 8410, 8415, into a vertical configuration. In other embodiments, other espresso coffee brewing machines may be modified to suit the overall system requirements.

In some embodiments, the group heads 8420 are reinforced on their interfacing surface, on a group head frame 8460, supported by group head struts 8425. This reinforcement may provide additional support and durability to the group heads, increasing structural longevity of the group heads 8420 when acted upon by a robotic brewing arm, such as arm 9100. The reinforcement may also provide greater positional accuracy for robotic arms, providing a wider engagement area to group handles 8930.

The drip tray 8402 may comprise a drip tray body 8430, at least one cup platform 8440, and an integrated cleaning station 8450. In some embodiments, drip tray load cells 8435 may be integrated beneath the drip tray struts to weigh the contents of a receptacle placed on a cup platform 8440. Spillage from the drip tray may be collected in a reservoir within the drip tray itself for emptying during service, or be drained into the lower waste vat 3300.

The cup platforms may 8440 be designed to receive one cup in a central position under a group head 8420, where the group head 8420 provides a double dose of espresso coffee from a group handle 8930. The cup platforms 8440 may be further designed to receive two cups disposed either side of the platform, under a group head 8420, to each receive a single dose of espresso coffee from a group handle 8930. Alternatively, a single cup may be disposed to one side of the platform under a group head 8420, to receive a single dose of expresso coffee from a group handle 8930, where a second dose from a group handle is delivered as waste into the drip tray.

The integrated cleaning station 8450 may comprise a filter basket engagement ring 8451, a chamber, a drainage channel 8453 disposed at a lower end of the chamber, and a cleaning fluid supply nozzle 8452. The filter basket engagement ring 8451 allows a filter basket 9010 to sealably engage with the cleaning station 8450. This sealing engagement can assist in preventing the basket from being accidentally dislodged during the cleaning process and minimising the risk of cleaning liquid or waste being discharged into the upper cabinet. Further, the engagement of the filter basket with the cleaning station 8450 allows the robotic arm 9110 to leave the filter basket 9010 at the cleaning station 8450 during the cleaning and can perform other coffee preparation-related tasks while the cleaning is occurring.

The cleaning fluid supply nozzle 8452 directs pressurised cleaning fluid, such as hot water, into the filter basket 9010 to dislodge spent grounds, to be directed through the drainage channel 8453. When a filter basket 9010 is engaged with the engagement structure in an inverted orientation over the top opening, water from the water jet nozzle and air from the air jet outlet can impinge on an inside of the filter basket to clean the inside of the filter basket.

Nozzle 8452 may be centrally positioned in the chamber and directed upwardly, having a nozzle configuration that projects a conical water jet toward the inverted filter basket. In some embodiments, the cleaning fluid provided by the cleaning supply nozzle 8452 may be heated water, heated air, or a combination of both. In some embodiments, two separate cleaning fluid supply nozzles are provided for separate heated air and heated water streams. The pressurised hot water or air is received from a separately located source of hot water (such as the boiler of the group machine 8401) or pressurised air in the housing. In some embodiments, a separate pressurised air outlet is disposed in a wall of the cleaning station that defines the chamber. The air jet may be used to blow away some residual water from the filter basket following the initial application of the water jet, although only a brief projection of the air is effected by the controller, to avoid cooling the filter basket too much.

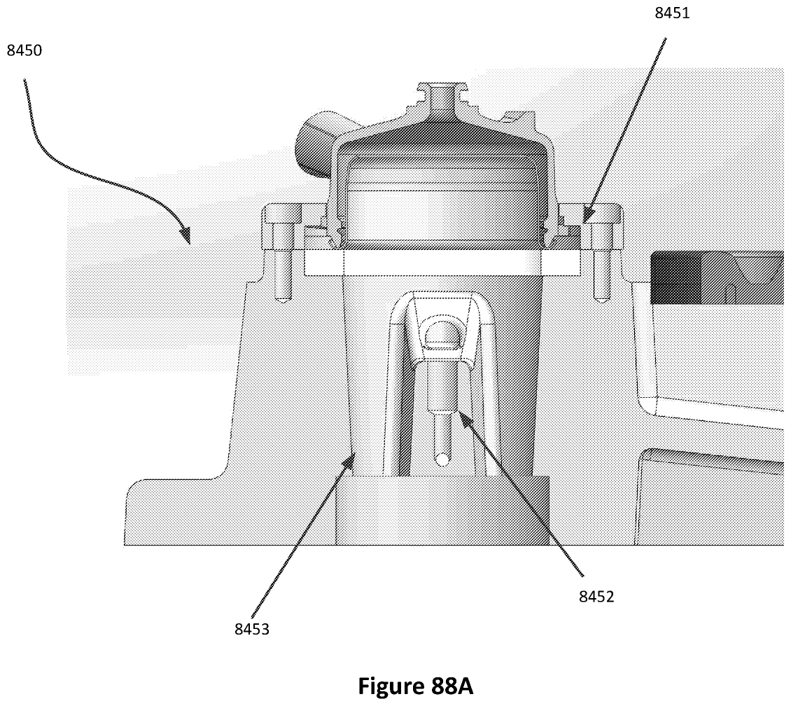

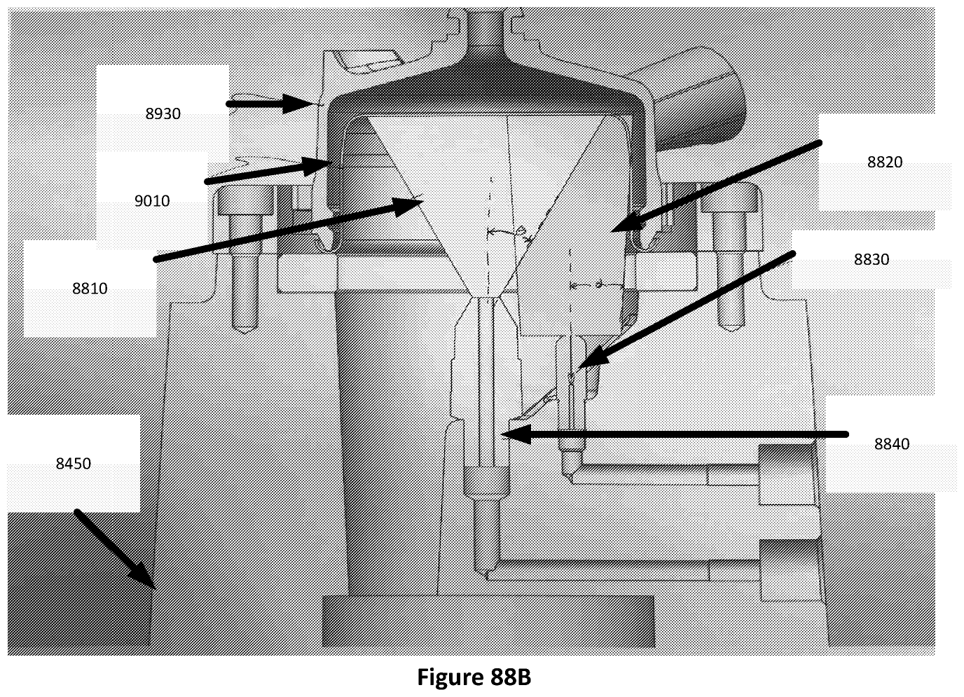

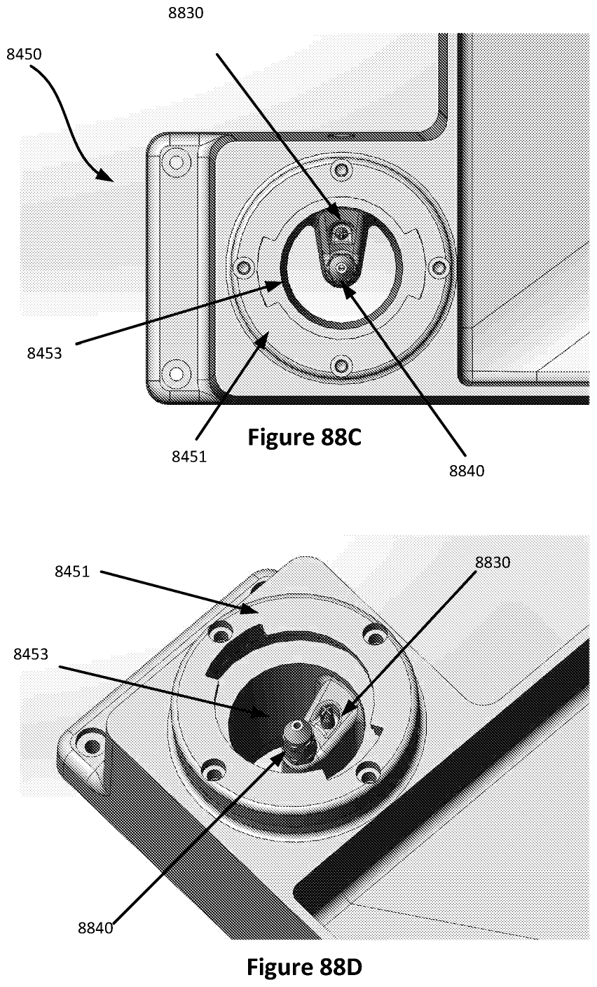

FIG. 88B depicts one embodiment of the integrated cleaning station 8450, having a water supply nozzle 8840, and an air supply nozzle 8830 positioned within the chamber and pictured with a water spray area 8810, an air spray area 8820. Water may be supplied at sufficient pressure to dislodge compacted coffee grounds after brewing, and air may be supplied at sufficient pressure to circulate around the entirety of the filter basket, so that the entire area of the inside of the filter basket is dry or mostly dry after a cleaning process. The hot water is heated to be sufficiently hot that the filter basket and surrounding metal of the handle are heated to a degree that any remaining water from the pressurised water source will quickly vaporise after the air is applied.

FIGS. 88C and 88D depict the embodiment of 88B where the water supply nozzle 8840 and air supply nozzle 8830 are positioned within the chamber 8453. The basket engagement ring 8451 is depicted with slots to receive the engaging portions of a group handle filter basket 9010.

In some embodiments, heated water may be provided from the steam boiler 8410 of the group machine 8401. The steam boiler 8410 may be super-heated under about 1.5 to 2 bar of pressure so that water within is between about 100 degrees C. and about 125 degrees C., optionally around 110 to around 120 degrees C. The steam boiler is operated to maintain a volume of its storage tank not filled with water, to allow for super heating the water under pressure.

In these embodiments, during cleaning at the cleaning station, heated fluid may also heat the filter basket 9010 to keep the basket at a high minimum temperature, in order to minimise heat loss into the filter basket 9010 when engaged under a group head 8420 when a brewing process is underway. As the group handle 8930 may be constructed from stainless steel, this metal may act as a heat sink, drawing heat from the brewing process that would otherwise be absorbed by the coffee grounds. Maintaining a high minimum temperature (e.g. 50 to 70 degrees C.) of the group handle 8930 throughout the grinding and brewing process aids in providing a consistent brew and higher quality coffee, when compared with an unheated filter basket and group handle body.

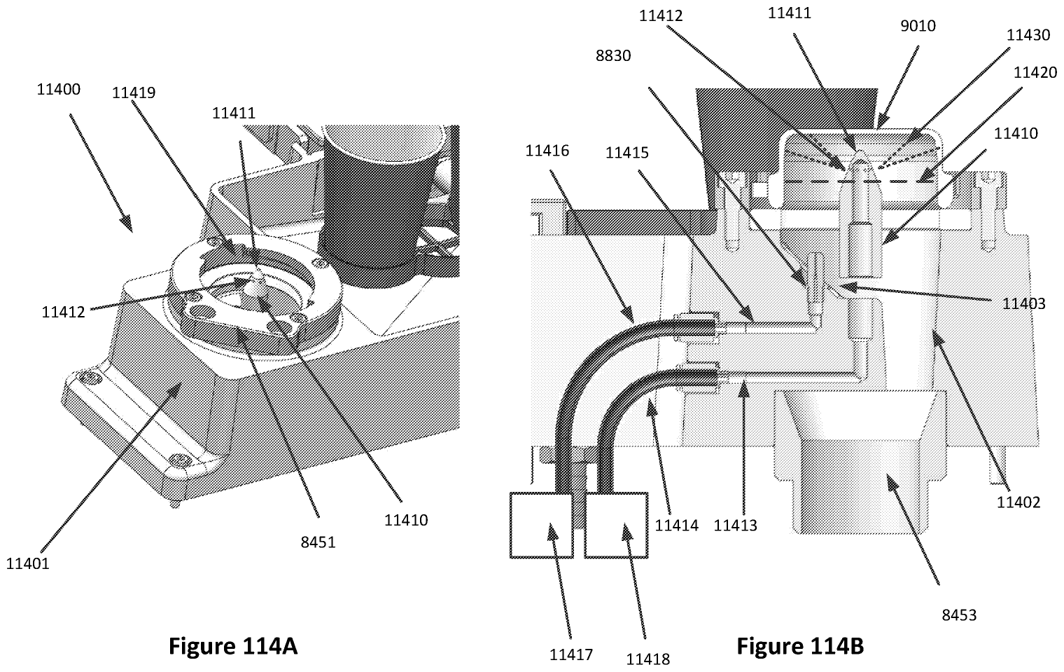

FIGS. 114A and 114B depict an alternative embodiment of the integrated cleaning station 11400, having a water supply nozzle 11410 with a higher vertical position, placing the top of the water supply nozzle 11410 within the cavity of the filter basket 9010 when performing a cleaning operation. In this embodiment, the tip of the water supply nozzle extends into a coffee grounds puck 11420 in a cleaning operation, when the filter basket 9010 is engaged. This arrangement can more effectively dislodge coffee grounds, by providing a penetrating force using the nozzle tip to break the puck and creating a circulating effect as the water spreads up and around the filter basket through the puck at the water nozzle spray angle 11430. The water supply nozzle 11410 may include cross drilled ports, allowing water to be directed at the upper corners of the filter basket 9010, reducing water retention.

The water supply nozzle 11410 comprises a tip portion 11411, the tip portion being tapered to a narrow diameter at its end. The tip portion 11411 further comprises a series of water supply apertures 11412, formed around a circumference of the water supply nozzle 11410. The water supply apertures 11412 direct water into where grounds may be present in a filter basket 9010 from the water supply channel 11413. The water supply channel 11413 defines a fluid path within the cleaning station body 11401 which receives pressurised water through a water supply line 11414 from a water supply reservoir 11418.

In FIGS. 114A and 114B, the air supply nozzle 8830 may be installed in a cleaning supply fixture 11403, and direct a stream of air into the engaged filter basket 9010 during a cleaning operation. The air stream may assist in dislodging remaining waste coffee grounds and drying the filter basket 9010 after a cleaning operation. The air supply nozzle 8830 may be fed a stream of pressurized air from an air supply line 11416. The air supply line supplies air into an air supply channel 11415 defined within the cleaning station body 11401. The air supply line 11416 supplies pressurized air into the air supply nozzle 8830 from the air supply reservoir 11417.

FIG. 114A further depicts an engagement ring 8451 having a group handle engagement channel 11419. The group handle engagement 11419 comprises a recessed channel in the engagement ring 8451, with slots provided to allow the engaging lugs of a group handle 8930 to fall within the inner diameter of the engagement ring 8451 and then, with a rotation of the group handle 8930, to be locked in place during a cleaning operation.

Waste from the integrated cleaning station may be collected in a reservoir within the drip tray itself for emptying during service, or be washed down through the unit and the cabinet separator, and routed to the top of the grind separation unit 3100 via tubing.

FIG. 89 depicts a group handle staging rack 8900, which may comprise a tool holding arm 8910, connected to a staging rack base 8920 by a vertical bar section.

The tool holding arm 8910 may provide at least one tool holder 8915 for a group handle portable filter 8930. In some embodiments, four radially projecting spaced supports are provided for group handles. Group handles 8930 may be provided with a series of supporting prongs 8935, arranged at a number of positions around the circumference of the group handle interface 8940. The supporting prongs 8935 may be provided to sit atop the tool supports 8915 on the tool holding arm 8910, thereby staging the group handles 8930 in a vertical position. The vertical positioning of group handles 8930 may allow faster connection of a robotic arm 9100.

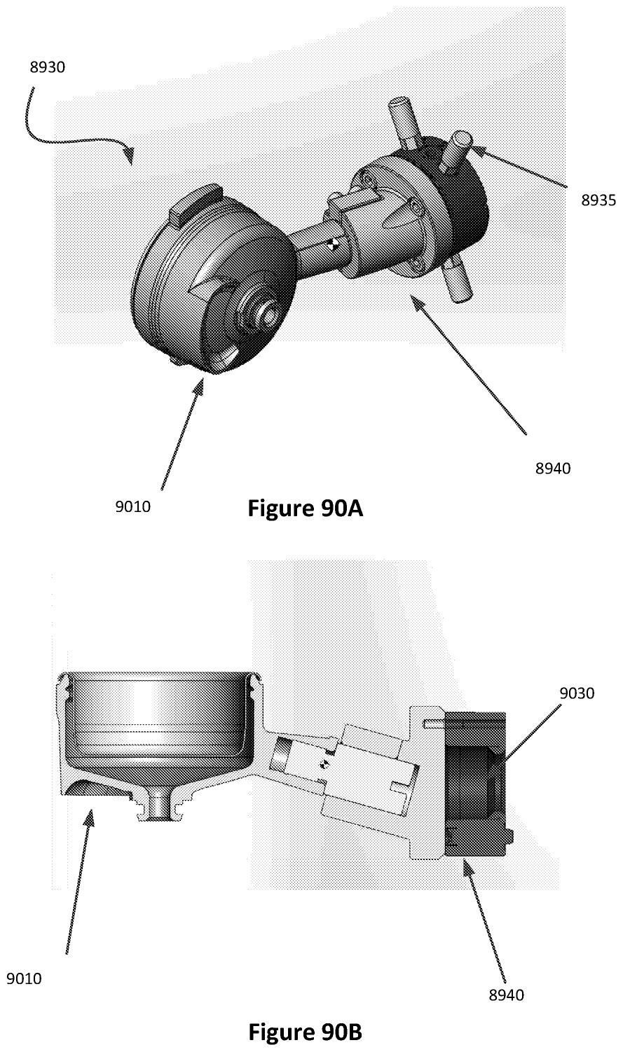

FIG. 90 depicts an embodiment of a group handle portable filter 8930, comprising a filter basket 9010, connected to group handle interface 8940, the group handle interface 8940 having a robotic arm engagement 9030.

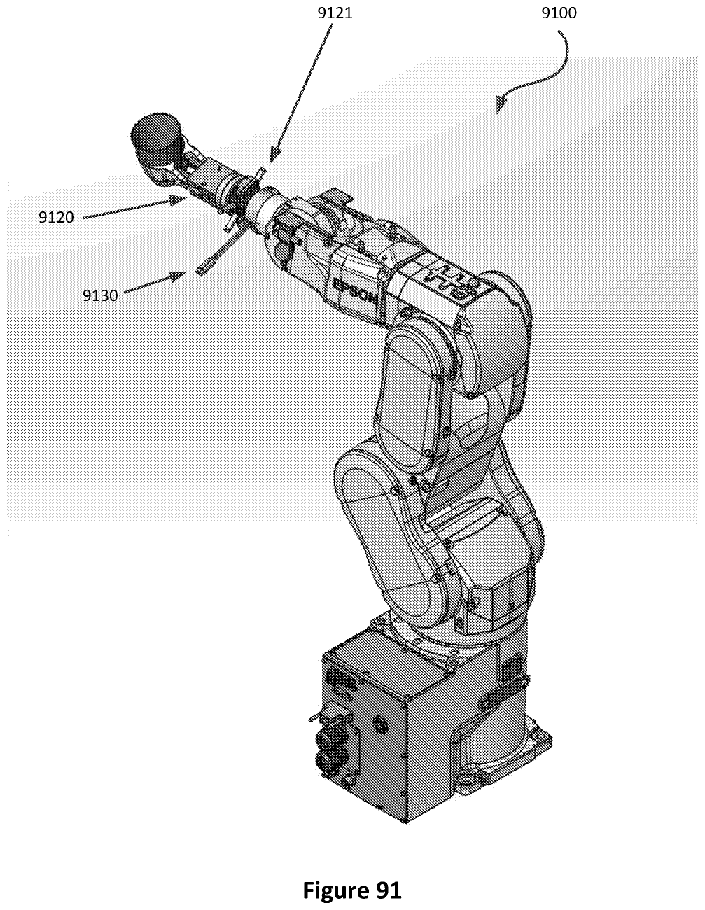

FIG. 91 depicts a robotic arm 9100 configured with a robotic engagement end, interfacing with a cup gripper 9120. The robotic arm 9100 may be provided with a cable section 9130. In some embodiments, the cable section 9130 may provide a pneumatic air supply for use by pneumatically powered tool ends. Other cable section 9130 embodiments may provide electricity or water, depending on tool end requirements.

In some embodiments, the robotic arm 9100 may be an Epson Model C8-A701SB™ for example, with 6 independent axes and a maximum payload of 8 kg.

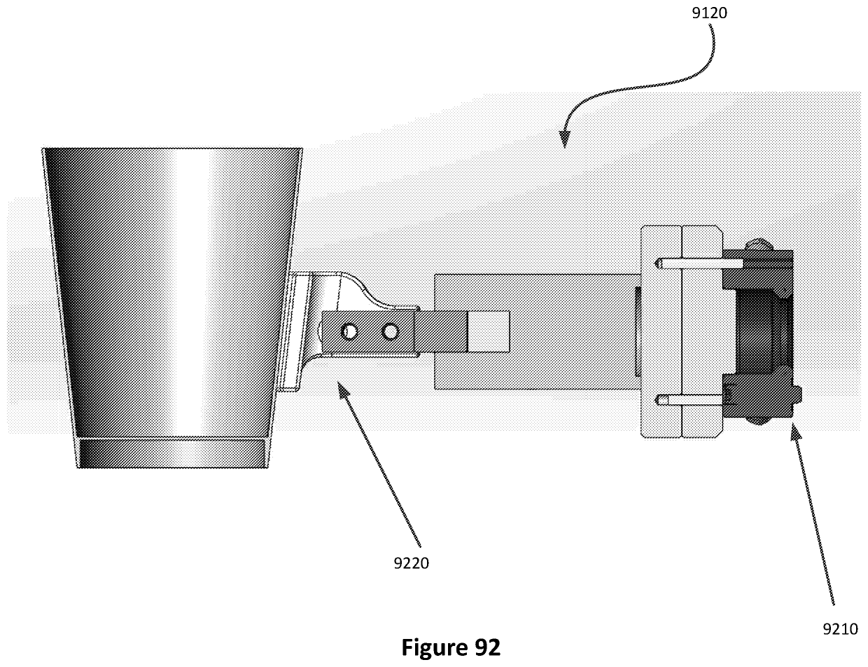

FIG. 92 depicts a cup gripper assembly 9120 comprising a robotic arm interface 9210 and a cup gripper end 9220. The cup gripper assembly 9120 may be interchanged by a robotic arm with other tools, such as group handles 8930, depending on order scheduling requirements. In such embodiments, the cup gripper end 9220 may be a fixed position gripper, being sufficiently flexible not to damage cups, while retaining rigidity to grip the cups via friction. The cup gripper end 9220 may comprise a pair of gripper arms attached to the assembly body by mounting struts of configurable distance. Narrower or broader distances may be used to accommodate cups of different sizes.

In some embodiments, the cup gripper assembly 9120 is fixed at the end of a robotic arm, and provided with a pneumatic supply through the cable section 9130. In such embodiments, the cup gripper may be have open and closed positions, enabling gripping of cups by the pneumatic actuation between these positions. In some embodiments, a pneumatic port is provided within the robotic arm interface 9210 to allow for a pneumatic cup gripper to be detachable from the robotic arm without cabling extending into the gripper assembly 9120 itself—the robotic arm interface 9210 providing a sufficiently airtight seal with the cup gripper assembly 9120 to eliminate pneumatic leaks.

The cup gripper assembly 9120 may comprise cup gripper supporting prongs 9121, allowing the cup gripper assembly 9120 to be hung and stored on a tool rack, such as a group handle staging rack 8900 or other rack.

In some embodiments, the cup gripper assembly 9120 comprises a two jaw angular gripper, such as an SMC Model MHC2-25D that is pneumatically operated with open and closed positions. This gripper assembly may be modified with a cup gripper attachment, featuring cup detection sensors 10810. The sensors 10810 may indicate the presence or lack of presence of a cup within the gripper, allowing the system to correct cup gripping errors where cups have been gripped incorrectly. In other embodiments, the cup detection sensor 10810 may detect misalignment of cups within the cup gripper assembly 9120, or errors where too many or too few cups have been gripped.

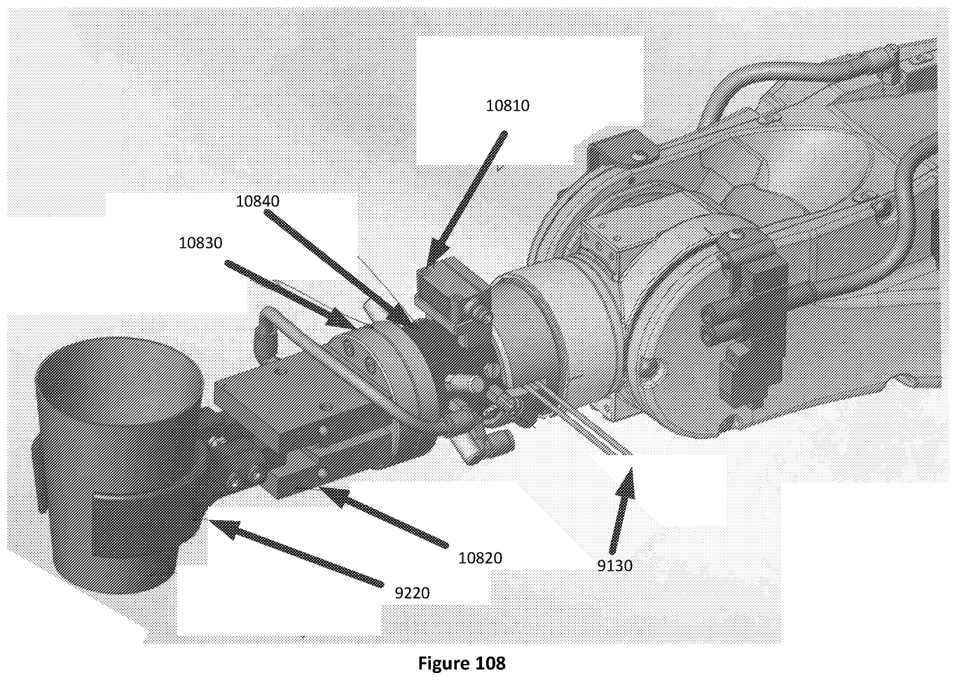

FIG. 108 depicts the system of 9100, where the cup gripper assembly 9120 is connected to a robotic arm by a robotic arm interface 9210. In such an embodiment, the arm interfaces with the gripper assembly 9120 by way of the tool changer 10840, designed to interface with the robotic arm engagement 9030. The cup gripper assembly 9120 comprises a jaw gripper 10820 affixed on adapter plates 10830. The jaw gripper is modified with the inclusion of the cup gripper end 9220, comprising a pair of machined or 3D printed cup jaws, arranged to receive a tapering angled cylindrical cup. In some embodiments, the cup gripper end 9220 may comprise different profiles to accommodate cups of different shapes and sizes.

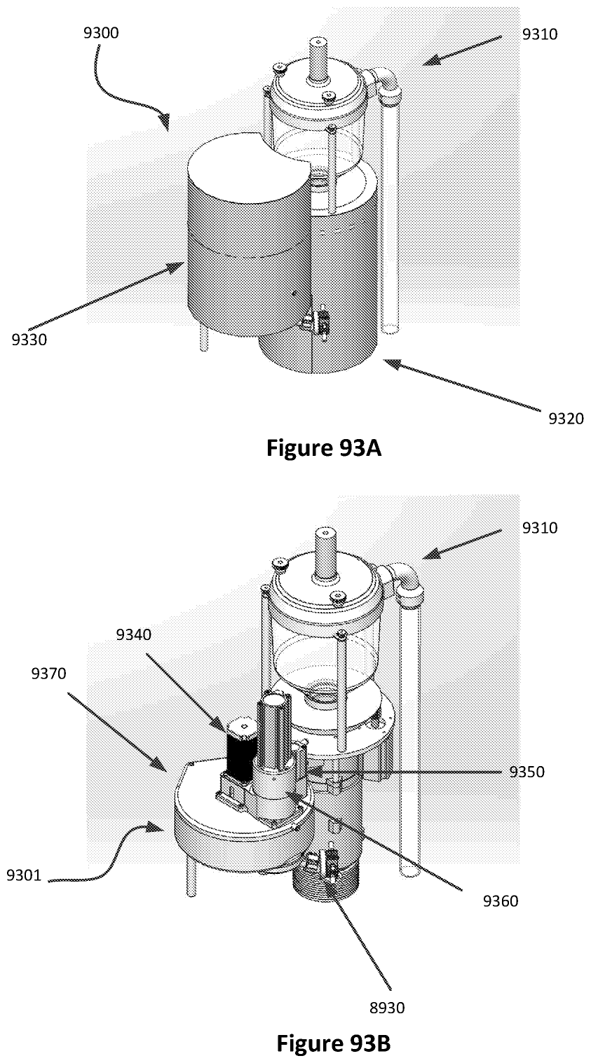

FIG. 93 depicts a combined grinding and compacting station 9300, being interfaced with a grinder 9310. In some embodiments, a Mazzer Robur™ coffee grinder modified for electronic control may be used as a grinder 9310. The grinding and compacting station may comprise a grinder housing 9320 and compacting housing 9330. The combined grinding and compacting station 9300 comprises a housing 9330 and an internal grinding and compacting assembly 9301.

The internal grinding and compacting assembly 9301 comprises a fixed casing 9370, inner rotatable dose wheel 9570, compacting piston assembly 9360, fine adjustment assembly 9350, coffee inlet assembly 9540, position detector 9525, and assembly support 9510. The compacting assembly 9301 may be arranged to compact coffee grounds received from the dose wheel 9570 into a filter basket, wherein the compactor is configured to apply a compacting force between about 100 N and about 700 N to compact coffee grounds in the filter basket. The compacting force may be a value at either end of that range or another value within that range, such as around 200 N, 250 N, 300N, 350 N, 400 N, 450 N, 500 N, 550 N, 600 N or 650 N, for example.

In a grinding and compacting operation, the grinder 9310 delivers a dose of ground coffee of slightly over 22 grams through the coffee inlet assembly 9540 into a dose chamber 9610 within the dose wheel 9570. The grinder 9310 grinds coffee beans for about 3.8 to 4.0 seconds to produce grounds of about (or slightly over) 22 grams in mass, for example. In some embodiments, a greater or smaller amount of grounds may be selected, or the dose may be selected based on longer or shorter grinding times. In some embodiments, the ideal dose size is dependent on the dose requirements to deliver two shots of espresso through a group handle filter basket 9010. The dose wheel 9570 is rotated by a motor 9340 until the chamber 9610 is positioned over an outlet 9755, the outlet 9755 having a compacting engagement ring 9380 to engage a group handle 8930. This rotating movement deposits the ground coffee into the filter basket 9010, which is then compacted by the compacting piston 9560, deployed from the compacting piston assembly 9360 by a driving shaft 9710. An air jet 9740 is provided to blow off coffee grounds from the compacting face of the piston 9740 on its return stroke, and a wiper ring 9730 is provided within the compacting piston assembly 9360 to wipe off coffee grounds adhering to the sides of the piston 9740.

In some embodiments, the compacting piston is configured to deliver a compacting force of between about 100 Newtons to about 600 or 700 Newtons to the grounds within a filter basket 9010. In other embodiments, stronger or weaker forces, such as at least 200 Newtons, at least 300 Newtons, at least 400 Newtons or at least 500 Newtons may be applied, depending on the system configurations and requirements of differing coffee orders. A preferred range for compacting force is between about 300 Newtons and about 600 Newtons.

Fine alignment guides 9810 are provided to ensure an accurate dose wheel 9570 position to avoid damage of or by the compacting piston 9740 when deployed. The guides 9810 define a cylindrical chamber and a chamfered lip 9815. The chamfered lip 9815 allows for the guide piston 10010 to be deployed in misaligned positions within the chamfered lip 9815 area, and the downward force of the guide piston 10010 then forces a correction to the alignment of the dosing wheel 9570 as the piston 10010 slides down the chamfered lip 9815 into the guide chamber 9810.

Position of the dose wheel 9570 is further determined by a position detector 9525. In some embodiments, the position detector 9525 comprises a ball switch sensor, with a ball in contact with the outer cylindrical surface of the dose wheel 9570. In such embodiments, the dose wheel 9570 comprises position marker ridges 9575 along its bottom edge, which trigger the ball switch and identify the location of the dose chambers 9610, providing output signals to the controller 240 to allow it to ensure the dose wheel 9570 is correctly positioned.

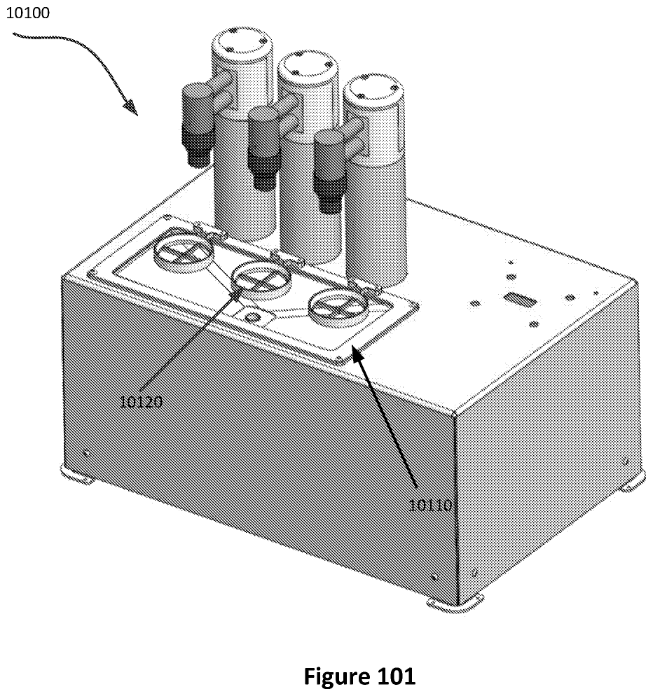

The coffee inlet assembly 9540 comprises a coffee dose inlet 9520 and an inspection window 9530, allowing incoming grounds to be inspected for obstruction and quality control. FIG. 101 depicts a milk foaming station 10010 with a milk drip tray 10110 with at least one milk drip tray cup holder 10120. The cup holders 10120 comprise a chamfered ring structure affixed to the drip tray, the chamfered portions providing some adjustment for misalignment when cups are placed by robotic arm 10520, while also assisting to keep the cups in a substantially fixed position to facilitate their retrieval by a robotic arm 10520, as described herein.

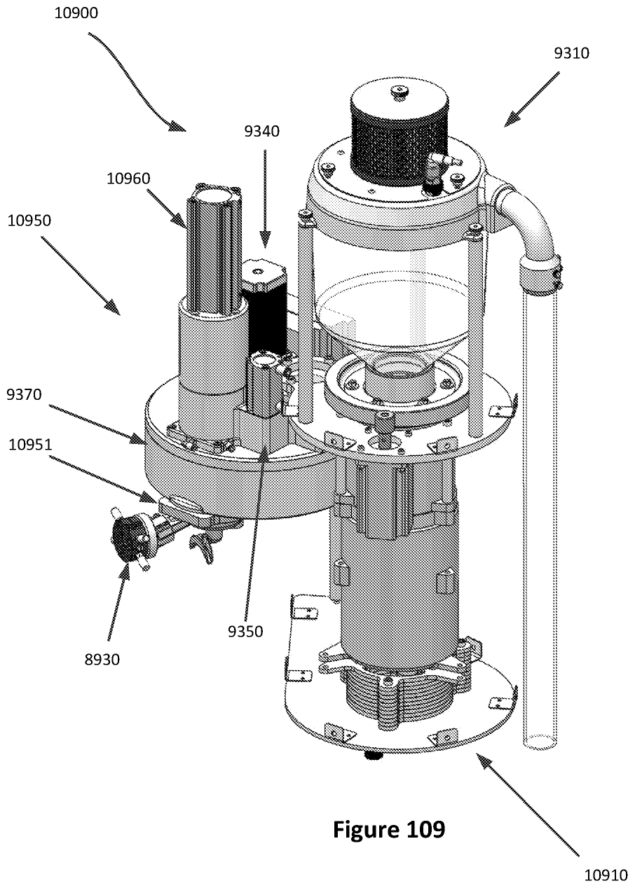

FIG. 109 depicts an alternative embodiment of a combined grinding and dosing station 10900, pictured without grinder housing 9320 and compactor housing 9330. The combined grinding and dosing station 10900 may comprises a grinder 9310, compacting assembly 10950 with a rotatable compacting piston assembly 10960, and a station fixing plate 10910. The grinder 9310 may be similar to other embodiments, wherein the grinder is a Mazzer Robur™ coffee grinder modified for electronic control may be used as a grinder 9310.

The grinder 9310 may be connected to the rotatable compacting assembly 10950 by suitable affixing means to a compacting assembly mounting plate 11030. The compacting assembly mounting plate 11030 may be constructed of stainless steel, plastic, or other suitable materials.

The compacting assembly 10950 comprises a fixed casing 9370, a rotatable compacting piston assembly 10960, at least one stepper driver 11010, a fine adjustment assembly 9350, a motor 9340, a position detector 9525, and coffee inlet assembly 9540. The rotatable compacting assembly 10960 may be arranged to compact coffee grounds received from the dose wheel 9570 into a filter basket, wherein the compactor is configured and controlled to selectively apply a compacting force between about 100 N and about 700 N to compact coffee grounds in the filter basket. The compacting force may be a value at either end of that range or another value within that range, such as around 200 N, 250 N, 300N, 350 N, 400 N, 450 N, 500 N, 550 N, 600 N or 650 N, for example. The rotatable compacting piston assembly 10960 may rotate the compacting piston 11100 as part of the compacting action. The rotational action of the rotatable compacting piston 11100 may more evenly distribute the deposited coffee grounds within a filter basket 9010, and minimize coffee ground waste particles accumulating on the tamping head 11170.

The rotatable compacting piston assembly 10960 comprises a piston housing 11110, piston body 11120, piston head fixing fasteners 11130, tamping body 11140, rotatable tamp ring 11150, tamping head fixing pin 11160, and tamping head 11170. The piston housing 11110 covers the inner piston components within the assembly 10960, and provides a top aperture, allowing a plunger 11310 to vertically move the piston. The piston body 11120 may include a motor portion 11121 which provides the rotational movement of the tamping head 11170. The tamping body 11140 may house the rotatable tamp ring 11150 and be affixed to the piston body 11120 by the piston head fixing fasteners 11130. The piston head fixing fasteners 11130 may comprise screws, bolts, or other suitable means. The rotatable tamp ring 11150 may comprise an outer ring and inner ring portion, housing ball bearings allowing a free rotational movement for the inner ring with respect to the outer ring.

The rotatable tamp ring 11150 may be coupled to the tamping head 11170, allowing rotation of the tamp head with respect to the overall assembly. The tamping head 11170 may be fixed to the axle of the piston body motor portion 11121 by the tamping head fixing pin 1160, through the openings provided in the cylindrical shape of the rotatable tamp ring 11150 and the tamping body 11140. The tamping head 11170 may further comprise a tamping head flange portion 11171 and a tamping head compacting face 11172. The tamping head flange portion 11171 extends out to a wider diameter, providing a minimal clearance of the walls of a dose chamber 9610 to wipe down ground coffee particles which may otherwise adhere to dose chamber walls. The diameter of the tamping head flange portion 11171 may also be of a substantially equivalent size, with minimal clearance, to the inner surface of the filter basket 9010.

The tamping head compacting face 11172 comprises a flat surface, thereby minimizing coffee ground adherence to the face under a compacting and rotational action. This may further aid in creating a uniform puck surface under a compacting action.

The compacting assembly 10950 may further incorporate at least one stepper driver 11010 for the rotational features of the combined grinding and dosing station 10900. In some embodiments, two stepper drivers may be provided to control the rotational action of the grind adjustment wheel of the grinder 9310 and the rotation of the dose wheel 9570.

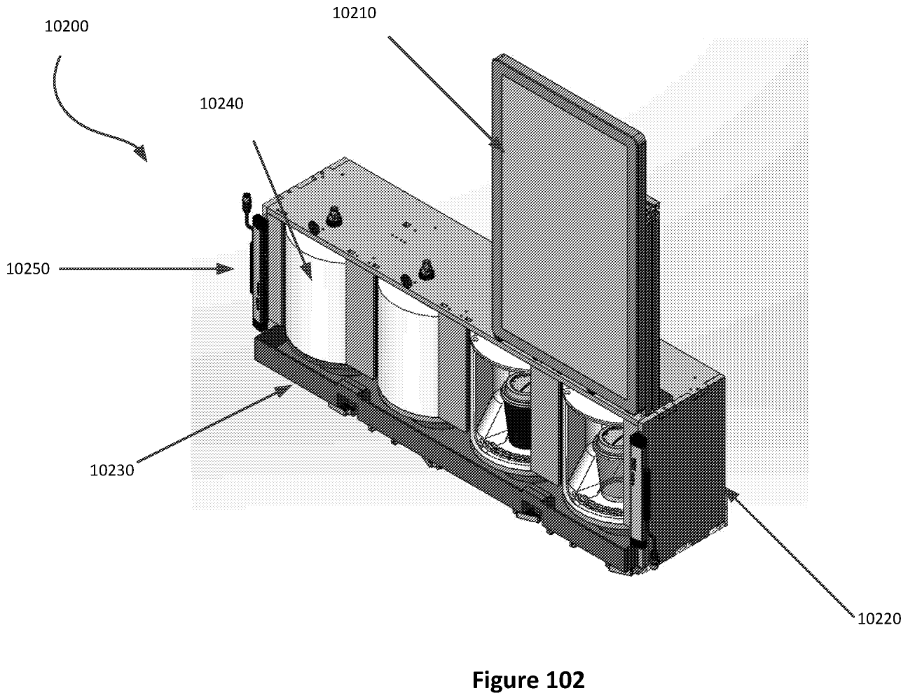

FIG. 102 depicts an order delivery interface 10200, the delivery portal comprising a frame 10220, delivery drip tray 10230, delivery stations 10240, light curtain 10250, and order display 10210. The delivery interface 10200 comprises multiple separate delivery portal chambers 10320 arranged in a portal array disposed on or toward an opposite end of the apparatus from the order interface. Completed coffee orders are placed by a robotic arm into the delivery station 10240, with chamber opening facing into the interior of the cabinet. Once the completed order is placed within the chamber 10240, the order portal chamber wall 10320 is rotated to the outward collection position by motor 10360.

The motor 10360 may be connected by a base 10350 and fixed to a bottom plate 10340, upon which rests the order portal chamber wall 10320. The order portal chamber wall 10320 having a partially enclosed top surface configured to receive a top fixing plate 10310.

The order portal chamber 10320 comprises a plurality of drip apertures 10330, which pass through a further bottom drain plate aperture 10341 in the bottom plate 10340, to drain any coffee spillage from the order portal chamber 10320 into the delivery drip tray 10230. In some embodiments the delivery drip tray 10230 may act as a reservoir for the spilled coffee waste, and be emptied manually upon service. In other embodiments, the delivery drip tray 10230 may be further drained into existing system waste storage.

The light curtain 10250 is provided to detect a customer reaching in to any one of the portals to collect a completed coffee order from within the chamber 103. Interruption of the light curtain 10250 prior to completion of a coffee order and subsequent rotation of the order portal chamber 10320 may cause the system to cease chamber rotation and display a safety warning on the display 10210.

The display 10210 may be configured to display a notification indicating an order is ready for collection at the delivery station 10240. In some embodiments, the display 10210 displays promotional and instructional media.

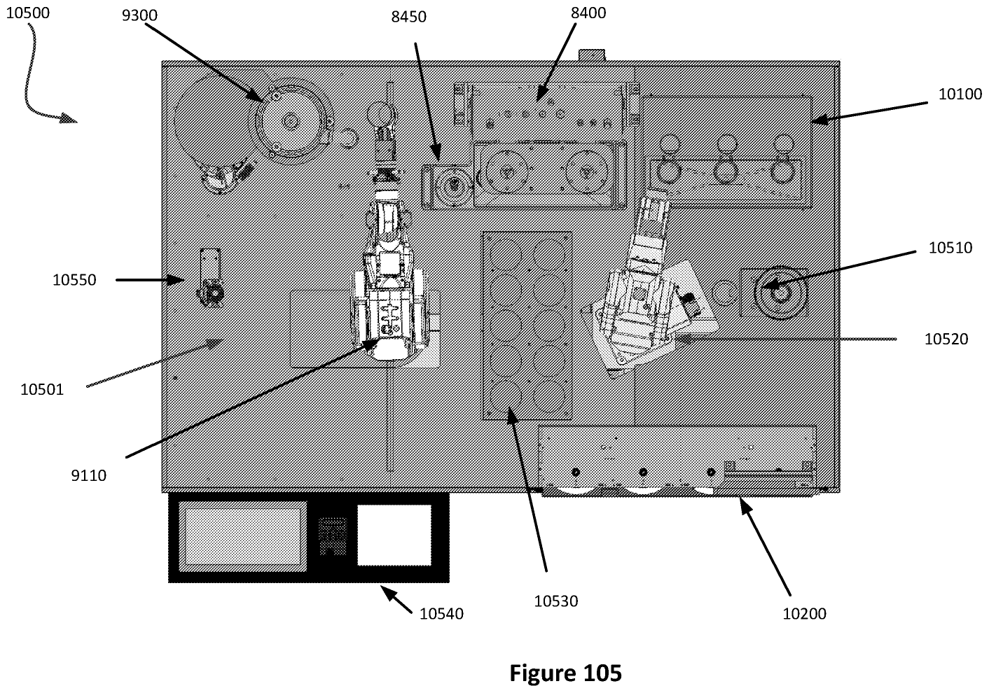

FIG. 105 depicts an alternative embodiment of an upper cabinet systems layout 10500 and cabinet separator 10501. In this configuration, the brewing arm 9110 is positioned centrally within the left of the cabinet separator surface 10501, and within reach of manipulation of the combined grinding, dosing and compacting station 9300, the brewing station 8400, and the weigh station 10550. The robotic brewing arm 9110 is configured to transport empty group handle portable filters 8930 to the doser and the compactor, then transport the filled group handle 8930 to the brewing machine and then engage the group handle portable filter 8930 with the at least one brew head of the brewing machine.

In some embodiments, the robotic staging arm 10520 is positioned centrally, to the right of the cabinet separator surface 10501, within reach of manipulation of the milk foaming station 10100, sugar dispenser 10510, and delivery interface 10200. The robotic staging arm 10520 may be arranged in the housing to select and transport a disposable coffee vessel between automatically controlled coffee preparation and delivery stations at the order delivery interface 10200. The cup and lid dispensers 10530 may be positioned between each robotic arm, and provide multiple apertures, such as up to ten apertures, for cups (e.g. 5 apertures) and lids (e.g. 5 apertures), to be dispensed from. A range of different numbers of apertures may be used while allowing for up to around 1500 cups and lids to be dispensed for a single service period of the machine without requiring re-stocking. In some embodiments, either robotic arm 9110 or 10520 is capable of engaging suitable end effectors for picking up cups or lids from the cup and lid dispensers 10530, depending on order requirements.

According to various embodiments, controller 240 as described previously herein is configured to automatically and autonomously control operation of each of:

the brewing machine 8400 (including cleaning station 8450), the grinding, dosing and compacting apparatus 9300, the milk delivery apparatus 10100, the robotic brewing arm 9110, the robotic staging arm 10520, the sugar dispenser 10510 and the delivery interface area 10200 (including display 10210).

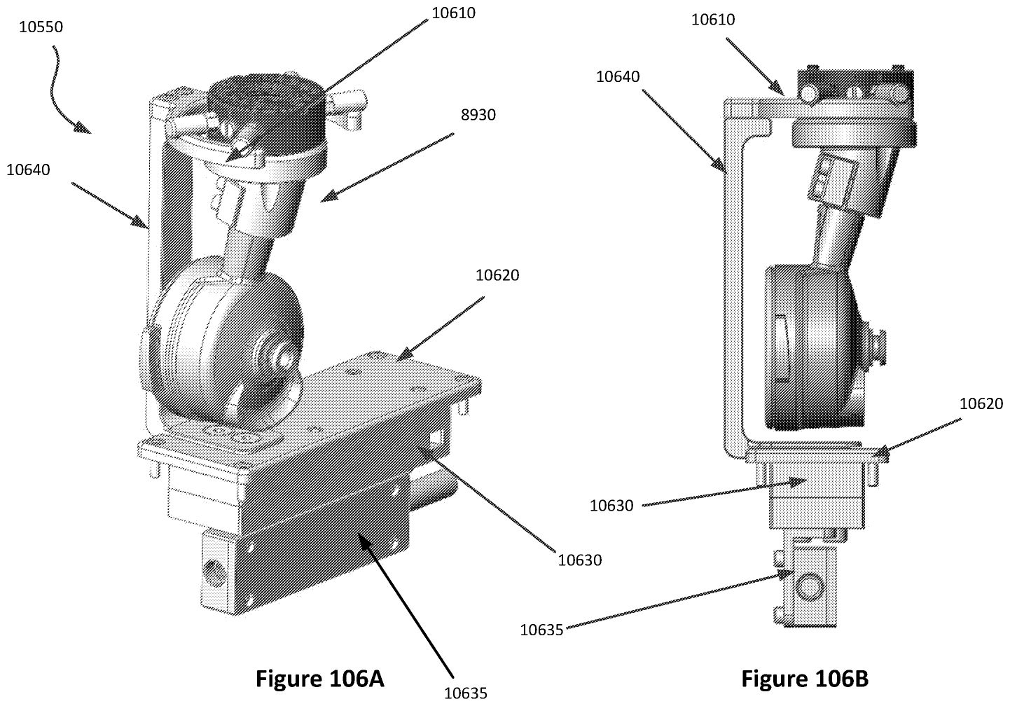

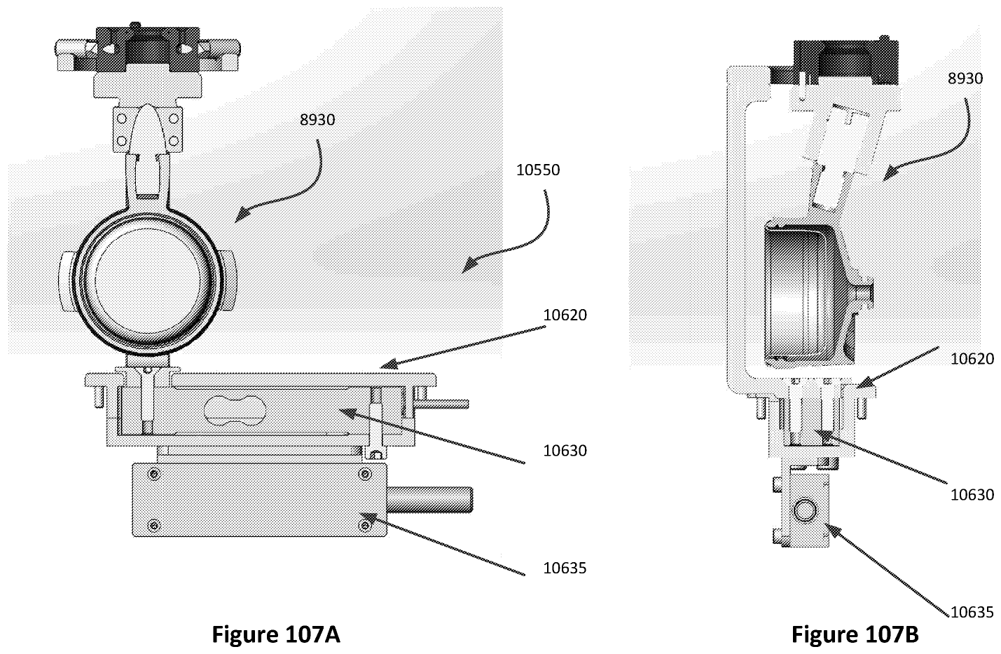

FIG. 106 depicts an embodiment of a weigh station 10550, having a weigh station tool holder 10610, supporting arm 10640, base plate 10620, and load cell 10630. Group handles 8930 with compacted coffee pucks are positioned with supporting prongs 8935 on the top surface of the weigh station tool holder 10610. The load cell 10630 weighs the entire group handle 8930 with compacted coffee puck, to ensure that the puck weight falls within a specified range, or a specific value. Each tool may be calibrated separately to account for minute discrepancies, and to ensure an accurate puck weight is obtained.

The load cell 10630 may be calibrated to account for off centre loading based on the position of the loaded supporting arm 10640 in relation to the base plate 10620. The weigh station is affixed to the cabinet separator 10501 by the base plate 10620, with the load cell 10603 and load cell cable housing 10635 positioned below. In some embodiments, a housing is provided to allow the load cell 10630 and load cell cable housing 10635 to sit above the cabinet separator surface 10501.

In some embodiments, the upper cabinet systems 10500 may be housed within an upper cabinet frame, comprising protective transparent shielding from the external environment. In some embodiments, the shielding is provided with a hinge proximally positioned a distance over the middle of the cabinet separator 10501, allowing the front L-shaped portion of the shield to be opened and providing access for maintenance and resupply. In some embodiments, the hinged portion may be located on either end of the machine, nearer to the brewing or staging arms respectively, or to the rear of the cabinet, allowing access to the brewing station 8400 and milk foaming station 10100.

FIG. 115 depicts a layout of some embodiments of upper cabinet system components for an autonomous brewing machine 11500. The upper cabinet components comprise a brewing station 8400, milk foaming station 10100, sugar dispenser 10510, robotic staging arm 10520, cup waste disposal 11510, cup holding array 11520, order delivery interface 10200, ordering interface terminal 4301, weighing station 2100, robotic brewing arm 9110, tool storage holder 11530, dose adjustment unit 2000, and combined grinding and dosing station 10900.

In the embodiment of 11500, the beverage brewing station 8400 is located centrally at the back of the cabinet separator surface, within reach of both a robotic brewing arm 9110 and a robotic staging arm 10520. This central rear location allows clear access by both robotic arms, allowing the drip tray 8402 to act as a staging and/or transfer (i.e. handover) area during a brewing operation. This clearer access and reduced travel distance can allow for more efficient movement of the robotic arms, improving coffee delivery times.

As in the embodiment of 10500, the cup and lid dispenser 10530 is located at an approximately half way point between the two robotic arms on the cabinet separator surface, and substantially in front of a brewing station 8400, allowing access for either the brewing arm 9110 or the staging arm 10520 to pick cups and lids as required throughout a brewing process. This shortened distance from the cup and lid dispenser 10530 to the brewing station 8400 and the robotic arms 9110, 10520 allows for more efficient movement of the robotic arms, further improving coffee delivery times.

The sugar dispenser 10510 of the autonomous brewing machine 11500 may be located on the right of the milk foaming station 10100, reducing the travel distance for a robotic arm between sugar and milk doses and further improving coffee delivery times.

The weighing station 2100 may accommodate up to two group handles 8930 for dose weighing or storage during peak operation times. Additional weighing stations having capacity for up to two group handles 8930 may be provided at other points such as the tool storage of 11550. In some embodiments, the tool storage 11550 functions only as a storage, without a load cell for weighing doses or group handles 8930. The greater capacity for weighing group handles 8930 on the weighing station 2100 for dosage weighing and tool storage may further improve coffee delivery time.

In some embodiment of the autonomous brewing machine 11500, the tool storage holder 11530 comprises a 2 by 2 configuration of the tool storage holder 8900, allowing up to four group handles 8930 to be stored for series or parallel use by the staging arm 231 and the brewing arm 232. A cup holding array 11520 may be located above the airlock delivery interface 10200, minimizing distance between completed orders and the delivery portal chambers 10320. The cup holding array 11520 may comprise multiple positions to hold cups. For example, the positions may include up to four rings, each defining a cup holding area. The rings each have a chamfered inner edge to correctly align cups placed in the holding array. The cup holding array 11520 may provide storage for completed orders in peak times, orders that remain uncollected after a period of time, or be used as a temporary storage point during a brewing operation.

In the embodiment of FIG. 115, a cup tray holder 11540 is included near the ordering interface terminal 4301, comprising a cavity within the housing under the ordering interface terminal 4301 of sufficient proportions to provide a storage space for cup trays.

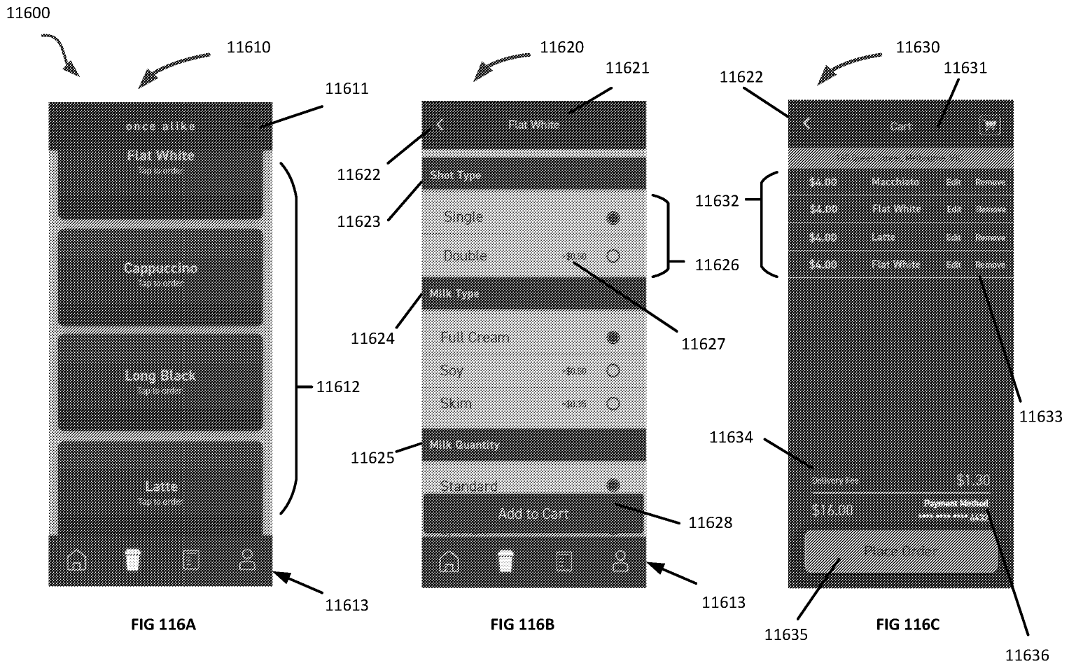

FIGS. 116A, 116B and 116C are screen shots of ordering interface displays displayed on a mobile client device 8210 interacting with the ordering web application server 130. FIG. 116A depicts a screenshot of an embodiment of a beverage ordering user interface 11610 of a beverage ordering application 8214 executing on the client device 8210. The user interface 11610 comprises a beverage selection menu 11612, navigation bar 11613, and shopping cart button 11611, for example. The beverage selection menu 11612 may comprise offer multiple different beverage types, for example including at least one coffee type, selectable by a user to be added to an online shopping cart. The navigation bar 11613 comprises an array of buttons allowing a user to select a different function of the beverage ordering user interface 11610. In some embodiments, these functions may comprise a home page, beverage ordering page, previous orders page, or user profile page. In other embodiments, different pages may be provided.

FIG. 116B depicts a screenshot of an embodiment of a beverage ordering interface 11620 executed by client application 8214. The beverage ordering interface 11620 may comprise a header bar 11621, a coffee shot menu 11623, milk type menu 11624, milk quantity menu 11625, an order confirmation button 11628, and navigation bar 11613, for example. The beverage ordering interface 11620 may be displayed after selection of a coffee through the beverage selection menu 11612, allowing a user to customise their selected coffee order. The selected beverage order may be displayed on a header bar 11621, which may further provide a back navigation button 11622 to return to a previous screen. The coffee shot menu 11623 may further comprise selectable order options 11626, with some options indicating cost additions 11627. Interacting with the order confirmation button 11628 may place the coffee order in an online cart for further processing.

FIG. 116C depicts a screenshot of an embodiment of a beverage ordering interface 11630 executed by client application 8214, comprising a header bar 11631, back navigation button 11622, beverage order table 11632, order modification options 11633, payment method display 11636, and order confirmation button 11635. The beverage order table 11632 may display a summary of beverage (e.g. coffee) orders currently placed in the online shopping cart, allowing a user to review before placing an order. The entries within the beverage order table 11632 may be modifiable through the order modification options 11635, comprising an edit or remove function in some embodiments. The order confirmation button 11635 allows a user to pay for the beverage order tabled in 11632, using a displayed payment method in 11636. An order delivery fee 11634 may be applicable in some embodiments.

It will be appreciated by persons skilled in the art that numerous variations and/ormodificationsmaybemadetotheabove-describedembodiments, without departing from the broad general scope of the present disclosure. The present embodiments are, therefore, to be considered in all respects as illustrative and not restrictive.

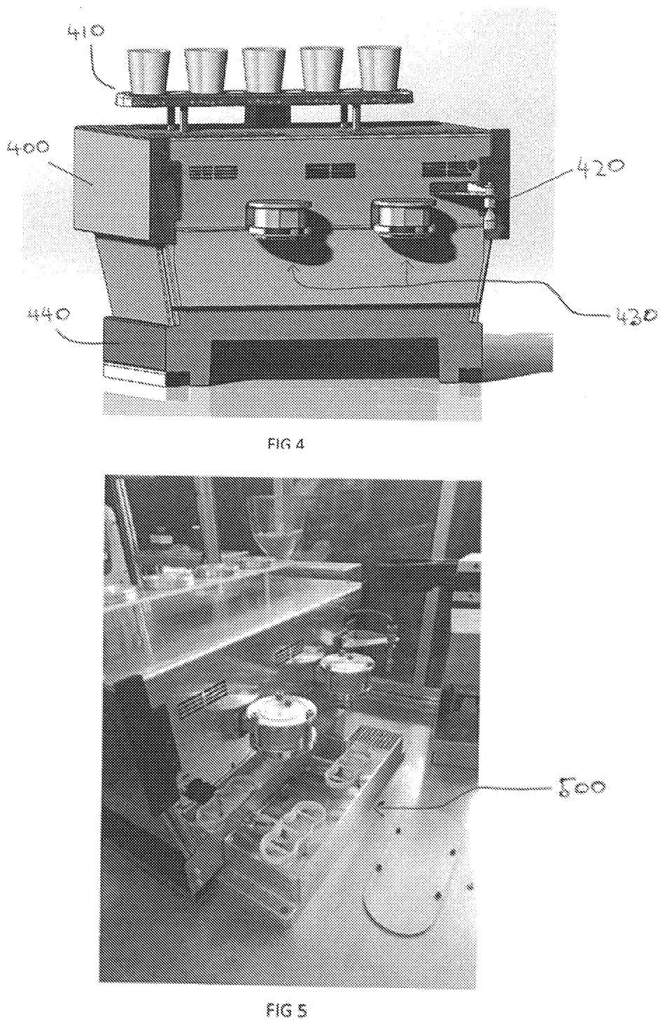

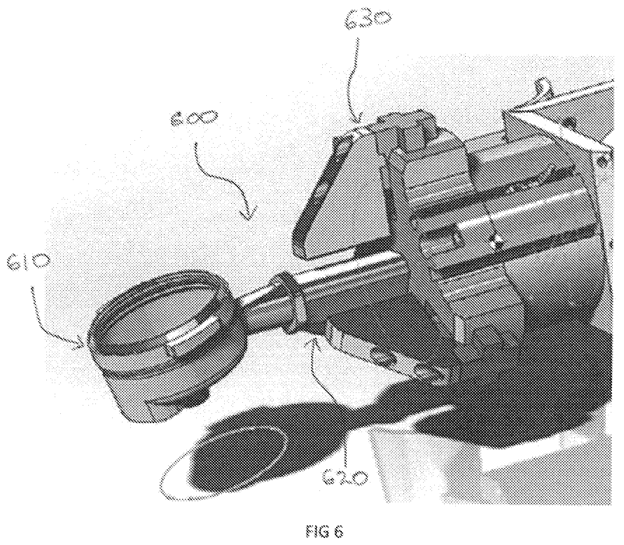

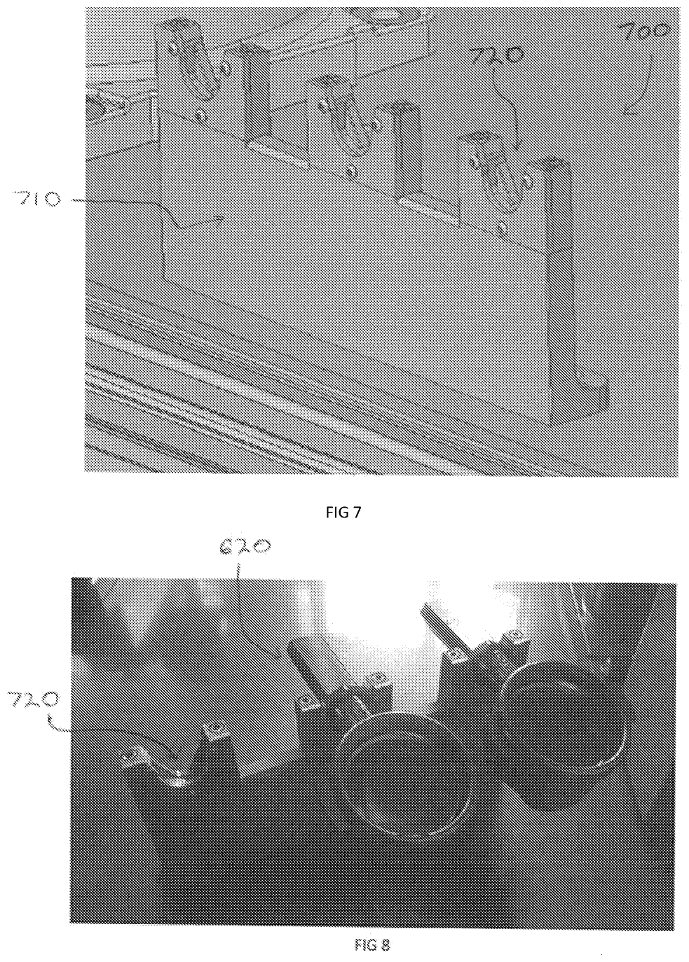

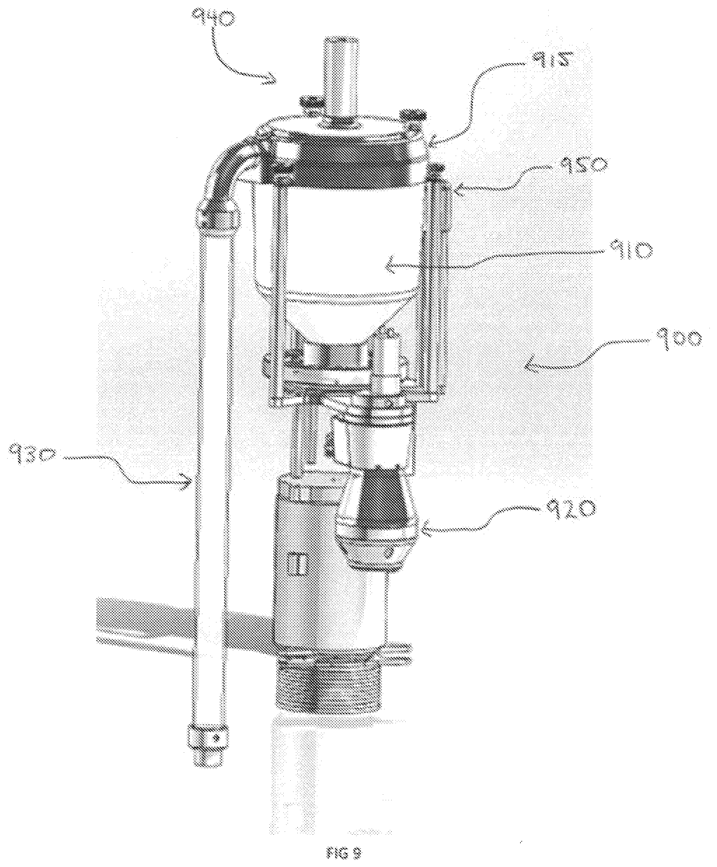

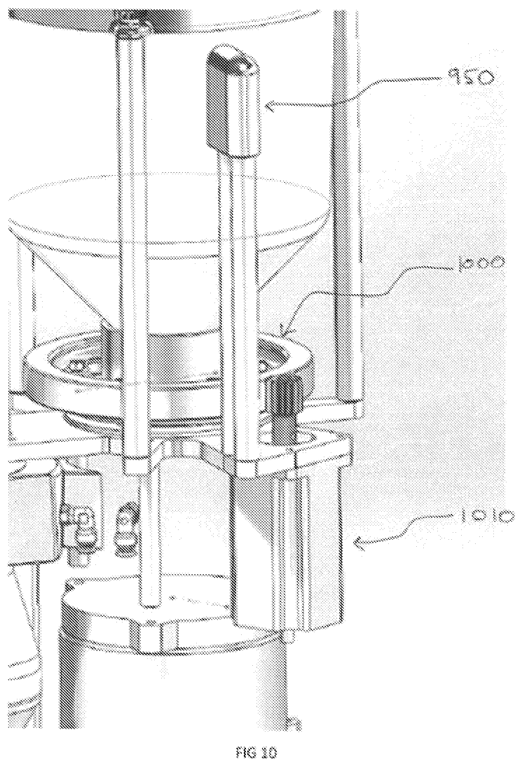

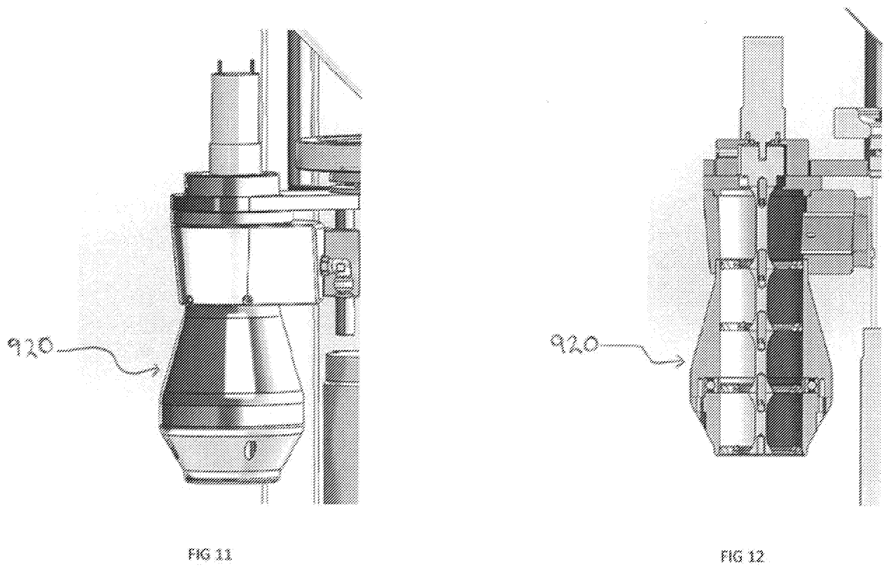

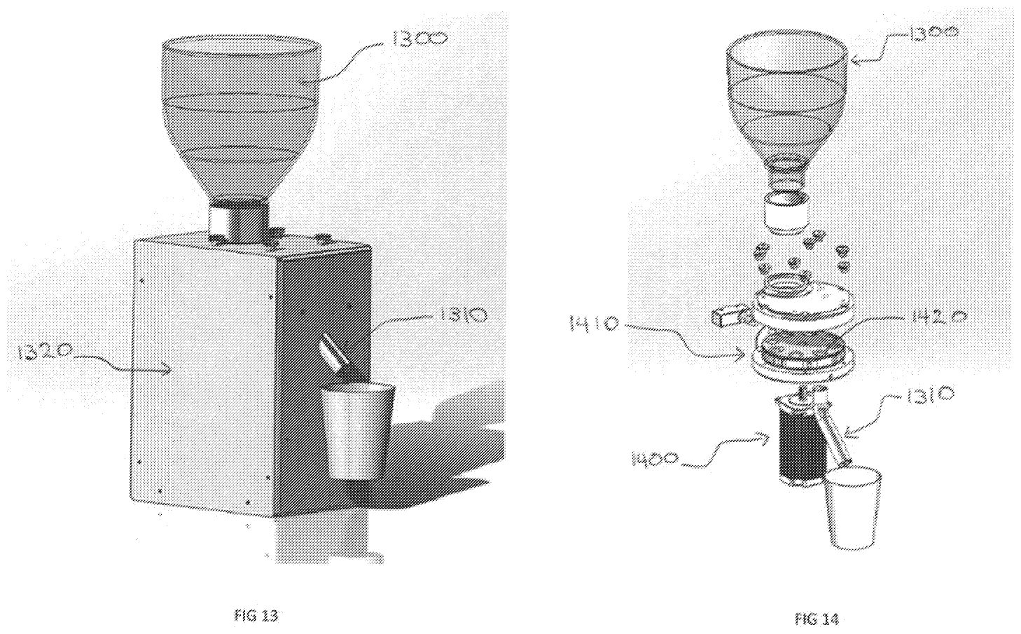

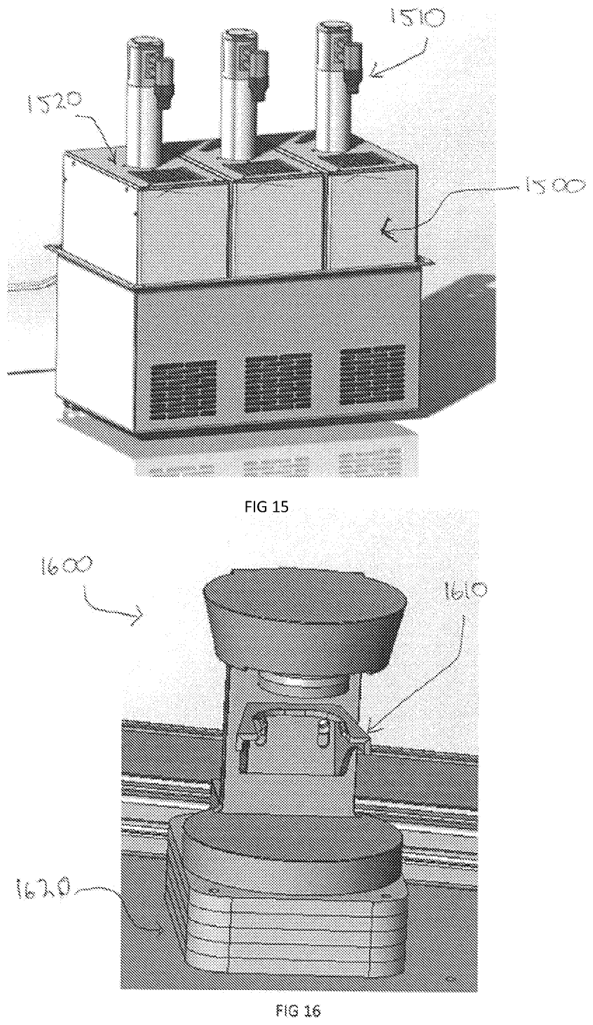

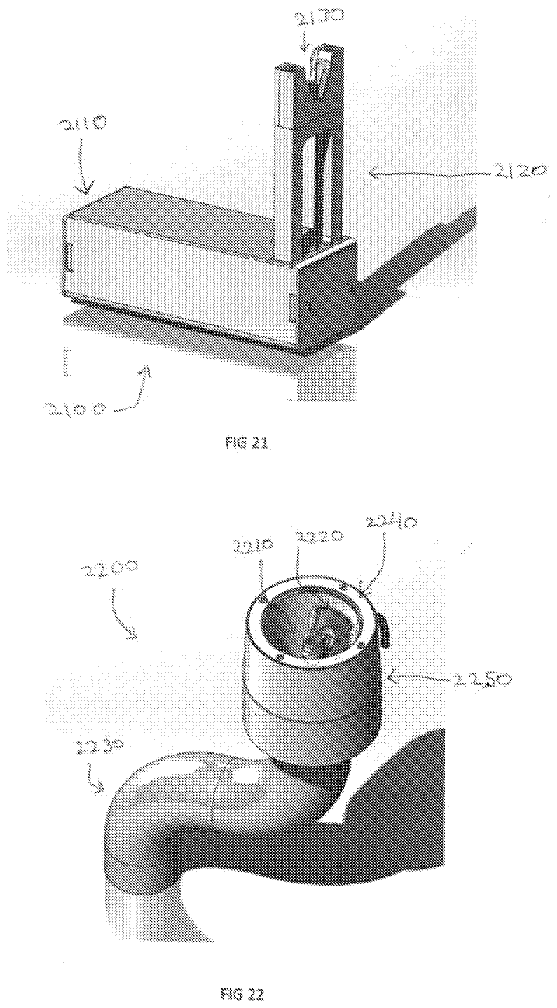

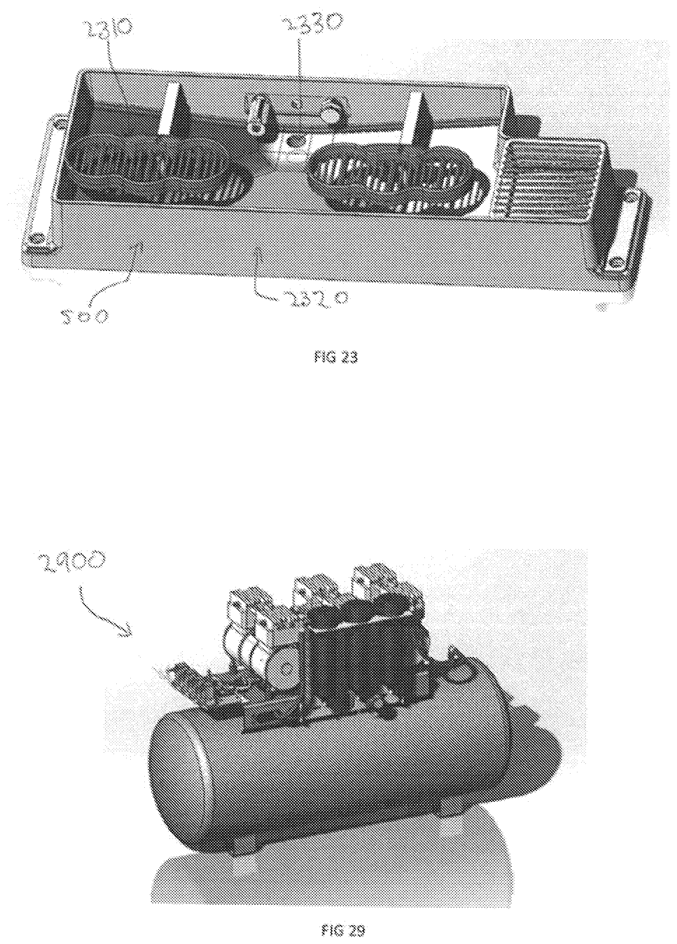

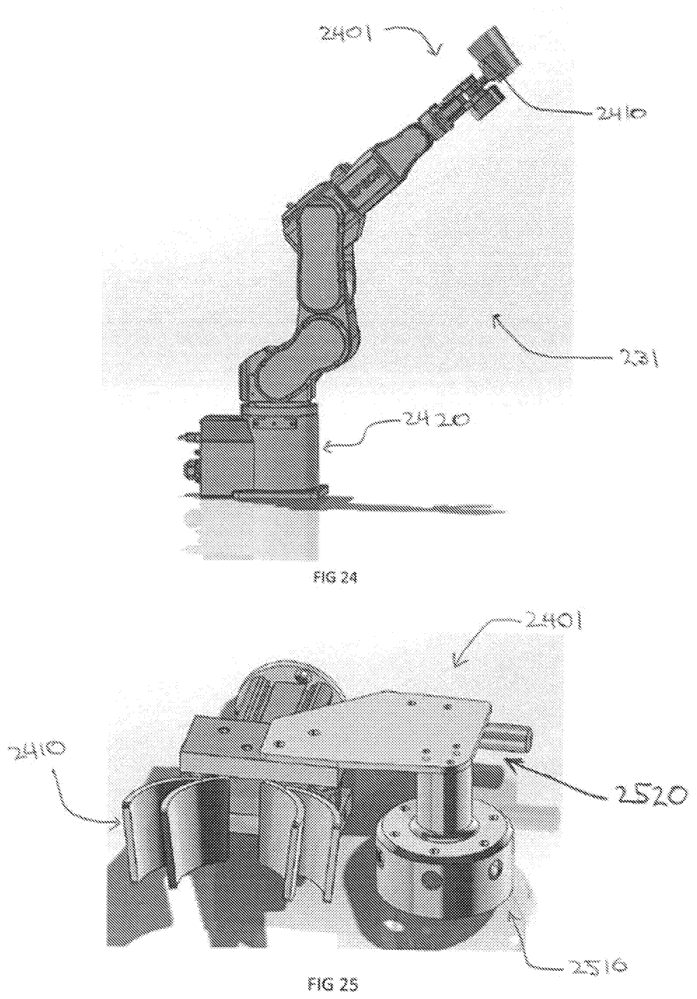

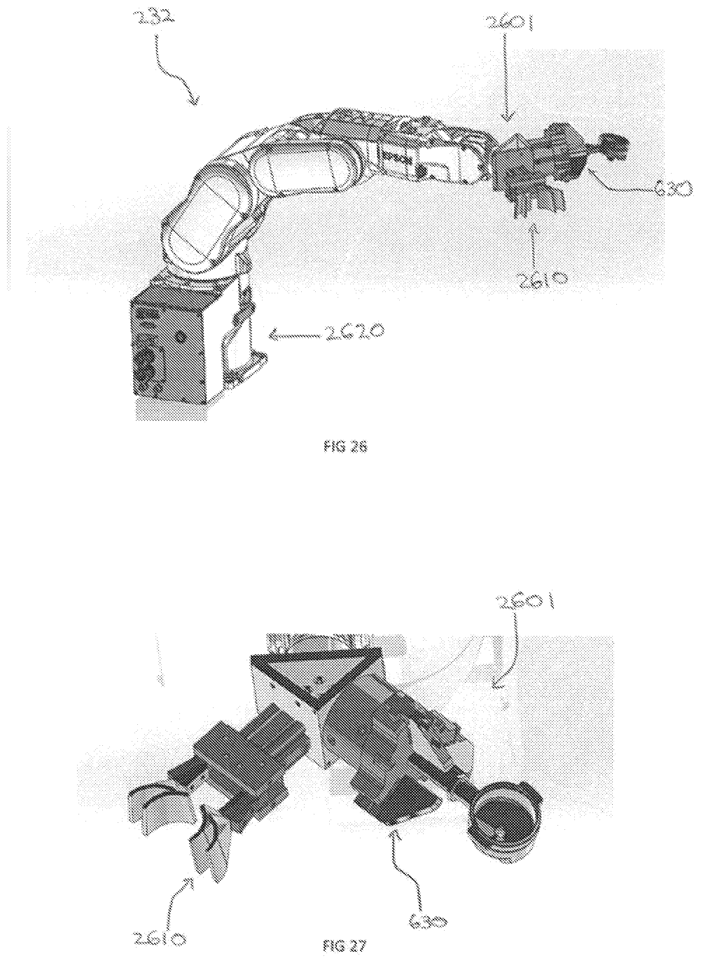

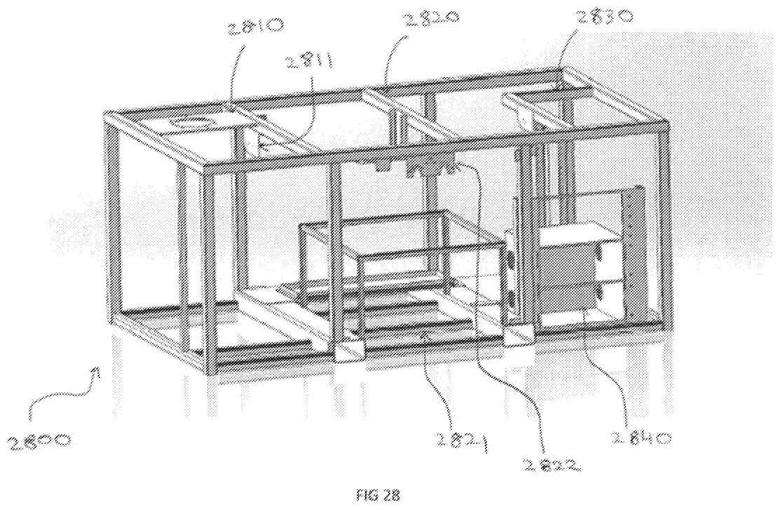

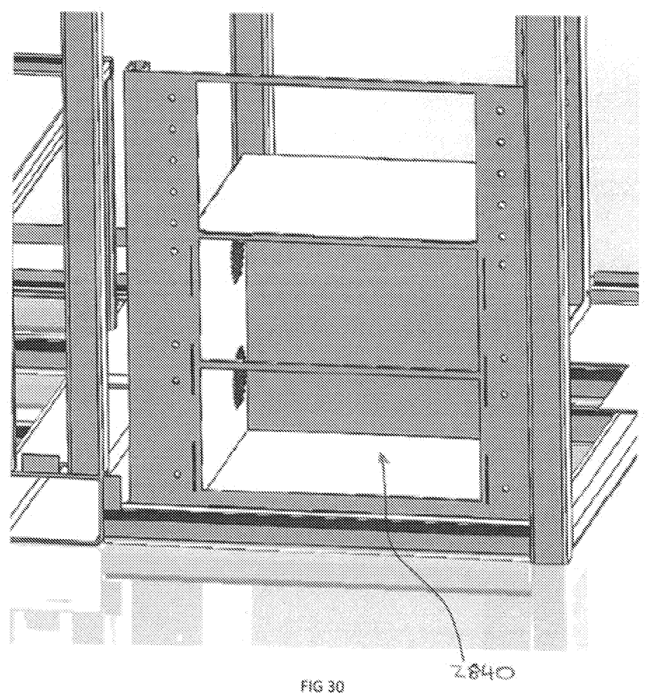

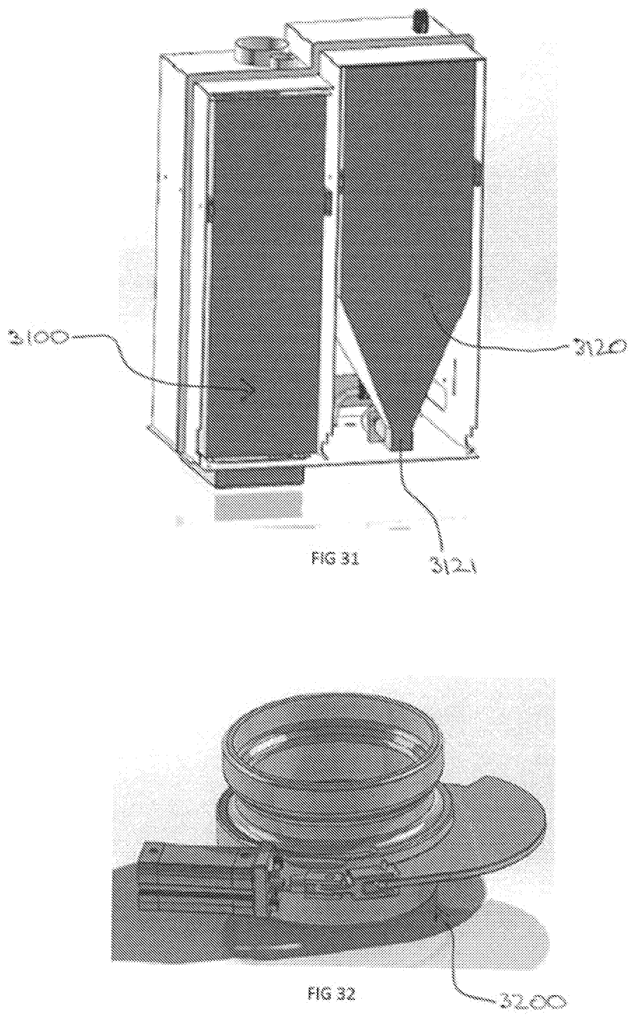

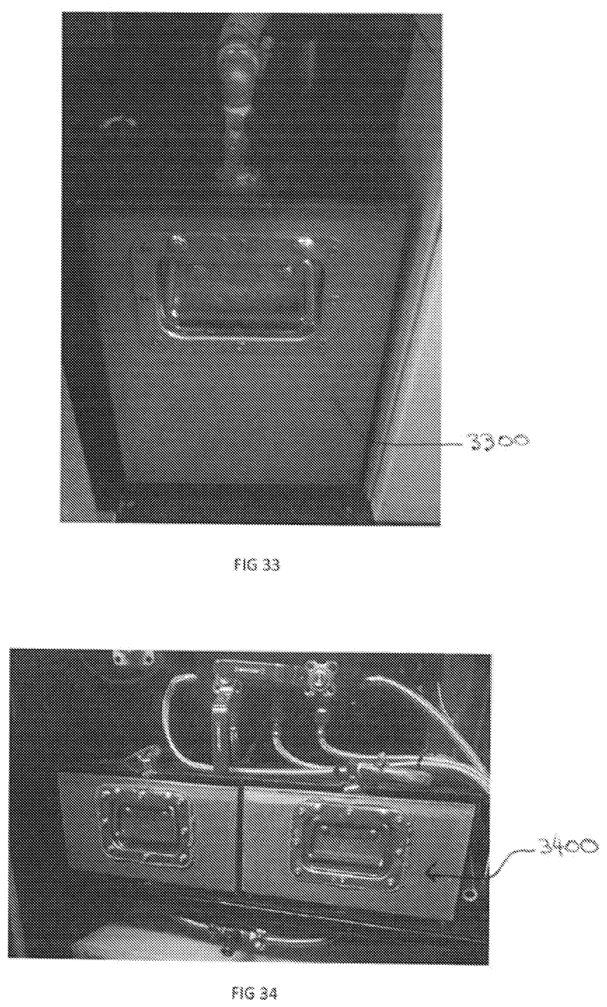

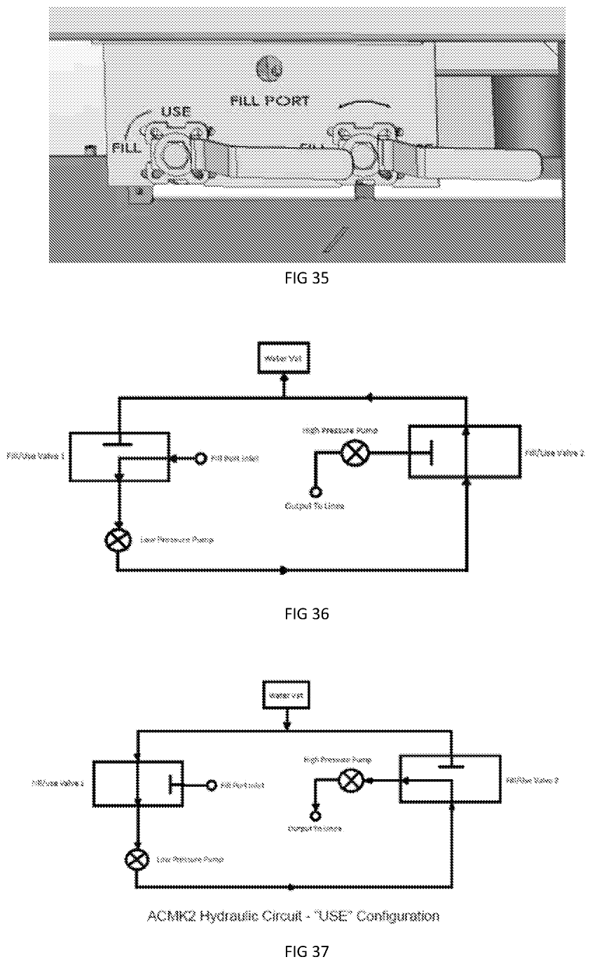

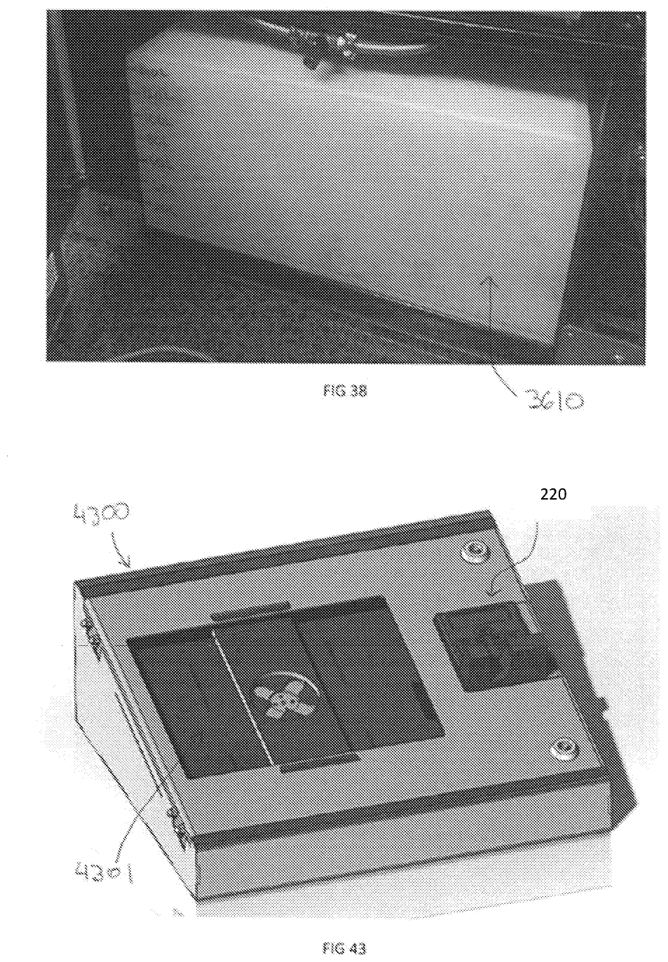

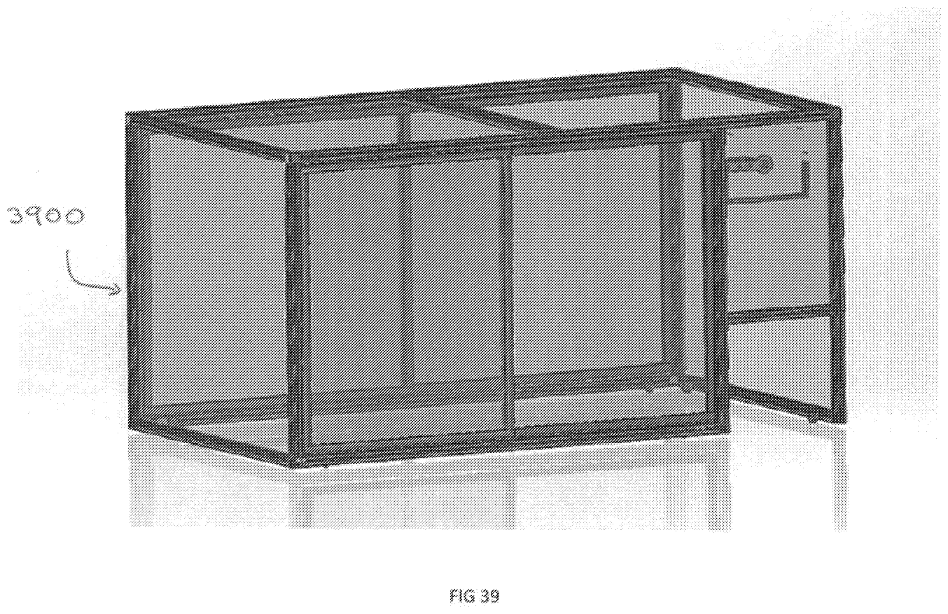

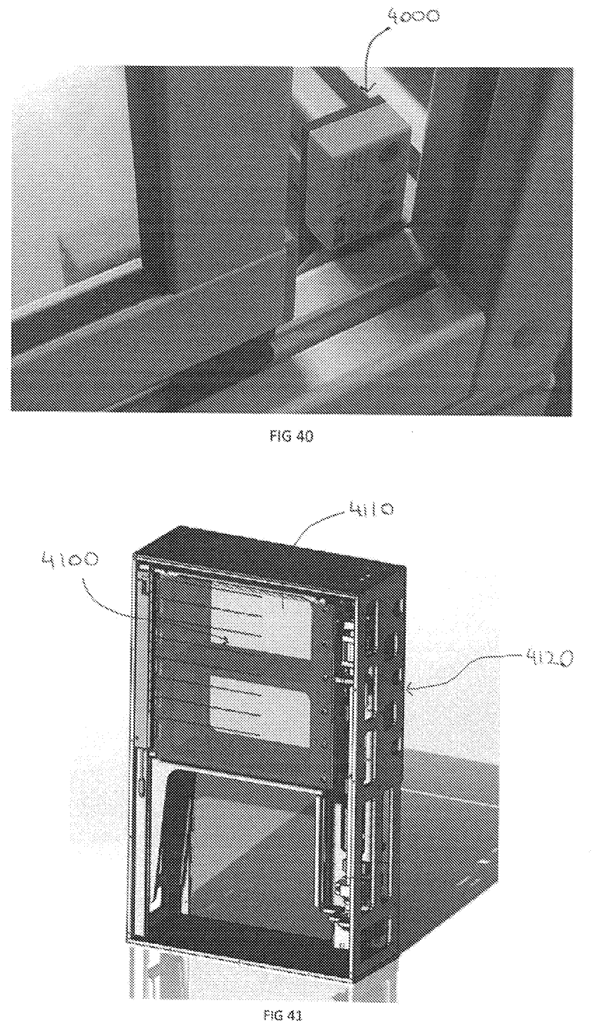

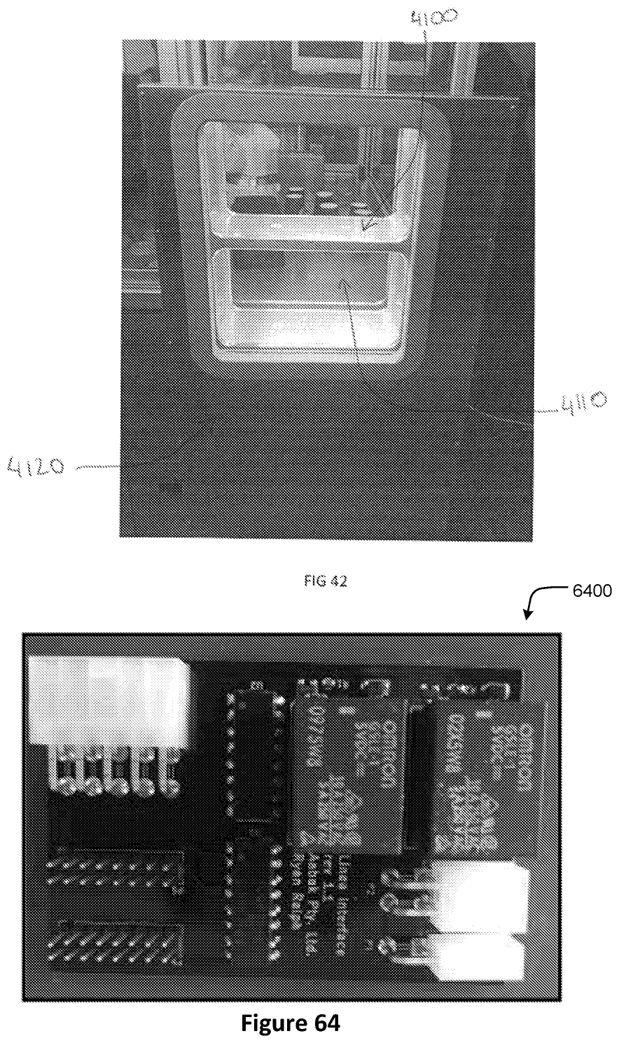

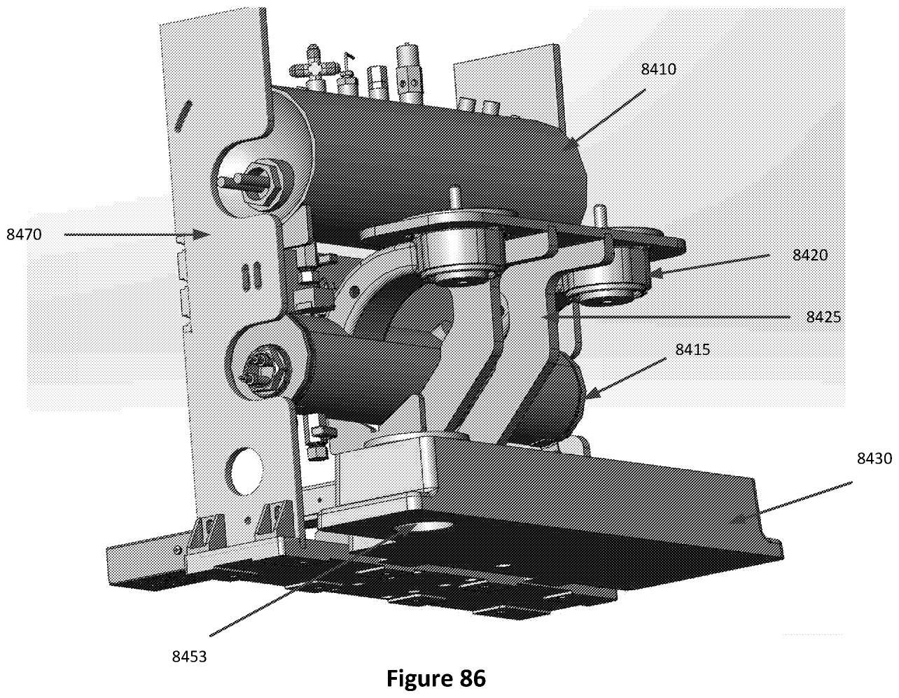

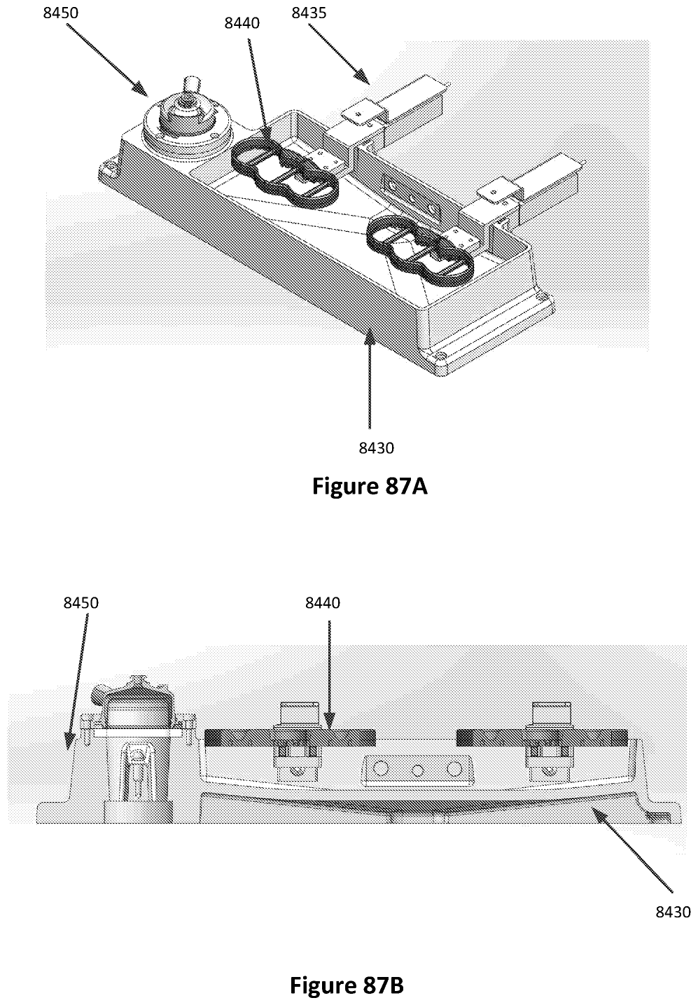

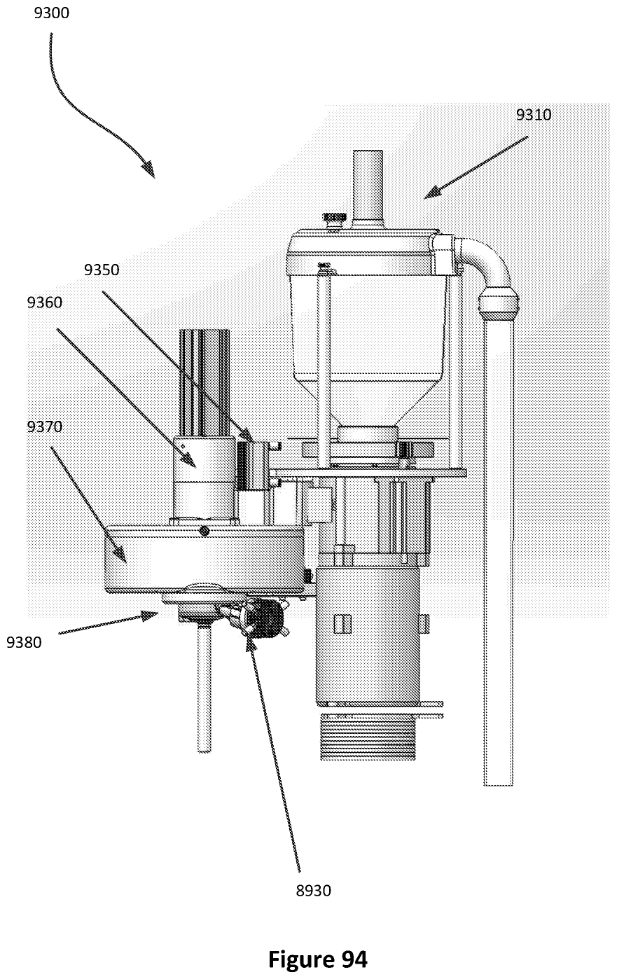

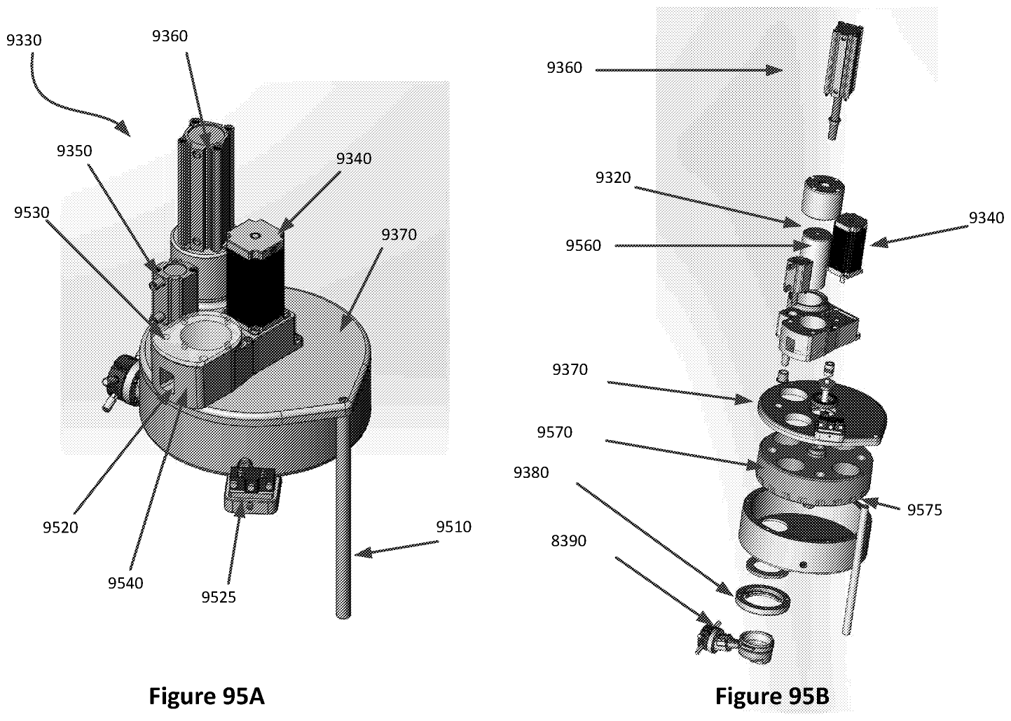

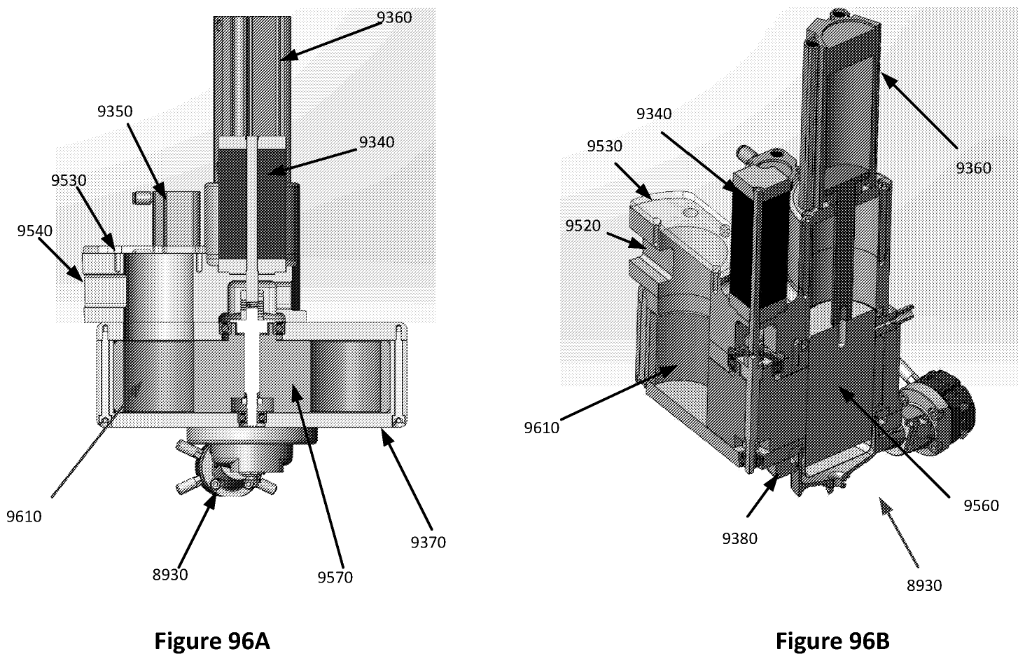

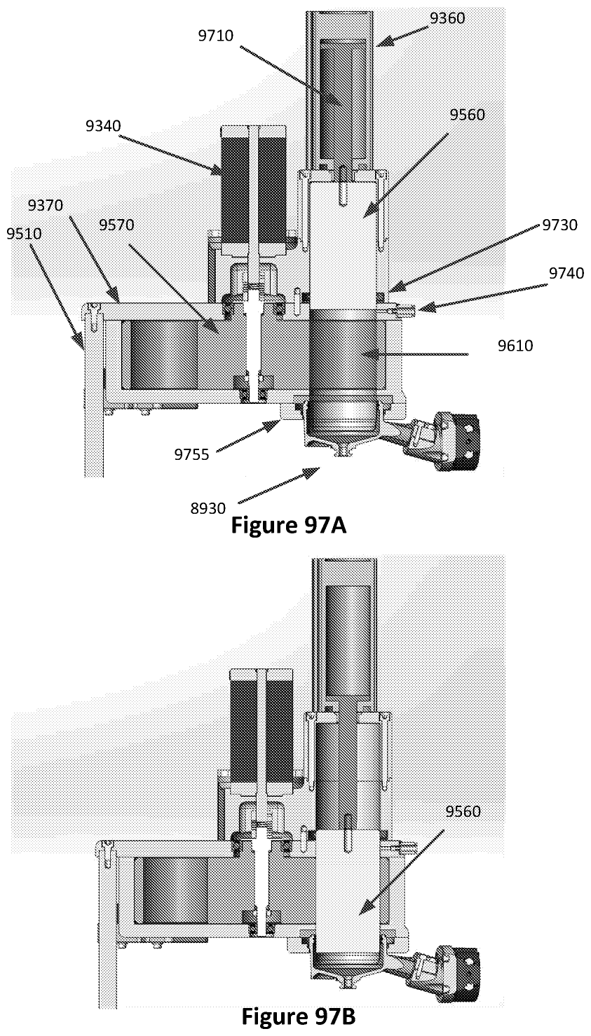

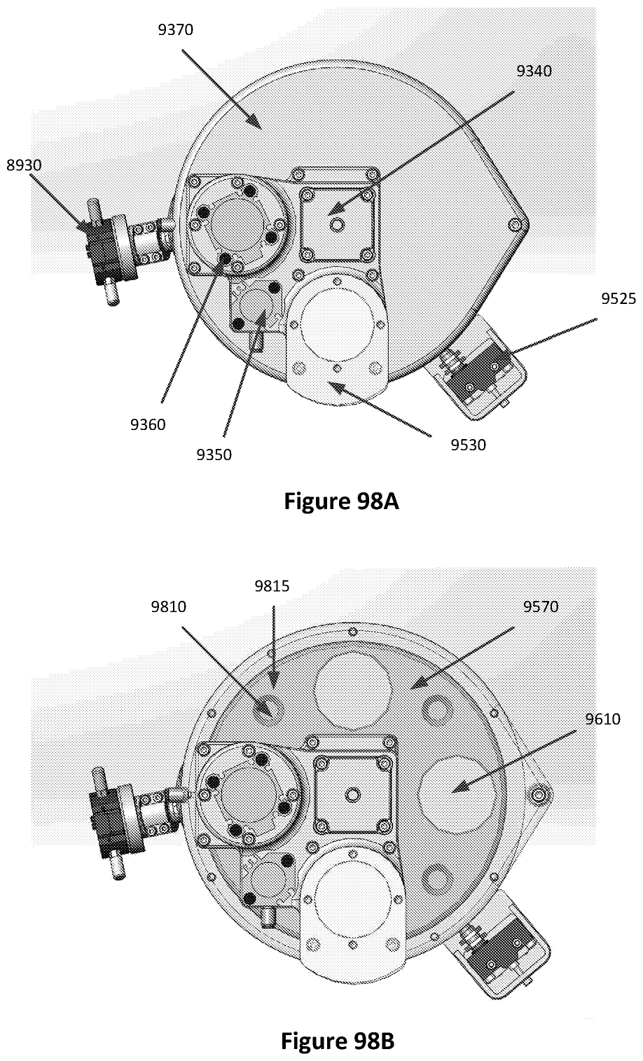

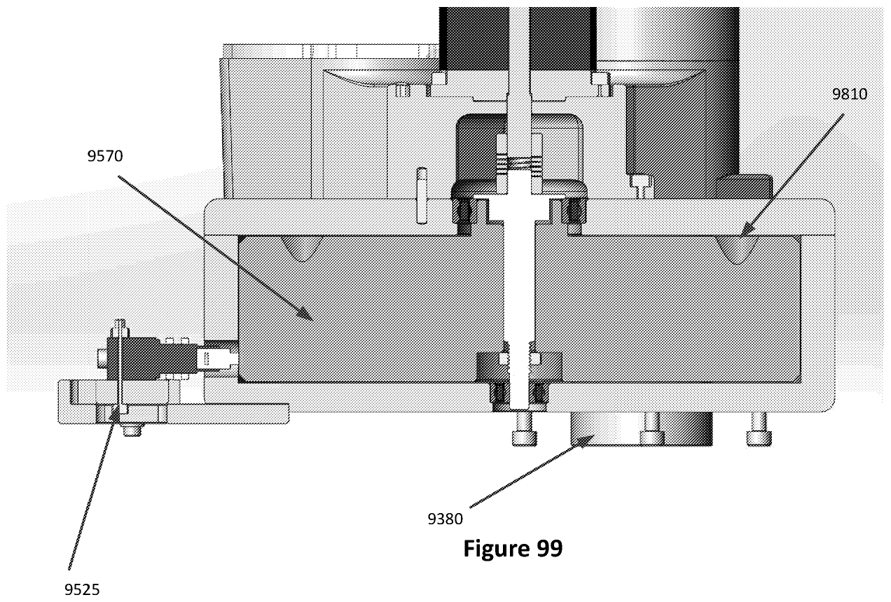

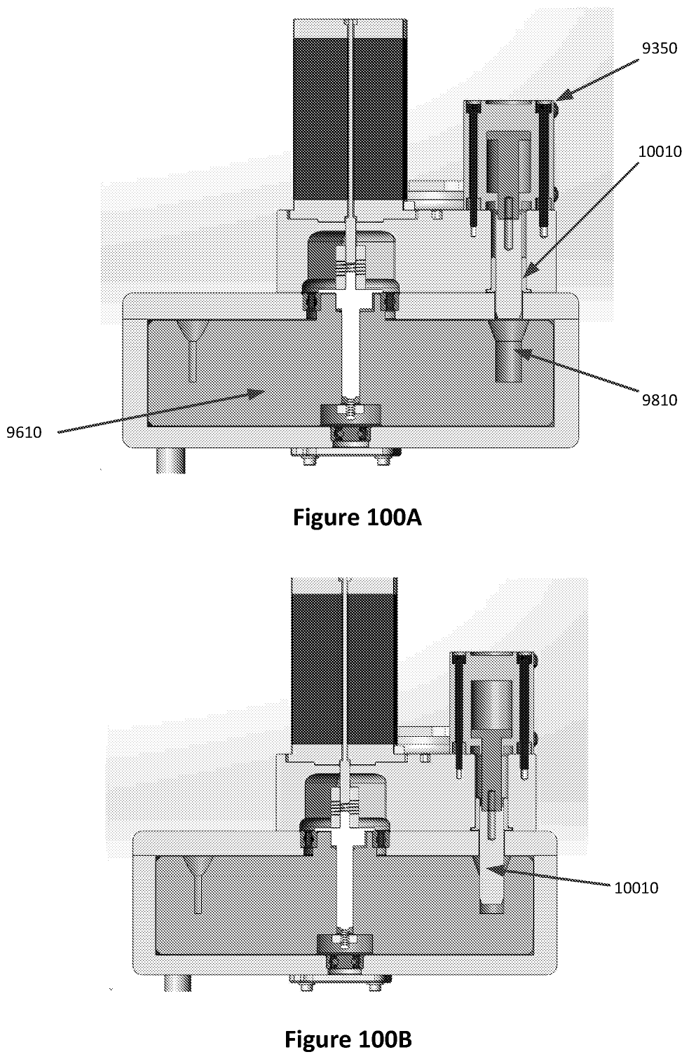

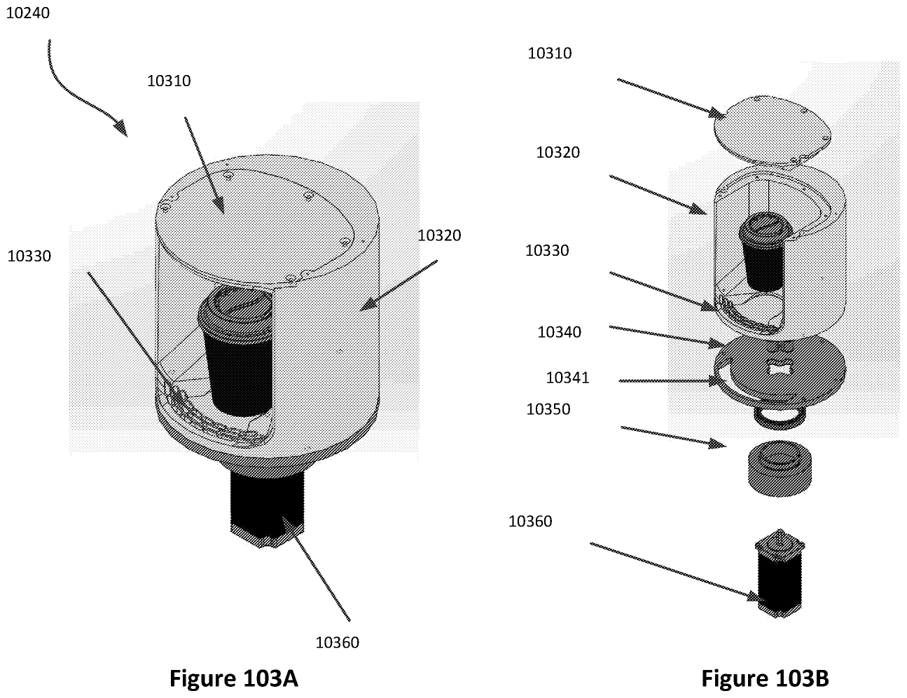

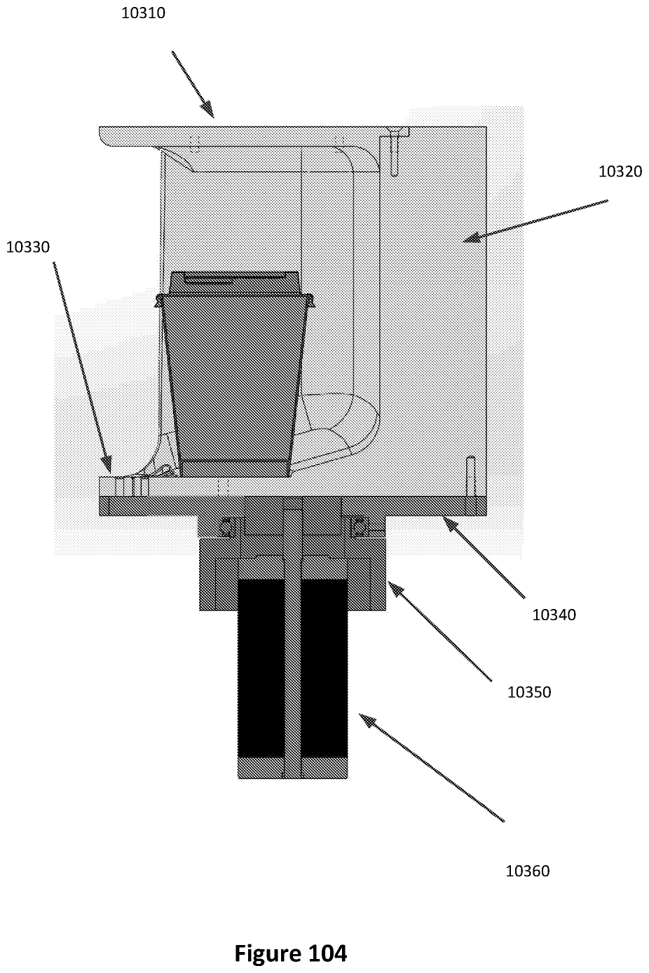

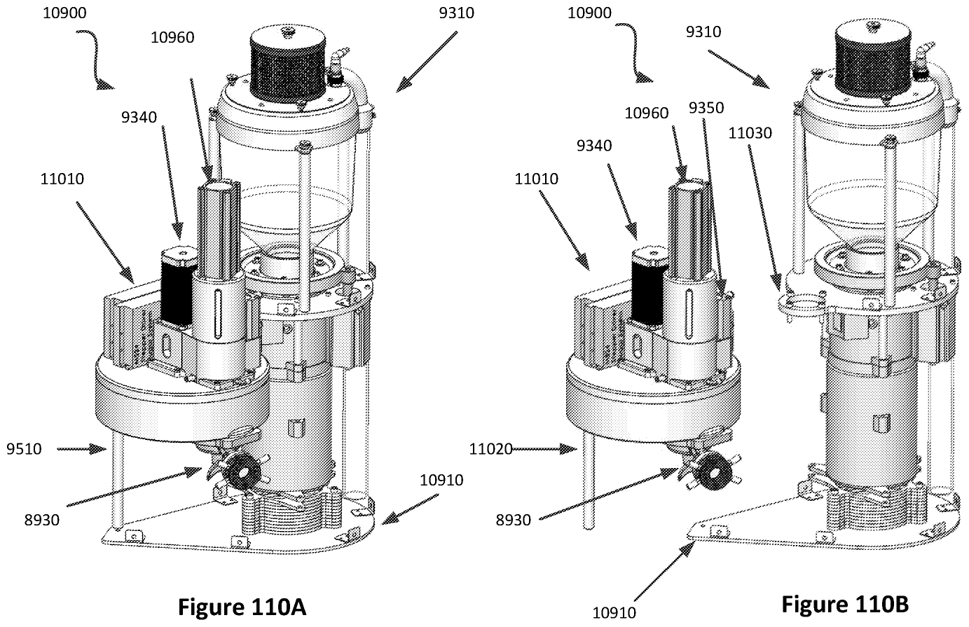

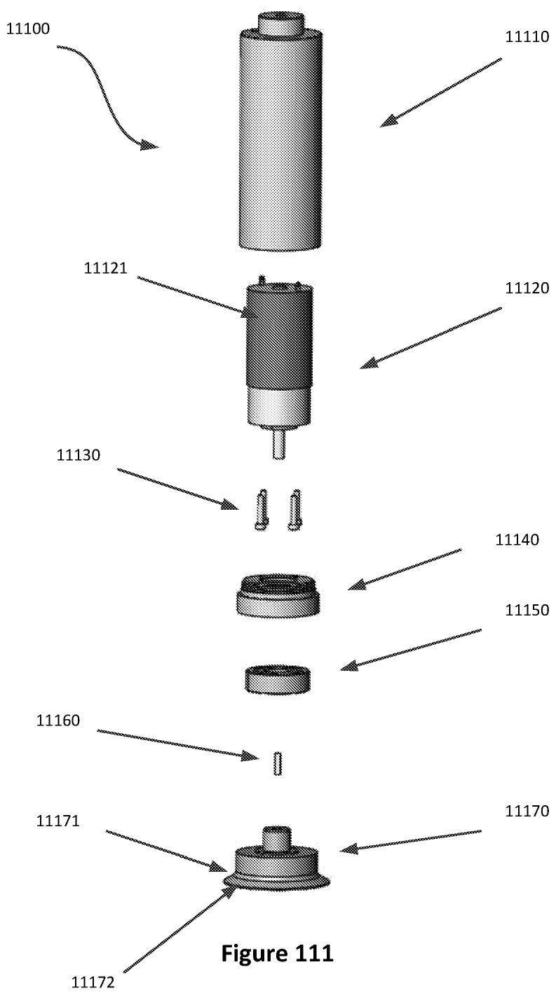

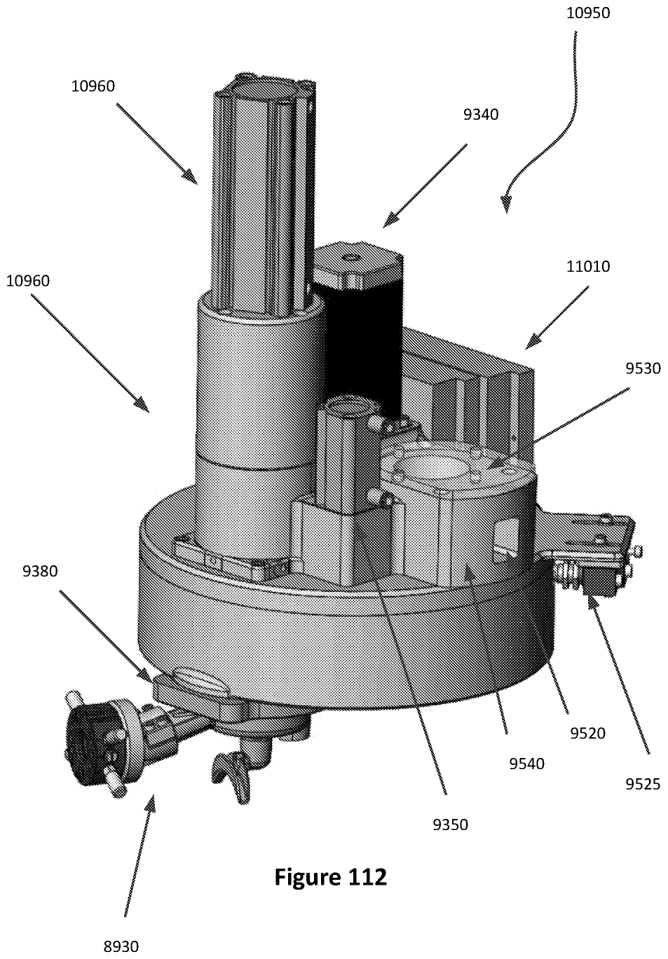

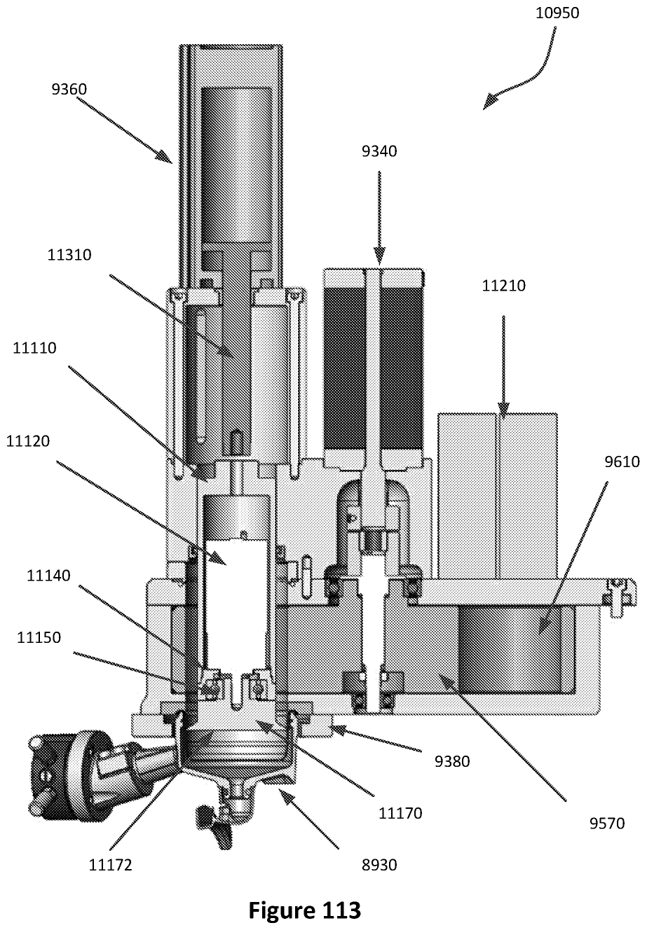

### Glossary

| | Figure | Reference |
|---|---|---|
| Term | Reference | No. |
| Coffee Preparation Array | FIG. 1 | 120 |
| Configuration Server | | |
| Payment Network | FIG. 1 | 140 |
| Coffee Preparation System Array | FIG. 1 | |
| Coffee Preparation System | FIG. 1, 2 | 110 |
| Coffee Preparation System Controller | FIG. 2 | 240 |
| Mobile Fulfilment Unit Array | FIG. 1 | — |
| Mobile Fulfilment Unit | FIG. 1 | 150 |
| Upper Cabinet Frame | FIG. 39 | 3900 |
| Card Validation Interface | FIG. 43 | 4310 |
| Coffee Preparation System Controller | FIG. 2 | 240 |
| Robotic Brewing Arm | FIG. 2, 26 | 232 |
| Robotic Staging Arm | FIG. 2, 24 | 231 |
| Cup/Lid Dispenser | FIG. 2, 17, 18 | 201 |
| System Housing | FIG. 3 | 350 |
| Order Display Assembly | FIG. 3 | 360 |
| Upper Cabinet | FIG. 3a, 39 | 330 |
| Beverage Brewing Station | FIG. 2, 4 | 303 |
| Grinding Station | FIG. 2, 16 | 203 |
| Milk Foaming Station | FIG. 2, 15 | 204 |
| Sugar Dispensing Station | FIG. 2, 13 | 205 |
| Tamping Station | FIG. 2, 16 | 206 |
| Puck Removal Station | FIG. 22 | 2200 |
| Cleaning Station | FIG. 2 | 207 |
| Dose shaving unit | FIG. 20 | 2000 |
| Operations Support Systems | FIG. 2 | 210 |
| Pneumatic Power Source | FIG. 2, 29 | 211 |
| Ingredient Supply Unit | FIG. 2 | 212 |
| Waste Management Unit | FIG. 2 | 213 |
| Cabinet Separator | FIG. 3 | 310 |
| Group Machine | FIG. 4 | 400 |
| Group Head | FIG. 4 | 430 |
| Mixer Tap | FIG. 4 | 420 |
| Staging Rack | FIG. 4 | 410 |
| Drip Tray | FIG. 5 | 500 |
| Tool Holder | FIG. 6 | 700 |
| Group Handle | FIG. 6 | 600 |
| Group Handle Basket | FIG. 6 | 610 |
| Jaw Gripper | FIG. 6 | 630 |
| Group Handle Shank | FIG. 6 | 620 |
| Tool Holder Channel | FIG. 7 | 720 |
| Tool Holder Body | FIG. 7 | 710 |
| Tool Holder | FIG. 7 | 700 |
| Grinder | FIG. 9 | 900 |
| Grinding Station | FIG. 9 | 203 |
| Grinder Hopper | FIG. 9 | 910 |
| Grinder Hopper Lid | FIG. 9 | 915 |
| Feeder Tube | FIG. 9 | 930 |
| Grinder Dose Tube | FIG. 9 | 920 |
| Bean Refill Vacuum | FIG. 9 | 940 |
| Ingredient Level Sensor | FIG. 9 | 950 |
| Grind Adjustment Gear | FIG. 10 | 1000 |
| Grind Adjustment Stepper Motor | FIG. 10 | 1010 |
| Sugar Hopper | FIG. 13 | 1300 |
| Sugar dispenser housing | FIG. 13 | 1320 |
| Rotary Dispensing Wheel | FIG. 13 | 1410 |
| Sugar Dispenser Stepper Motor | FIG. 13 | 1400 |
| Rotary Dispensing Wheel Top Plate | FIG. 13 | 1420 |
| Sugar Spout | FIG. 13 | 1310 |
| Milk Tap | FIG. 15 | 1510 |
| Milk Drip Tray | FIG. 15 | 1520 |
| Milk Foaming Device | FIG. 15 | 1500 |
| Tamping unit | FIG. 16 | 1600 |
| Tamping station Spacer Plate | FIG. 16 | 1620 |
| Group Handle Basket Seat | FIG. 16 | 1610 |
| Cup/Lid Dispenser Tube | FIG. 17, 18 | 1700 |
| Dispenser Plate Assembly | FIG. 17, 18 | 1710 |
| Flexible Membrane | FIG. 17, 18 | 1712 |
| Fixing Plate | FIG. 17, 18 | 1711 |
| Mounting Plate | FIG. 17, 18 | 1713 |
| Vacuum Tubing | FIG. 20 | 2020 |
| Dose control blade | FIG. 20 | 2010 |
| Weighing Station | FIG. 21 | 2100 |
| Weighing Station load cell | FIG. 21 | 2110 |
| Weighing Station mount | FIG. 21 | 2120 |
| Weighing station mount channel | FIG. 21 | 2130 |
| Puck Removal Station | FIG. 22 | 2200 |
| Puck Removal Air Supply Nozzle | FIG. 22 | 2210 |
| Puck Removal Air Supply Nozzle | FIG. 22 | 2220 |
| Puck Removal unit head | FIG. 22 | 2250 |
| Puck Removal Body | FIG. 22 | 2230 |
| Puck Removal Sealing Ring and | FIG. 22 | 2240 |
| O-ring | | |
| Drip Tray | FIG. 23 | 500 |
| Cup Platform | FIG. 23 | 2310 |
| Drip Tray Load Cells | FIG. 23 | 2320 |
| Drip tray outlet port | FIG. 23 | 2330 |
| Staging Arm Cup Gripper | FIG. 24 | 2420 |
| Staging Arm Lid Suction End Effector | FIG. 24 | 2510 |
| Staging Arm End Effector Assembly | FIG. 24 | 2401 |
| Staging Arm Effector Coupling Unit | FIG. 25 | 2520 |
| Brewing Arm Effector Coupling Unit | FIG. 26 | 2600 |
| Brewing Arm Cup Gripper | FIG. 26 | 2610 |
| Brewing Arm Base | FIG. 26 | 2620 |
| Brewing Arm Jaw Gripper | FIG. 6, 26 | 630 |
| Lower Cabinet Frame | FIG. 28 | 2800 |
| Lower cabinet first cross-member | FIG. 28 | 2810 |
| Lower cabinet second cross-member | FIG. 28 | 2820 |
| Perpendicular support member | FIG. 28 | 2830 |
| Lower cabinet vertical mounting plate | FIG. 28 | 2811 |
| Water system control valve mounting | FIG. 28 | 2822 |
| bracket | | |
| Water supply enclosure | FIG. 28 | 2821 |
| Air Compressor | FIG. 29 | 2900 |
| Server Rack | FIG. 28, 30 | 2840 |
| Grind Separation Unit | FIG. 31 | 3100 |
| Bean Vat | FIG. 31 | 3120 |
| Bean vat outlet | FIG. 31 | 3121 |
| Swing door assembly | FIG. 32 | 3200 |
| Upper Waste Vat | FIG. 34 | 3400 |
| Lower Waste Vat | FIG. 33 | 3300 |
| Hydraulic System | FIG. 35-38 | |
| Hydraulic Circuit | FIG. 36 | 3600 |
| Low pressure pump | FIG. 36 | 3620 |
| High pressure pump | FIG. 36 | 3630 |
| Refrigeration system | — | — |
| Water Vat | FIG. 38 | 3600 |
| Door Safety Sensor | FIG. 40 | 4000 |
| Collection Shelf | FIG. 41 | 4100 |
| Collection Area Housing | FIG. 42 | 4120 |
| Collection Area Sliding Door | FIG. 41 | 4110 |
| Ordering Interface Assembly | FIG. 43 | 4300 |
| Card Payment Terminal | FIG. 43 | 4310 |
| Ordering Interface Terminal | FIG. 43 | 4301 |
| Collection Area Light Curtain | FIG. 53 | 5300 |
| Load Cell Signal Processor | FIG. 54 | 5400 |
| Electronics Enclosure Front Plate | FIG. 55 | 5500 |
| Robotic Unit Interface | FIG. 56 | 5600 |
| Safety Board | FIG. 57 | 5700 |
| Wire Loom | FIG. 58 | 5800 |
| Lower Cabinet Assembly View | FIG. 59 | 5900 |
| Ethernet Communications Network | FIG. 60 | 6000 |
| USB Communications Network | FIG. 61 | 6100 |
| Milk Foaming Station Interface | FIG. 62, 63 | 6200, 6300 |
| Brewing Station Interface | FIG. 64 | 6400 |
| Grinder Power Box Relay Circuit | FIG. 65 | 6500 |
| Lower Cabinet | FIG. 3a | 340 |
| Dose Shaving Unit Head | FIG. 20 | 2030 |
| Coffee preparation sub-process | FIG. 81 | 8110 |
| Coffee delivery sub-process | FIG. 81 | 8120 |
| Airlock sub-process | FIG. 81 | 8130 |
| Geofence server | FIG. 82 | 8220 |
| Location tracker | FIG. 82 | 8212 |
| Client device | FIG. 82 | 8210 |
| Communications server | FIG. 82 | 8230 |
| Application | FIG. 82 | 8214 |
| Group machine | FIG. 84 | 8401 |
| Drip tray | FIG. 84 | 8402 |
| Steam boiler | FIG. 84 | 8410 |
| Brew boiler | FIG. 84 | 8415 |
| Group heads | FIG. 84 | 8420 |
| Group head struts | FIG. 84 | 8425 |
| Drip tray body | FIG. 84 | 8430 |
| Drip tray load cells | FIG. 84 | 8435 |
| Cup platform | FIG. 84 | 8440 |
| Integrated cleaning station | FIG. 84 | 8450 |
| Basket engagement ring | FIG. 88 | 8451 |
| Cleaning supply nozzle | FIG. 88 | 8452 |
| Drainage channel | FIG. 86 | 8453 |
| Group head frame | FIG. 84 | 8460 |
| Boiler frame | FIG. 84 | 8470 |
| Water spray area | FIG. 88 | 8810 |
| Air spray area | FIG. 88 | 8820 |
| Air supply nozzle | FIG. 88 | 8830 |
| Water supply nozzle | FIG. 88 | 8840 |
| Group handle staging rack | FIG. 89 | 8900 |
| Tool holding arm | FIG. 89 | 8910 |
| Tool holder/supports | FIG. 89 | 8915 |
| Staging rack base | FIG. 89 | 8920 |
| Group handle | FIG. 89 | 8930 |
| Supporting prongs | FIG. 89 | 8935 |
| Group handle interface | FIG. 89 | 8940 |
| Filter basket | FIG. 90 | 9010 |
| Robotic arm engagement | FIG. 90 | 9030 |
| Robotic brewing arm | FIG. 91 | 9100 |
| Cup gripper assembly | FIG. 91 | 9120 |
| Cup gripper supporting prongs | FIGS. 92 | 9121 |
| Cable section | FIG. 91 | 9130 |
| Robotic arm interface | FIG. 92 | 9210 |
| Cup gripper end | FIG. 92 | 9220 |
| Combined grinding and compacting | FIG. 93 | 9300 |
| station | | |
| Compacting assembly | FIG. 93 | 9301 |
| Grinder | FIG. 93 | 9310 |
| Grinder housing | FIG. 93 | 9320 |
| Compacting housing | FIG. 93 | 9330 |
| Motor | FIG. 93 | 9340 |
| Fine adjustment assembly | FIG. 93 | 9350 |
| Compacting piston assembly | FIG. 93 | 9360 |
| Fixed casing | FIG. 93 | 9370 |
| Compacting engagement ring | FIG. 94 | 9380 |
| Assembly support | FIG. 95 | 9510 |
| Coffee dose inlet | FIG. 95 | 9520 |
| Position detector | FIG. 95 | 9525 |
| Inspection window | FIG. 95 | 9530 |
| Coffee inlet assembly | FIG. 95 | 9540 |
| Dose chamber | FIG. 96 | 9610 |
| Driving shaft | FIG. 97 | 9710 |
| Wiper ring | FIG. 97 | 9730 |
| Air jet | FIG. 97 | 9740 |
| Outlet | FIG. 97 | 9755 |
| Fine alignment guides | FIG. 98 | 9810 |
| chamfered lip | FIG. 98 | 9815 |
| Guide piston | FIG. 100 | 10010 |
| Milk foaming station | FIG. 101 | 10100 |
| Milk drip tray | FIG. 101 | 10110 |
| Cup holder | FIG. 101 | 10120 |
| Order delivery interface | FIG. 102 | 10200 |
| Order display | FIG. 102 | 10210 |
| Frame | FIG. 102 | 10220 |
| Delivery drip tray | FIG. 102 | 10230 |
| Delivery station | FIG. 102 | 10240 |
| Light curtain | FIG. 102 | 10250 |
| Top fixing plate | FIG. 103 | 10310 |
| Order portal chamber | FIG. 103 | 10320 |
| Drip apertures | FIG. 103 | 10330 |
| Bottom plate | FIG. 103 | 10340 |
| Bottom plate drain aperture | FIG. 103 | 10341 |
| Base | FIG. 103 | 10350 |
| Motor | FIG. 103 | 10360 |
| Upper cabinet systems layout | FIG. 105 | 10500 |
| Cabinet separator surface | FIG. 105 | 10501 |
| Sugar dispenser | FIG. 105 | 10510 |
| Robotic staging arm | FIG. 105 | 10520 |
| Cup and lid dispenser | FIG. 105 | 10530 |
| Weigh station | FIG. 105 | 10550 |
| Weigh station tool holder | FIG. 106 | 10610 |
| Base plate | FIG. 106 | 10620 |
| Load cell | FIG. 106 | 10630 |
| Cable housing | FIG. 106 | 10635 |
| Supporting arm | FIG. 106 | 10640 |
| Cup detection sensor | FIG. 108 | 10810 |
| Jaw gripper | FIG. 108 | 10820 |
| Adapter plates | FIG. 108 | 10830 |
| Tool changer | FIG. 108 | 10840 |
| Combined grinding and dosing station | FIG. 109 | 10900 |
| Station fixing plate | FIG. 109 | 10910 |
| Compacting assembly | FIG. 109 | 10950 |
| Rotatable compacting piston assembly | FIG. 109 | 10960 |
| Stepper driver | FIG. 110 | 11010 |
| Compacting assembly mounting plate | FIG. 110 | 11030 |
| Rotatable Compacting piston | FIG. 111 | 11100 |
| Piston housing | FIG. 111 | 11110 |
| Piston body | FIG. 111 | 11120 |
| Piston body motor portion | FIG. 111 | 11121 |
| Piston head fixing means | FIG. 111 | 11130 |
| Tamping body | FIG. 111 | 11140 |
| Rotatable tamp ring | FIG. 111 | 11150 |
| Tamping head fixing pin | FIG. 111 | 11160 |
| Tamping head | FIG. 111 | 11170 |
| Tamping head flange portion | FIG. 111 | 11171 |
| Tamping head compacting face | FIG. 111 | 11172 |
| Plunger | FIG. 113 | 11310 |
| Water supply nozzle | FIG. 114 | 11410 |
| Water supply channel | FIG. 114 | 11413 |
| Water supply line | FIG. 114 | 11414 |
| Tip portion | FIG. 114 | 11411 |
| Air supply channel | FIG. 114 | 11415 |
| Air supply line | FIG. 114 | 11416 |
| Cleaning station body | FIG. 114 | 11401 |
| Cleaning station drainage channel | FIG. 114 | 11402 |
| Cleaning supply fixture | FIG. 114 | 11403 |
| Air supply reservoir | FIG. 114 | 11417 |
| Water supply reservoir | FIG. 114 | 11418 |
| Group handle engagement | FIG. 114 | 11419 |
| Coffee ground puck | FIG. 114 | 11420 |
| Water nozzle spray angle | FIG. 114 | 11430 |
| Cup waste disposal | FIG. 115 | 11510 |
| Cup holding array | FIG. 115 | 11520 |
| Tool storage holder | FIG. 115 | 11530 |
| Cup tray holder | FIG. 115 | 11540 |
| Additional tool storage | FIG. 115 | 11550 |
| Beverage ordering application | FIG. 116 | 11600 |
| Beverage ordering interface | FIG. 116 | 11610 |
| Shopping cart button | FIG. 116 | 11611 |
| Coffee selection menu | FIG. 116 | 11612 |
| Navigation bar | FIG. 116 | 11613 |
| Beverage ordering interface | FIG. 116 | 11620 |
| Header bar | FIG. 116 | 11621 |
| Back navigation | FIG. 116 | 11622 |
| Coffee shot menu | FIG. 116 | 11623 |
| Milk type menu | FIG. 116 | 11624 |
| Milk quantity menu | FIG. 116 | 11625 |
| Selectable order options | FIG. 116 | 11626 |
| Cost additions | FIG. 116 | 11627 |
| Order confirmation button | FIG. 116 | 11628 |
| Beverage ordering interface | FIG. 116 | 11630 |
| Header bar | FIG. 116 | 11631 |
| Beverage order table | FIG. 116 | 11632 |
| Order modification options | FIG. 116 | 11633 |
| Payment method display | FIG. 116 | 11634 |
| Order confirmation button | FIG. 116 | 11635 |
| Payment method display | FIG. 116 | 11636 |

Although the present invention has been described with reference to preferred embodiments, workers skilled in the art will recognize that changes may be made in form and detail without departing from the spirit and scope of the invention.

1. (canceled)

2. The system of claim 20, further comprising a weigh station to measure a mass of the grounds in the filter basket, wherein the controller is configured to control the at least one robotic arm to transport the portable filter with compacted grounds to the weigh station before transporting it to the brewing machine.

3. The system of claim 2, further comprising a weight reduction station to remove some of the compacted grounds from the filter basket, wherein the controller is configured to control the at least one robotic arm to transport the portable filter with compacted grounds to the weight reduction station after transporting it to the weigh station.

4. The system of claim 20, further comprising a grounds disposal station to remove used grounds from the filter basket, wherein the controller is configured to control the at least one robotic arm to transport the portable filter with used grounds to the disposal station after the coffee beverage is created at the brewing machine.

5-18. (canceled)

19. The system of claim 20, further comprising a milk supply and a sweetener supply, wherein the controller controls dispensing of milk from the milk supply and dispensing of sweetener from the sweetener supply.

20. An automated coffee preparation system, comprising:
a controller;
a coffee grinder to grind coffee beans into grounds;
a doser to dispense grounds into a filter basket;
a compactor to compact the grounds in the filter basket, the compactor being co-located with the doser;
a brewing machine comprising at least one brew head and configured to force water through the grounds in the filter basket to create a coffee beverage; and
at least one robotic arm configured to:
transport an empty portable filter that holds the filter basket to the doser and the compactor, then transport the portable filter to the brewing machine and then engage the portable filter with the at least one brew head of the brewing machine-;
wherein the controller controls independent operation of each of the at least one robotic arm, the coffee grinder, the doser, the compactor and the brewing machine.

21. The system of claim 20, wherein the doser and the compactor are integrated into a single unit.

22. The system of claim 20, wherein the compactor is adapted to deliver at least 200 N of force to compact grounds in the filter basket.

23. The system of claim 20, wherein the doser is configured to hold multiple separate doses of coffee grounds for sequential delivery to successive filter baskets.

24-32. (canceled)

33. An autonomous robotic coffee preparation system, comprising:
a closed housing;
a first robotic arm arranged in the housing to transport a filter basket between a plurality of different automatically controlled coffee preparation stations;
a second robotic arm arranged in the housing to select and transport a disposable coffee vessel between automatically controlled coffee preparation and delivery stations;
a control system configured to control operation of the first and second robotic arms, and the coffee preparation and delivery stations.

34. The system of claim 33, wherein one of the coffee preparation stations comprises a brewing machine, wherein both the first robotic arm and the second robotic arm have access to the brewing machine.

35. The system of claim 34, wherein the brewing machine comprises a water heater to deliver hot water to filter baskets coupled to the brewing machine and to deliver hot water to a puck removal apparatus.

36. The system of claim 35, further comprising the puck removal apparatus, wherein the puck removal apparatus is configured to remove a puck of spent coffee grounds from a filter basket using the hot water, wherein the puck removal apparatus is configured:
to remove the puck from the filter basket by application of pressurised air and hot water directed at an inverted filter basket; and
to receive the spent coffee grounds into a disposal conduit or opening positioned below the inverted filter basket.

37-41. (canceled)

42. The system of claim 33, wherein the system comprises multiple filter baskets that are separately transportable and engageable with ones of the plurality of coffee preparation stations using the first robotic arm to enable parallel operation of the plurality of coffee preparation stations.

43-49. (canceled)

50. An autonomous robotic coffee preparation system, comprising:
a housing closed to unauthorised access;
coffee preparation apparatus in the housing;
coffee preparation supply storage in the housing and accessible to the coffee preparation apparatus;
at least one robotic arm in the housing and configured to cooperate with the coffee preparation apparatus to prepare and deliver coffee orders using coffee preparation supplies stored in the coffee preparation supply storage;
a controller in the housing configured to control operation of the at least one robotic arm and the coffee preparation apparatus;
a delivery portal for delivery of prepared coffee beverages;
wherein the coffee preparation apparatus and the coffee preparation supply storage are configured to allow preparation of at least 100 coffee beverages without resupply of coffee preparation supplies.

51-54. (canceled)

55. The system of claim 50, wherein the at least one robotic arm comprises separately controlled first and second robotic arms to perform separate tasks.

56. A The system of claim 50, further comprising:
a user interface disposed at a same geographic location as the at least one robotic arm to generate local coffee orders in response to user input;
an order interface configured to receive and process local coffee orders generated by the user interface and to provide coffee preparation instructions to the controller;
wherein the order interface is further configured to receive and process remote coffee orders from a remote server via a communication network.

57. The system of claim 56, wherein the order interface is configured to queue local coffee orders and remote coffee orders for order fulfillment.

58. The system of claim 57, wherein the controller, the coffee preparation apparatus and the at least one robotic arm are configured to prepare multiple coffee beverages in a single local or remote coffee order.

59. The system of claim 58, wherein the controller, the coffee preparation apparatus and the at least one robotic arm are configured to fulfil multiple local and/or remote coffee orders simultaneously.

60-61. (canceled)

62. The system of claim 50, further comprising:
a monitoring subsystem to monitor removal of the prepared coffee beverages from the delivery portal and to determine an overdue pick-up event when one or more prepared coffee beverages have remained in the delivery portal for longer than a predetermined time;
wherein the controller is configured to cause the at least one robotic arm to retrieve the one or more remaining coffee beverages from the delivery portal in response to determination of an overdue pick-up event by the monitoring subsystem.

63-142. (canceled)
